(19) United States
(12) Patent Application Publication
(10) Pub. No.: US 2020/0338639 A1
(43) Pub. Date: Oct. 29, 2020

(54) Advanced Automated Fabrication System And Methods For Thermal And Mechanical Components Utilizing Quadratic Or Squared Hybrid Direct Laser Sintering, Direct Metal Laser Sintering, CNC, Thermal Spraying, Direct Metal Deposition And Frictional Stir Welding. Cross-reference To Related Applications

(71) Applicant: Kevin FRIESTH, North Fort, IA (US)

(72) Inventor: Kevin FRIESTH, North Fort, IA (US)

(21) Appl. No.: 16/764,910

(22) PCT Filed: Nov. 16, 2018
(86) PCT No.: PCT/US2018/061659

§ 371 Date: May 18, 2020

Related U.S. Application Data
(63) Continuation-in-part of application No. 15/815,721, filed on Nov. 17, 2017, now abandoned.

(51) Int. Cl. B22F 3/105; B33Y 30/00; B33Y 50/02; B22F 5/00; B22F 5/04; B23K 20/12; H01M 8/04014; G21C 13/02; G21C 15/28; G21C 1/00; F02K 9/97; F02K 7/18; B33Y 80/00; B23K 26/342

(52) U.S. Cl. CPC B22F 3/1055; B23K 2101/001; B33Y 50/02; B22F 5/009; B22F 5/04; B23K 20/122; H01M 8/04014; G21C 13/02; G21C 15/28; G21C 1/00; F02K 9/972; F02K 7/18; B33Y 80/00; B23K 26/342; B22F 2003/1057; B33Y 30/00

(57) ABSTRACT

ADVANCED AUTOMATED FABRICATION SYSTEM AND METHODS FOR THERMAL AND MECHANICAL COMPONENTS UTILIZING QUADRATIC OR SQUARED HYBRID DIRECT LASER SINTERING, DIRECT METAL LASER SINTERING, CNC, THERMAL SPRAYING, DIRECT METAL DEPOSITION AND FRICTIONAL STIR WELDING. CROSS-REFERENCE TO RELATED APPLICATIONS

### FIELD OF THE INVENTION

Advanced automated fabrication system for thermal and mechanical components utilizing quadratic or squared select laser sintering, direct metal laser sintering, cnc, thermal spraying, direct metal deposition and frictional stir welding.

Disclosed illustrative embodiments includes advanced mechanical and thermal components and fabrications utilizing integral automated methods and processes integrating quadratic or squared selective sintering fabrication, cnc, thermal spraying, direct metal deposition and friction stir welding, applications and fabrication consists primarily of single material component fabrications.

### BACKGROUND

Various prior art generally utilized isolated fabrication methods and processes have been used such as TIG and MIG welding, brazing, casting, select laser sintering (SLS), direct metal laser sintering (DMLS), fused and diffusion welding and mechanical joints to fabricate and join materials. In each case prior art by default generally introduced additional material weakness from the fabrication method, failure points and reduced the maximum characteristics of the chosen materials to mere percentages of the original capabilities and many suffered from the completed project having inferior material density, scaling issues and lack of uniformity and no repair capability during build causing errors to be encased in the finished product which is common in prior art sls/dmls methods, casting with its channel and complex geometry shape limitations and mechanical joints limitations which are well known in prior art. Various pressure doors and methods are in prior art.

Typical welding typically involves joining two separate fabricated items but as such typically damages the initial material characteristics that changes the molecular structure at the point of joint and generally the nearby area from thermal stress and changing fundamental properties and characteristics. These phenomena generally are in regards to the physical and chemical behavior of metallic and nonmetallic elements, their inter-material properties.

Thermal energy from typical prior art methods such as common welding applications affects the joining material and the weld itself, for example in regards to joining stainless steel pieces changes the amount of chromium near the weld due to the thermal energy attracting elements of chromium to the weld area thereby reducing the quality and resistances of the base material from the material characteristics that are remaining after the joined material reverts back to its initial temperature.

Prior art fabrication typically was limited in material choices, machinability, limited in fabrication methods, limited in scaling methods or limited scaling of the application.

Prior art typically utilized excessive material usage, excessive fabrication waste, excessive labor requirements, excessive energy usage, lower efficiency and lower capabilities.

Additionally, prior art fabrications and manufacturing methods and applications suffered from reduced quality and limited characteristics or reduced characteristics due to changes in material structural composition and properties matrix.

Non-square laser count will work but is suboptimal for utilization of the build area

Prior art fabrication and manufacturing methods typically altered the coefficient of thermal expansion, thereby the materials do not exactly match thermal expansion rates which causes the material properties to break down and separate in the form of stress fractures, cracks and material fatigue such as bending or bowing in the material and other non-optimal conditions.

Prior art heat exchangers for example basic designs utilized tube and shell designs which suffer from low effectiveness, large material usage, non-optimal surface area density, very large foot print, high weight, transportation and handling issues.

Prior art plate heat exchanger (PHE) suffers from lower effectiveness, non-optimal surface area density, lower pressure limitations, lower temperature limitations, high manufacturing cost, special order typically required very extensive lead times for delivery.

Prior art such as the 1980's printed circuit heat exchanger (PCHE) usage of diffusion bonding technology utilizes etching processes such as acid etching, electrical discharge machining (EDM) or laser etching to remove material to form channels within the base material and uses another process for diffusion of the target materials with use of a second material for diffusion bonding. Etching limitations however also limits the shape and complexity of the pathways channel being etched.

The fused and/or diffusion bonded areas are exposing the dissimilar material to differing coefficients of expansion issues caused from the dissimilar materials that used for the fusing and/or diffusion bonding. PCHE also suffers from lower effectiveness than is achieved with the present invention while suffering from non-optimal surface area density thereby lower efficiency and incurring higher material usage, mass production limitation, time consuming multiple step processes required, higher preparation and fabrication costs, excessive design and labor costs and lengthy lead times for delivery.

The preferred method of the present invention provides methods for fabrications that can accommodate phase changes on any loops of the component or heat exchanger. Some common thermal applications include closed loop cooling exchangers, lube oil coolers, gland steam condensers, low-pressure or high pressure feed water heaters.

Some additional common thermal applications normal and high pressure and supercritical boiler, blowdown heat recovery exchangers, condensers, and evaporators.

In continuance of prior art deficiencies when dissimilar metals are exposed to electrolytic fluids a process called galvanic corrosion (also called ‘dissimilar metal corrosion’ or sometimes referred to wrongly as ‘electrolysis’) refers to corrosion damage induced when two dissimilar materials are coupled in a corrosive electrolyte environment which causes erosion and corrosion of the channels and pathways of the component thereby shortening expected component lifespans while increasing maintenance and directly relates to a component's partial and critical failures.

The preferred method of the present invention utilizing quadratic or squared HDLS 1000 and DMD can fabricate ‘sacrificial anodes’ within build designs to minimize these types of affects that prior art does not have the ability to do so.

The preferred method of the present invention utilizing quadratic or squared HDLS fabrication advantage of prior art capability of advanced zig zag patterns and rounded zig zag patterns at scale to reduce pinch points and reduction of unnecessary cavitation within the channels while increasing potential flow characteristics and enhanced thermal effectiveness.

An example of this occurs when ships use seawater for cooling intake seawater into a heat exchanger to remove thermal energy will cause erosion and corrosion of the heat exchanger causing premature leaks and failures. This can also occur whenever water as a substance is exposed to contaminants that when mixed form a type of electrolyte, once this occurs this will then allow current to flow through the solution when dissolved in water.

Electrolytes promote low voltage current flow due to the fact they produce positive and negative ions when dissolved. The low voltage current flows through the solution in the form of positive ions (cations) moving toward the negative electrode and negative ion (anions) moving the positive electrode.

Unlike erosion, which is the physical degradation of a material due to the flow of water, wind, or debris, corrosion is the degradation of a material caused by chemical reactions. Corrosion affects a vast many types of materials metals that are used in our daily processes and applications.

Salt and polluted water is generally regarded as a more serious breeding ground for aggressive corrosion as the salt and pollution makes the water more conductive however, it should be noted that polluted fresh water can be even more conductive than sea water with the right combination of electrolytic contaminants.

Corrosion in ducts and channels can advance into the interior parts of the component over time, which tends to lead to ducts and channel thinning and eventually ducts and channel failure if left untreated and typically unchecked within closed components.

Furthermore, corrosion by-products are often carried downstream in piping, which can contaminate the fluid, cause the erosion and further corrosion of piping, and clog valve orifices yet the cause for additional leaks and failures.

These prior art methods and applications and methods introduce new points of failure, potential faults, limitations while greatly increasing material requirements thereby costs compared to the efficient method and process of the present invention.

These prior art methods and applications and methods inability to scale fabrication build area, reduced material density from singular laser usage, lack of repair capability, lack of mission critical quality assurance integration.

The preferred method of the present invention provides the vastly important fabrication which in essence generates little or no waste during material fabrication greatly reducing material usage thereof material costs. The additional benefit is the environmental nature for reduction of energy usage attached to fabrication and processing of the material.

The preferred method of the present invention technology known as High Density Laser Sintering or Hybrid Direct Laser Sintering (HDLS) primarily combines capabilities of both SLS and DMLS and DMD with automation and CNC enabled finishing processes

The preferred method of the present invention utilizing of quadratic or squared HDLS fabrication provides for localized gas and thermal input for a superior advantage over prior art in the present inventions reduction in the fabricated component's overall footprint, volume and weight by up to 95% depending on the application and component requirements.

The preferred method of the present invention utilizing of quadratic or squared HDLS fabrication provides for localized gas and thermal input for a superior advantage over prior art in the present inventions thermal management and additional advantage of the present invention over prior art is within the gas flow and thermal movement providing reduction of blockage from contamination smoke and gases between the laser and the material caused by the lasing of materials.

The preferred method of the present invention utilizes purification of gases to promote use of optimized containment gases and removal of contaminated gases.

The preferred method of the present invention utilizes cyclone separation and screening of powered material to promote optimal sizing while removing oversized and slag from previous build cycles.

The preferred method of the present invention integration of quadratic or squared. High Density Laser Sintering (HDLS) composing both select laser sintering (SLS) and quadratic or squared direct metal laser sintering (DMLS) and direct metal deposition (DMD) with an integrated 3D object scanner, thermal or optical or light based sensor, x-ray, sonic scanning for monitor, analysis and control allows providing near zero defect fabrication, unavailable and unobtainable with prior art methods and applications.

The present invention allows for active analysis of 3D object scanner, thermal or optical or light based sensor, x-ray, sonic scanning for monitor, analysis of the active object build and original 3D design to maintain constant monitoring, analysis and control with observation and repair of anomalies. Through the integration of artificial intelligence and machine learning allows the machine to advance its abilities with and through each fabrication build process.

The present invention then allows the object build process to detect any visible, thermal or scanned faults and flaws and allow them to be repaired via DMD or allow a decision gate before a fault is allowed to over looked and left in the build resulting in a flawed output or worse permeate into additional flaws and faults within the object build as faults and flaws would naturally occur in prior art.

The present invention advantage over prior art is through use and integration of artificial intelligence and machine learning based on cloud integration allows a single machine or multiple machines spread of a vast geography to learn and advance from each and every build cycle.

The preferred method of the present invention advantage over prior art includes the use of rail and carriage or various prior art transport system to enable each material supply cartridge and build area cartridge for quick removal and installation to promote mass production.

The preferred method of the present invention advantage over prior art includes the use self-contained cartridge system, additionally the lift system and vacuum venting and/or material capture tray may be connected as an add-on.

The preferred method of the present invention advantage over prior art includes the use self-contained cartridge system with utilization of a solid and/or mesh build plate to promote gas flow and thermal management.

The preferred method of the present invention allows material supply cartridges to be emptied or filled external to the machine to maximize operational builds via no excessive waits or machine downtime for removal or installation of cartridges for new builds.

The preferred method of the present invention allows build area cartridges to be emptied and product removal external to the machine to maximize operational builds via no excessive waits or machine downtime for removal or installation of cartridges for new builds.

The preferred robotic and cnc work area allows for material removal from a build cartridge from the build object extraction, processing, handling and finishing.

The preferred method of the present invention users robotic and cnc work area allows for material insertion into empty material cartridges, material cartridges for processing rejected material and reprocessing for recycling of materials and reloading of cartridge.

The preferred method of the present invention uses an enclosed robotic and cnc work area allows for material insertion into empty material cartridges, material cartridges for processing rejected material and reprocessing for recycling of materials and reloading of cartridge.

The preferred method of the present invention advantage over prior art includes reduced structural supports and material requirements thereof required when compared to typical prior art technologies.

The preferred method of the present invention integration with DMD allows novel processes of including of additional material type insertion for usage within the quadratic or squared HDLS build providing for highly complex geometries, multiple material usage designs.

The preferred method of the present invention provides for higher resistances, thermal characteristics that are unavailable and unobtainable with prior art methods and applications.

The preferred method of the present inventions utilization of scalable fabrication capabilities incorporating honeycomb design characteristics provides for distinct novel advantages over prior art provides for reduction of material usage by inclusion in all designs that can be enabled via weight reduction fabrication criteria of the targeted end component.

The preferred method of the present inventions utilization of honeycomb structure capability and innovations provides for new designs and updates to older developments in both thermal and mechanic design, aircraft, light and heavy motor vehicle technology and light-weight construction which have formed the basis for the past development of honeycomb structured panels.

The preferred method of the present invention builds upon its scaling and vast material types utilization to provide novel methods and applications that was limited or simply unavailable, not financially viable or even unmanufacturable with anything in prior art.

The present inventions decisive advantage is highlighted via fabrications with low weight, combined with great structural strength and industrial scaling of the design.

The present invention's design incorporating thermal control and gas management thereby conserving energy and reducing gas input or gas generational requirements.

The present invention allows for external gas storage, gas generation, thermal management, power systems, control systems, material supply, material separation and recycling and power systems.

The present inventions advantage over prior art is due its density, fabrication accuracy and to scaling to monetize honeycomb's anti-shock properties, honeycomb structures are today used as shock-absorbent layers both in mechanical and thermal fabrication and construction with characteristics attractive for mass production.

The preferred method of the present invention is ideally suited compared to prior art for design and architectural applications as a result of their optimal ratio of weight to load-bearing capacity and bending strength.

The present invention provides for additional benefit from its scaled fabrication methods and material utilizations, prior art lacked the ability to scale fabrication which lends to joints, welds fusions and mechanical connections

The preferred method of the present invention which typically utilizes a honeycomb design with an internal facing, honeycomb core and external facing, this design can be adapted to individual requirements with regard to strength and choice of materials to optimal performance and longevity which is greatly enhanced when compared to prior art.

The preferred method of the present invention provides for last but not least, the aesthetic properties of these materials are being increasingly of very high value. The present invention provides for characteristics from transparent to translucent, visually attractive by catching the eye and directing the gaze, this versatile material fabrication method of the present invention can be tailor-made for a variety of design purposes.

The preferred method of the present invention advantage over prior art providing access for maintenance from the reduced volume and weight when compared to typical prior art technologies.

The preferred method of the present invention having no joints, welds or connections like prior art thereby allows higher temperatures, higher pressures and higher margins of safety with lower costs, maintenance with greatly extended useful life versus any prior art method and application.

The preferred method of the present invention thereby allows cost effective fabrication of components whereas prior art with the considerable weaknesses contributed to a lesser product, lower quality or worse made fabrication not feasible from cost, life span or inability to fabricate or fabricate cost effectively.

Prior art sls/dmls typically used singular lasers fields for sintering whereas the present invention uses quadratic or squared HDLS arrays to allow its numerous lasers to preheat a defined laser path before sintering the layer with a second beam movement. The preferred method of the present invention will also allow a third beam movement to perform a retrace of the sintering beam path to perform material density enhancement thereby increasing the density for strength, resistance and thus the quality for a reduced maintenance requirement and greatly extended life expectancy.

This method of the present invention provides for a stronger and more robust component fabrication versus any of the above or other known prior art methods by removing prior art methods and applications with distinct fabrication processes and archaic techniques and procedures of manufacturing widely known weaknesses and limitations.

The preferred method of the present invention utilizes 3D object scanning for micrometer (μm or micron) accuracy level with real time analysis, this provides for the highest level of automated quality assurance and removal of potential material defects from the fabrication process before continuing thereby not allowing a defect to go unrepaired, this presents a huge advantage and novel method versus prior art. This will also allow the integral direct metal deposition (DMD) to fill any voids or repair any flaws in the quadratic or squared HDLS process layer.

The preferred method of the present invention provides for DMD to also perform additional additive manufacturing allowing multiple additional material types to be fabricated by applying additional material types beyond the quadratic or squared HDLS process targeted material within the quadratic or squared HDLS build process.

The preferred method of the present invention integration of DMD for example provides the ability to plate or coat with a higher resistant material or use copper to enhance the thermal transfer capability novel in their own right and unavailable and not possible in or with prior art methods and applications thereof.

The preferred method of the present invention provides for reduced mass material fabrication of thermal and mechanical components as well as aircraft and spacecraft specific controlled mass material usage and strength design whereas material mass is the biggest factor relating to efficiency and energy requirements.

Prior art utilization motivated engineers to find viable methods to reduce material mass across as much of the design and development as possible. The initial effort was towards the components with the largest material mass that typically was always the structure associated with the system. Utilization of a design of sandwiched structures with supported voids such as a framed hexagon honeycomb core design promotes high structural strength and integrity while encouraging greatly reduced material mass usage thereby total weight of the system and/or component thereby greatly reducing its material costs.

Honeycomb cores typically consists of three parts: two plates or face sheets and an internal interlocking honeycomb wall core with mostly empty void space. The honeycomb core is an arrangement of thinly connected cells, typically using hexagons, which are sandwiched between the two plates or face sheets. The core provides typical strength of the structure, and the plates or face sheets provide the structural tensile strength. This light-weight design encompasses a large loading factor while keeping the structural material mass low.

It should be noted however that the honeycomb structure is not thermal transfer efficient. The rationale is also what makes honeycomb structures attractive to engineers is it also makes the structure thermally inefficient for thermal conductance. Thereby high thermal loads do not transfer across the honeycomb structure efficient for specific uses such as casings for steam turbines, CO2 turbines, pumps and compressors and other structures.

The honeycomb structure is composed by mostly empty voids of space supported by interlocking wall structures. During thermal transfer energy is communicated through the core, it should be noted however that the thermal energy is communicated through the thin walls of honeycomb cells which have a very low thermal conductance ratio thereby low thermal transfer capability.

Thus requires a very large temperature differential between the two plates or face sheets to communicate thermal energy. Additionally, due to the empty void space between the plates or face sheets, radiation thermal transfer is also a factor engineers must calculate into their designs specifications.

When radiation is compared to conduction, radiation is an extremely poor way to communicate thermal energy which is a factor that must be considered during design to determine the level of thermal energy communicated. Hence calculations incorporating material type, conductance and radiance must be factored in as necessary information during the design phase.

The preferred method of the present invention incorporates the ability to provide vacuum from the of the cartridge system to move smoke and gas contaminants away from the laser and material while promoting thermal exchange between the top layered surface and the previously fabricated layers.

For an oversimplification of the design process utilizing honeycomb structures, the following assumptions are typically used. First, the plate or face sheets of the panel are extremely thin, so that the temperature differential through them is basically negligible. Second, there is no convection thermal transfer inside the panel, as the experiment will take place inside a still environment. Third, the cell walls of the core are thin so that the temperature gradient across them is negligible. Fourth, the thermal properties of the materials used do not change with the temperature. Fifth, the thermal effects of the connection between the honeycomb core and the plate or face sheets are considered negligible. And finally, the thermal energy transfer calculations are generally nonlinear due to the thermal radiation method.

This method of the present invention provides over prior art with the novel ability to use finite element analysis to give the strongest design of all possible design choices. This method of the present invention provides for honeycomb design customized designs for Hexagonal, Reinforced Hexagonal, Over-Expanded Hex Core, Flexible Hex Core, Double Flexible Hex Core, Spiral wrapped (tubular-core), Criss-Cross-Hex-Core, hybrid Flower-Circular (tubular, flower core) and Square formed honeycomb orientation.

The preferred method of the present invention additional advantage over prior art such as reduced floor space for the component and when attached to a skid with the present inventions enhanced reduction in volume in weight providing stackable skid installation arrangement.

The preferred method of the present invention provides for an integral process includes the inclusion of 3D object scanner, thermal or optical or light based sensor, x-ray, sonic scanning for monitor, analysis of the fabricated component for errors in fabrication, this provides for integration of a gantry to provide mounting for a Direct Material Deposition system.

Prior art has two different versions of typical DMD processes, those providing for manual and automatic modes.

Semi-Manual laser deposition welding: In the case of manual deposition welding, the welder guides the filler material “by hand” to the area to be welded. An automatic fed thin wire with a diameter between 0.15 and 0.6 millimeters is primarily used as filler material in this process. The laser beam melts the wire. The molten material forms a strong bond with the substrate, which is also melted, and then solidifies, leaving behind a small raised area. The welder continues in this fashion, spot by spot, line by line, and layer by layer, until the desired shape is achieved.

Automated laser deposition welding: In the case of automated deposition welding, the machine guides the filler material to the area to be welded. Although the material can also be a wire, this process primarily uses metal powders. Metal powder is applied in layers to a base material and fused to the base material and is fused to it without pores or cracks. The metal powder forms a high-tensile weld joint with the surface. After cooling, a metal layer develops that can be machined mechanically. A strength of this process is that it can be used to build up a number of similar or differing metal layers.

Inert gas such as inert or noble gas, rare gas or argon on which can be any of the chemically inert gaseous elements of the helium group in the periodic table or the unreactive gaseous elements helium, neon, argon, krypton, xenon, and radon which can include carbon dioxide to also include nitrogen gas for certain uses as the gas shields for work process barrier to ambient air. Finally, the part is restored to its original shape by grinding, lathing, milling, EDM etc.

The preferred method of the present invention with integration of quadratic or squared with cnc automated DMD can provide a near flawless expansion of originating quadratic or squared HDLS build with DMD based laser cladding to enhance the original material for higher resistance and wear.

The preferred method of the present invention with integration of quadratic or squared with cnc automated tools for machining and milling any potential flaws during the build cycle with availability of DMD enabled repair of the flawed area which can provide a near flawless expansion of originating quadratic or squared HDLS build.

The preferred method of the present invention introduces a unique 90-degree mirror offset arrangement and dynamic focus module which allows for the laser, focus system, galvo scanner to enable tightly packed quadratic or squared laser assemblies allowing high density laser configurations.

The preferred method of the present invention with integration of thermal spraying techniques are coating processes in which melted (or heated) materials are sprayed onto a surface. The “feedstock” (coating precursor) is heated by electrical (plasma or arc) or chemical means (combustion flame).

Thermal spraying can provide thick coatings (approx. thickness range is 20 micrometers to several mm, depending on the process and feedstock), over a large area at high deposition rate as compared to other coating processes such as electroplating, physical and chemical vapor deposition. Coating materials available for thermal spraying include metals, alloys, ceramics, plastics and composites.

Thermal spraying is typically feed materials in powder or wire form, heated to a molten or semi molten state and accelerated towards substrates in the form of micrometer-size particles. Combustion or electrical arc discharge is usually used as the source of energy for thermal spraying.

Resultant coatings are formed by the accumulation of numerous sprayed particles. The targeted surface generally does not heat up significantly, allowing the coating of flammable substances and plastics without excessive deforming the target surface or the shape of the target.

Thermal spray coating quality is usually assessed by measuring its porosity, oxide content, macro and micro-hardness, bond strength and surface roughness. Generally, the coating quality increases with increasing particle velocities.

Several variations of thermal spraying are distinguished: Plasma spraying, Detonation spraying, Wire arc spraying, Flame spraying, High velocity oxy-fuel coating spraying (HVOF), High velocity air fuel (HVAF), Warm spraying, Cold spraying techniques.

Plasma spraying, developed in the 1970s, uses a high-temperature plasma jet generated by arc discharge with typical temperatures >15000 K, which makes it possible to spray refractory materials such as ceramics, oxides, molybdenum, etc

Thermal spraying is an industrial coating process that consists of a heat source (flame or other) and a coating material in a powder or wire form which is literally melted into tiny droplets and sprayed onto surfaces at high velocity. This “spray welding” process is known by many names including Plasma Spray, HVOF, Arc Plating, Arc Spray, Flame Spray, and Metalizing.

Thermal sprayed coatings are typically applied to metal substrates, but can also be applied to some plastic substrates. Thermal sprayed coatings uniquely enhance and improve the performance of the component. Substrates can be most metals including: aluminum, steel, stainless steel, copper, bronze and some plastics.

Plasma spray is the most versatile of the thermal spray processes. Plasma is capable of spraying all metallic and nonmetallic materials that are considered sprayable.

In plasma spray devices, an arc is formed in between two electrodes in a plasma forming gas, which usually consists of either argon/hydrogen or argon/helium. As the plasma gas is heated by the arc, it expands and is accelerated through a shaped nozzle, creating velocities up to Mach 2. The higher the velocity as possible is desired. Temperatures in the arc zone approach 36,000° F. (20,000° K). Temperatures in the plasma jet are still 18,000° F. (10,000° K) several centimeters form the exit of the nozzle.

Thermal sprayed coatings can be an effective alternative to several surface treatments including: nickel and chrome plating, nitride or heat treat processes, anodizing, and weld overlay. They are typically thicker than plating, in the range of 0.002″-0.025″ thick depending on the coating material.

Nozzle designs and flexibility of powder injection schemes, along with the ability to generate very high process temperatures, enables plasma spraying to utilize a wide range of coatings. The range goes from low melting point polymers such as nylon, to very high temperature melting materials such as refractory materials including tungsten carbides, stainless steels, ceramics, (chronic oxide, aluminum oxide, zirconia, titania), nickel-chrome carbides, pure metals (aluminum, zinc, copper), tungsten, tantalum, ceramic oxides, and other refractory materials

Because plasma-arc spraying is the most versatile of all the thermal spray processes it can be found in the widest range of industries. Plasma spray coatings are used commonly for applications in aerospace, automotive, medical devices, agriculture communication, etc.

Jet engines literally contain hundreds of components that are plasma spray coated. A commonly used coating in jet engines is produced with yttria partially stabilized zirconia (YSZ). This coating provides high temperature protection to components that are exposed to combustion gases and/or supercritical fluids. The thermal protection allows the component to last longer and run at higher temperatures, which improves the system's overall performance efficiency.

The four primary spray methods commonly used today are Electric Arc Spray (twin wire electric arc), Flame Spray (Oxy-acetylene), Plasma Spray (APS), HVOF (High Velocity Oxy-Fuel).

Electric wire arc thermal spraying utilizes the same principles employed in wire arc welding systems. The coating material, in wire form, is electrically charged, and then contacted creating an arc. The molten droplets of metal wire are then sprayed onto the substrate using a high velocity air stream to atomize and propel the material.

Plasma Arc spray coatings are very cost effective and are typically used to apply metals like pure aluminum, zinc, copper, and metal alloys such as stainless steel. Arc spray also allows adjustments to achieve varied coating texture (200 micro inches-800 micro inches).

Flame spray, also known as oxy/acetylene combustion spray is the original thermal spray technique was developed roughly 100 years ago. It uses the basic principles of a welding torch with the addition of a high velocity air stream to propel molten particles onto the substrate. The coating material can be either a wire or powder form. Often flame spray coatings are fused after being applied to enhance bond strengths and coating density.

The plasma spray process (non-transferred arc), uses inert gases and/or supercritical fluids fed past an electrode inducing the “plasma” state of the gases and/or supercritical fluids. When the gases and/or supercritical fluids exit the nozzle of the gun apparatus and return to their normal state, a tremendous amount of heat is released. A powdered coating material is injected into the plasma “flame” and propelled onto the substrate.

Ceramic Coatings are most often applied using plasma spray due to their high melting temperatures. (Often >3500 F). Several types of ceramic coatings can be applied using plasma spray.

The HVOF (High Velocity Oxy-Fuel) process combusts oxygen and one of select group of ignitable gases and/or supercritical fluids including: propane, propylene, or hydrogen. Although the HVOF system uses the basic principle of combustion, the spray gun is designed differently than the standard oxy-fuel spray gun.

The HVOF gun differences produce higher flame temperatures and higher velocities. The result is more thoroughly melted powder and more kinetic energy available to “flatten” the molten particles of coating material. The HVOF process produces superior bond strength and coating density.

The HVOF process is most often used to apply high melting temperature metals and metal alloys such as: tungsten carbide, nickel, Inconel, chrome carbide.

The preferred method of the present invention with integration of automated DMD can provide a enclosed controlled environment for near flawless capability of joining two quadratic or squared HDLS fabricated component pieces into a larger single component

The preferred method of the present invention with integration of automated friction stir welding can provide a near flawless capability of joining two quadratic or squared HDLS fabricated component pieces into a larger single component.

For example, DMD or friction stir welding can be done to minimize changes in material properties thereby maintaining targeted pressure, temperature and tensile strength properties and characteristics which can be selected dependent on the targeted resultant component operational requirements.

Another example of an automated and amalgamated process would be with quadratic or squared fabrication of the ends of a tank and its cylinder segments and with CNC controlled DMD and/or frictional stir welding to join the components as separate single fabricated components into a singular large assembled component.

The preferred method of the present invention with integration of DMD can provide for changes in design in real-time or for any potential flaws, errors in the initial quadratic or squared HDLS sintering process layer.

The preferred method of the present invention with integration of direct metal deposition (DMD) provides for an enhanced set of integrated processes of advanced additive manufacturing technology used to repair and rebuild worn or damaged components, to manufacture new components, and to apply wear- and corrosion resistant coatings. DMD produces fully dense, functional metal parts directly from CAD data by depositing metal powders pixel-by-pixel using direct laser sintering

The preferred method of the present invention provides for artificial intelligence decision based feedback control system and 3D object scanner, thermal or optical or light based sensor, x-ray, sonic scanning for monitor, analysis to maintain highly precise dimensional accuracy and material integrity. With the feedback system, 3D object scanner, thermal or optical or light based sensor, x-ray, sonic scanning for monitor, analysis, artificial intelligence and machine learning, seven-axis deposition tool, and multiple material delivery capability, DMD can coat, build, and rebuild parts having extremely very complex geometries with submicron accuracies.

In the past Direct Metal Deposition was typically referred to as Laser Cladding since it can be used to add a certain amount of metal in order to repair a damaged or worn part. With the expansion of 3D printing technologies to create near end-use parts, this technology is then also used as a way to create from the ground an entire object and in the preferred method of the present invention integrated to enhance quadratic or squared HDLS technology greatly surpassing prior art in speed and quality of fabrication yet providing real time alteration and repair during the initial build and additionally as follow-up during the CNC process. Then, the substrate is no longer just a part to be repaired but a platform to start building or alter an existing build part.

A laser spray nozzle assembly is described in U.S. Pat. No. 4,724,299. The assembly includes a nozzle body with first and second spaced apart end portions. A housing, spaced from the second end portion, forms an annular passage. A cladding powder supply system is operably associated with the passage for supplying cladding powder thereto so that the powder exits the opening coaxial with a laser beam.

Typical metal 3D printing technologies (selective laser melting, direct metal laser sintering, direct metal deposition laser sintering), these technologies are based on the premise of transformation of powdered and/or wire and/or cord in metal and nonmetal materials into a solid metallic object. The main principle is to use a powder or wire feed nozzle then using the shielding gas or in the case of wire or cord using friction propulsion to propel the material into the laser beam.

The material is then fused by the laser. Using a layer by layer strategy, the printer head and/or power deposition duct head, comprised of the laser beam and the feed nozzle, can scan the substrate to deposit successive layers. The deposit width is between 0.5 to 2.5 mm while the layer thickness lies between 0.1 and 0.85 mm with wire up to about 2.5 mm.

Additive manufacturing processes for metal sintering or melting (such as selective laser sintering, direct metal laser sintering, and selective laser melting) usually went by their own individual names in the 1980s and 1990s. At the time, nearly all metal working was produced by casting, fabrication, stamping, and machining; although plenty of automation was applied to those technologies (such as by robot welding and CNC), the idea of a tool or head moving through a 3D work envelope transforming a mass of raw material into a desired shape layer by layer was associated by most people only with processes that removed metal (rather than adding it), such as CNC milling, CNC lathe, CNC EDM, and many others.

Direct Metal Deposition is an additive manufacturing technology using a laser to melt metallic and nonmetallic powder or wire. Unlike most of the other technologies, it is not based on a powder bed but it uses a feed nozzle or friction system to propel the material into the laser beam. It is very similar to Fused Deposition Modeling as the nozzle can move to deposit the fused metal.

Direct Metal Deposition, the laser beams and the material being fused are focused and scan the substrate to deposit the material. This technology can be used in various industries such as in the thermal or mechanical related component usage field to repair complex and expensive parts instead of replacing them. That way, the manufacturer saves a spare part and the cost of disassembly and reassembly.

The preferred method of the present invention provides for automation of complex fabrication and complex protective coatings for cost effective yet high quality fabrication whereas prior arts fabrication, manufacturing and design capabilities thereof was limited in quality, quantity, costs, timeframes and competitiveness when compared to the present inventions novel methods, applications and fabrication with associated manufacturing competitive advantages and high value offerings.

The preferred method of the present invention provides for fabrication of components and devices such as those of the present invention and fabrications that prior art wasn't not capable of or had limited capacity or wasn't competitive due to its all the above and commonly known limitations in comparison to the applications and fabrications of the present invention.

A Solid Oxide Fuel Cell (SOFC) Supercritical CO2 cooled fuel cell, Supercritical CO2 Gas Cooled Fast Reactor (SGCFR (Generation 5) or SMART Small Modular Advanced Reactor Technology), solar thermal energy sources and turbine, impeller and/or rotor with blades, bearing with seals assembly for use in turbomachinery as integral components of a CO2 combined cycle energy system and fabrication method thereof is provided. The turbine impeller and/or rotor with blades has a connection area adapted to mounting to a shaft, and an airfoil area extending from the root area extending from the connection area.

A cooling gas or supercritical fluid duct is provided and adapted to communicate with the gas plenum as a consequence of turbine shaft components interconnection while gas or supercritical fluid is communicated through ducts and/or channels in the blades that are connected to the rotor. Pressurized gas or supercritical fluid is provided to a cooling gas or supercritical fluid channel defined within a blade airfoil area of the impeller and/or rotor and a cooling gas or supercritical channel defined in the vane or nozzle area for the purpose of cooling the blades or vanes.

Turbomachinery components includes superior high surface area ratio heat exchangers with optimal coefficients of thermal expansion for optimized for enhanced thermal dynamic operations. A turbomachinery system also includes the linear advanced bearings and seals gallery assembly in connection with the shaft and in communication with gas or liquids for the purpose of support, sealing and cooling of the assembly.

Supercritical carbon dioxide (sCO2) is a fluid state of carbon dioxide where it is held at or above its critical temperature and critical pressure. Carbon dioxide usually behaves as a gas in air at standard temperature and pressure (STP), or as a solid called dry ice when frozen. If the temperature and pressure are both increased from STP to be at or above the critical point for carbon dioxide, it can adopt multiple properties midway in its form between a gas and a liquid. More specifically, it behaves as a supercritical fluid above its supercritical temperature (304.25 K, 31.10° C., 87.98° F.) and supercritical pressure (72.9 atm, 7.39 MPa, 1,071 psi), expanding to fill its container like a gas but with a density like that of a liquid.

A supercritical fluid is any substance at a temperature and pressure above its critical point, where distinct liquid and gas phases do not exist. It can effuse through solids like a gas, and dissolve materials like a liquid. In addition, close to the critical point, small changes in pressure or temperature result in large changes in density, allowing many properties of a. supercritical fluid to be “fine-tuned”. Supercritical fluids are suitable as a substitute for organic solvents in a range of industrial and laboratory processes. Carbon dioxide and water are the most commonly used supercritical fluid.

In thermodynamics, the triple point of a substance is the temperature and pressure at which the three phases (gas, liquid, and solid) of that substance coexist in thermodynamic equilibrium. For example, the triple point of liquid carbon dioxide forms only at pressures above 5.1 atm; the triple point of carbon dioxide is about 518 kPa occurs at a temperature of −56.6° C. The critical point is 7.38 MPa at 31.1° C.

This discovery confirmed the theory that carbon dioxide could exist in a glass state similar to other members of its elemental family, like silicon (silica glass) and germanium dioxide. At temperatures and pressures above the critical point, carbon dioxide behaves as a supercritical fluid known as supercritical carbon dioxide. In addition to the triple point for solid, liquid, and gas phases, a triple point may involve more than one solid phase, for substances with multiple polymorphs. Helium-4 is a special case that presents a triple point involving two different fluid phases such as the lambda point.

The preferred method of the present invention provides for a CO2 Combined Cycle System (CCS) utilizing a thermal generation system includes a SOFC Supercritical CO2 cooled fuel stack module via high temperature sealing joints including an integral stack heat exchanger manifold containing all of the gas necessary for supply and exhaust of fuel gas and cathode air to and from the stack chimneys and carbon dioxide (CO2) thermal control pathways for removal of excess thermal energy from the SOFC stack.

Additionally, the preferred method of the present invention provides for a supercritical CO2 cooled nuclear reactor containment vessel module providing an integrated thermal heat exchanger capability within the vessel, comprising one or more layers of heat exchanger chambers rather than ceramic fiber, ceramic bricks or tile such as would be conventional in an advanced gas-cooled reactor. This is provided so that the coolant temperatures achieved in a High-Temperature Reactor or a Fast Reactor can be tolerated with the vessel, provide fault tolerance and scram capability.

The preferred method of the present invention provides for integration forr any desired number of internal or external modules or layers may be arrayed together to from a higher shielding and system strength with the novel ability to incorporate honeycomb structure and supports, this had the advantage of less weight while retained strength

In a typical turbo machine seal assembly, higher performance sealing system would comprise a tandem dry gas seals consisting of a primary and a secondary gas seal and optionally an intermediate labyrinth seal, are often used to eliminate process gas or leakage to the atmosphere. The typical tandem dry gas seal has generally known pressure limits that are well below the turbo machine's ability thereby limiting its usefulness. In extreme high pressure applications, however, to operate properly the tandem gas seal must receive “balance gas” which is typically a filtered process gas (a general filtered low-pressure process gas that has been significantly reduced in overall pressure by a previous “labyrinth” seal) or filtered air injection as the balance gas.

In conventional operations, a toothed labyrinth seal or a grooved labyrinth seal is typically used as the primary initial pressure reduction seal and generally configured to reduce a high-pressure process gas to a level that the normal tandem gas seal can accept. Using a single labyrinth seal, however, has demonstrated significant inefficiencies in the form of excess process gas leakage or liquid loss and seal contamination.

It is therefore, in extreme high-pressure applications such as the present invention, a need for an alternative to the typical commercially available seals that can be used to reduce the high-pressure process gas and or liquid leakage. The balance gas is to create an equilibrium between the pressure of the gas or liquid emanating from the primary inner labyrinth seal and the tandem seal assembly to reduce leakage to an optimal reduction for the outside labyrinth seal lowers the leakage for an acceptable leak rate.

In accordance with the preferred embodiment of the present invention what was demanded is a low-leakage sealing technology capable of handling higher delta pressures, higher material resistance to fouling and corrosion with low frictional resistance for high efficiency and has a long life span through resistance to wear. Additionally, the preferred embodiment of the present invention provides for a method and an application whereas the bearing and seal assembly is integrated as a modular cartridge to which to contains the bearings, seals and gas or liquid ducting.

The preferred embodiment of the present invention with its modular design allows changes to the layout and the individual components to be flexible for adjustment to the particular requirements. This will provide for a compact cartridge assembly that is easy to maintain and service as a module rather than separate components that in themselves create additional complexity and difficulty through maintenance and replacement.

Gas Film Journal and Gas Film Thrust bearings are typically seated in a center bearing housing between the shaft and the center bearing housing for rotatable supporting the shaft. In some turbomachinery hydrodynamic gas film flexure pivot tilting pad (GFFPTP) journal bearings are used to support the shaft. A GFFPTP bearing is a type of bearing in which individual tilting bearing elements (e.g., pads) are arranged around the axial circumference of a rotating shaft. GFFPTP bearings and hydrodynamic gas film thrust pad bearing (GFTPB) can also be configured radially to serve as thrust bearings by placement of the pad(s) along a thrust surface.

In GFFPTP and GFTP bearings, either rotation of the shaft or pressure created by an external pump or compressor causes the gases and/or supercritical fluids or fluid to support a film between the bearing and the contact support and within the bearing to provide a fluid bearing between the opposing surfaces. The pressure causes the pad to tilt and creates a film of gas or fluid between the bearing and the contact area whether that be a solid ring or pads. The film is preferred to be equal from the leading edge of the bearing surface to the trailing edge of the bearing.

A hydrodynamic bearing which can include hydrostatic support features. The contact surfaces are typically supported on a single or dual pivoting mechanism on a support structure which can include one or more components such as the case in preloaded self-leveling which generally uses an upper and lower leveling component. The bearings may have hydrostatic and active control attributes and is very attractive in high pressure applications where it is very difficult to prevent leakage in conventional hydrostatic tilt pad bearings. The hydrostatic feed through the pass through connector eliminates this problem completely and prevents the fretting at the pivots common with conventional tilt pad bearings.

Applied gas or fluid pressure can implore the bearing set or assembly clearance to be reduced thus providing better damping and centering capability. The preload of surface tension on the contact surfaces can be actively controlled in this manner. The contact surface has a design that by default is a limiting device to prevent a negative pre-load condition from happening. This active control of through pressure, design and film thickness for precise bearing clearance can allow bearings to operate at large spreads in temperatures and speeds.

One advantage of a GFFPTP or GFTP bearing is that the contact surfaces can move independently of each other and thus, a GFFPTP or GFTP bearing is able to provide dampening for vibrations caused by rotation of the device and the environment such as mobile applications may infer. Another advantage is that the contacts of the GFFPTP or GFTP bearing can individually shift to accommodate various loading conditions, thus the bearing geometry is always optimized for load capacity and efficiency, and cross-coupled stiffness is greatly reduced or eliminated. Further advantage is that the GFFPTP or GFTP bearing is inherently more stable than many other journal or thrust bearings and thus the GFFPTP or GFTP bearing allows greater flexibility in the design, application, and manufacturing.

Oil-free turbomachinery (TMs) typically require gas or liquid bearings in compact units of enhanced rotor dynamic stability, mechanical efficiency, and improved reliability with greatly reduced maintenance costs when compared to typical oil-lubricated bearings. Implementation of gas bearings into TMs requires careful planning and design for proper thermal management with accurate measurements verifying model predictions. Gas film bearings (GFBs) are customarily used in oil-free turbomachinery because of their distinct advantages including tolerance to shaft misalignment and centrifugal/thermal growth, and large damping and load capacity compared with rigid surface gas bearings.

Flexure pivot tilting pad bearings (FPTPBs) are widely used in high-performance turbomachinery since they offer little or no cross-coupled stiffness's with enhanced rotor dynamic stability. The preferred methods and applications of the present invention promotes design capabilities to give a high degree of confidence in the present intentions use of GFB technology for critical ready applications into turbomachinery for stationary applications and mobile applications such as automotive passenger car, commercial vehicle, ships and aerospace applications with increased reliability.

Many of today's modern turbomachines, especially those running at high speeds and low and high bearing loads, require the superior stability characteristics of GFFPTP or GFTP bearings to prevent rotor dynamic instabilities. Until now, the design complexity of GFFPTP or GFTP bearings and the associated seals has precluded their use in many small, high-volume applications where cost and size are important and typically the deciding factor.

Prior art hydrodynamic bearings often suffer from fluid leakage which causes breakdown of the fluid film. In radial bearings, the leakage primarily occurs at the axial ends of the bearing pad surface. In thrust bearings, the leakage primarily occurs at the outer circumferential periphery of the pad surface as a result of centrifugal forces action on the fluid. When film formation and film stability from leading edge to trailing edge is optimized, fluid leakage is minimized in agreement to reduced maintenance and the bearings lifespan is greatly extended.

Yet furthermore, it is the intent of the present invention that relates to cooling systems for the turbine blades and vanes of a turbomachinery and in particular an improved cooling gas supply system for turbine that has a single stage or multiple stage high work and high pressure turbine. Conventional turbomachinery includes rather complex structures including impeller and/or rotor surfaces, shafts, bearings and associated seals, all of which add to the mechanical complexity of the system.

Under typical operating conditions, turbomachinery components, such as turbine with axial rotors and blades or radial turbines with impellers or a combination of both are conventionally cooled by a flow of compressed gases and/or supercritical fluids discharged at a relatively cool temperature. The flow of cooling gases and/or supercritical fluids through the interior of the rotor and blades or impeller removes heat through heat exchange so as to prevent excessive reduction of the mechanical strength properties of the turbine blades and. turbine rotor or impeller.

The operational temperatures, efficiencies and energy output of the turbomachinery are limited by the high temperature capabilities and material stabilities of its coatings when used of various turbine components. A lower operating temperate of the components with its reduced thermal stresses, the higher strength and resistance to operating stress of the machine. Whereas, the performance of the turbomachinery sensitive to the amount of gas flow that is used for cooling the hot turbomachinery components. Hence, if less gas is used for cooling functions, the efficiency and performance of the turbine improves in kind.

Prior art cooling arrangements for the rotor and blades or impeller assemblies in turbomachinery are well known. There is however always room for improvement for the cooling system in order for turbomachinery to operate more efficiently at extremely high temperatures and high pressures. The known cooling configurations and design of cooling passages, however, is not well designed for directing the cooling gas at maximum pressure to the blades for optimized cooling effect.

To cool turbine rotor with blades, impellers and vanes conventionally, a flow of high pressure cooling gas is introduced through ducts to passages within the rotor to the blades or ducts under the vanes. Unfortunately, typical turbomachinery utilizes hot gas or fluid path pressures that are relatively high pressure, therefor the pressure of the cooling gas must exceed the hot gas path pressure. Due to the high pressure of the hot gas path, conventionally it is necessary to inject high pressure cooling gas and increase the pressure of the gas above pressure equalization levels to allow cool gas injection.

Fuel cells which generate electric current by the electrochemical combination of hydrogen and oxygen are well known. In one form of such a fuel cell, an anode layer and a cathode layer are deposited on opposite surfaces of an electrolyte for ed of a ceramic solid oxide. Such a fuel cell is known in the art as a “solid oxide fuel cell” (SOFC). Hydrogen, preferably generated from a renewable source, is flowed along the outer surface of the anode and diffuses into the anode. Oxygen, typically extracted from air, is flowed along the outer surface of the cathode and diffuses into the cathode where it is ionized.

The oxygen anions transport through the electrolyte and combine with hydrogen ions to form water. The cathode and the anode are connected externally through a load to complete the circuit whereby electrons are transferred from the anode to the cathode. When hydrogen is derived from “reformed” hydrocarbons, the reformate gas includes CO which is converted to CO2at the anode via an oxidation process similar to the hydrogen oxidation. Reformed gasoline is a commonly used fuel in automotive fuel cell applications. Solid oxide fuel cells (SOFCs) are energy conversion devices that produce electricity and heat directly from a gaseous or gasified fuel by electrochemical combination of that fuel with an oxidant.

A SOFC consists of an interconnect structure and a three-layer region composed of two ceramic electrodes, anode and cathode, separated by a dense ceramic electrolyte (often referred to as the PEN—Positive electrode/Electrolyte/Negative-electrode). SOFCs operate at high temperatures and atmospheric or elevated pressures, and can use hydrogen, carbon monoxide, and hydrocarbons as fuel, and air (or oxygen) as oxidant.

A single cell is capable of generating a relatively small voltage and wattage, typically between about 0.5 volt and about 1.0 volt, depending upon load, and less than about 2 watts per cm2 of cell surface. Therefore, in practice it is usual to stack together, in electrical series, a plurality of cells. Because each anode and cathode must have a free space for passage of gas over its surface, the cells are separated by perimeter spacers which are vented to permit flow of gas to the anodes and cathodes as desired but which form seals on their axial surfaces to prevent gas leakage from the sides of the stack.

The perimeter spacers include dielectric layers to insulate the interconnects from each other. Adjacent cells are connected electrically by “interconnect” elements in the stack, the outer surfaces of the anodes and cathodes being electrically connected to their respective interconnects by electrical contacts disposed within the gas-flow space, typically by a metallic foam which is readily gas-permeable or by conductive filaments. The outermost, or end, interconnects of the stack define electric terminals, or “current collectors,” which may be connected across a load.

A complete SOFC system typically includes auxiliary subsystems for, among other requirements, generating oxygen by pressure swing absorption; processing and separation of oxygen from the air; providing oxygen to the cathodes for reaction with hydrogen in the fuel cell stack. A complete SOFC assembly also includes appropriate piping and valving, as well as a programmable electronic control unit (ECU) and appropriate sensors for managing the activities of the subsystems simultaneously.

The various components of a fuel cell stack, possibly including the fuel cells themselves, the anode and cathode spacers which create the flow passageways across the anodes and cathodes, the perimeter seals, and the electrical interconnects, are rectangular and are perforated along all four edges. When the components are stacked up, the passages define fuel, oxygen and CO2 distribution manifolds, known as “chimneys,” within the fuel cell stack perpendicular to the planes of the stacked fuel cells, through which fuel and oxygen may be supplied to and removed from the individual fuel cells.

The typical prior art gas-cooled fast reactor (GFR) system is a nuclear reactor design which is currently in development and generally classed as a Generation IV reactor, it features a fast-neutron spectrum and closed fuel cycle for efficient conversion of fertile uranium and management of actinides. The prior art reference reactor design is a helium-cooled system operating with an outlet temperature of 850° C. using a direct Brayton closed-cycle gas turbine for high thermal efficiency. Several fuel forms are being considered for their potential to operate at very high temperatures and to ensure an excellent retention of fission products: composite ceramic fuel, advanced fuel particles, or ceramic clad elements of actinide compounds. Core configurations are being considered based on pin- or plate-based fuel assemblies or prismatic blocks, which allows for better coolant circulation than traditional fuel assemblies.

The gas-cooled fast reactor (GFR) was chosen as one of the Generation IV nuclear reactor systems to be developed based on its excellent potential for sustainability through reduction of the volume and radiotoxicity of both its own fuel and other spent nuclear fuel, and for extending/utilizing uranium resources orders of magnitude beyond what the current open fuel cycle can realize. In addition, energy conversion at high thermal efficiency is possible with the current designs being considered, thus increasing the economic benefit of the GFR. However, research and development challenges include the ability to use passive decay heat removal systems during accident conditions, survivability of fuels and in-core materials under extreme temperatures and radiation, and economical and efficient fuel cycle processes.

The preferred method of the present invention addresses prior art deficiencies and weaknesses while solving cooling issues found in prior art, the present invention addresses those and the other outstanding issues in prior art and with the additional safety and scram event handling for decay heat removal options and solutions provided by the present invention.

The preferred method of the present invention provides for an optimal design compared to the problematic prior art designs with the present inventions utilization of a supercritical CO2 cooled (850C outlet and 25 MPa), direct or indirect cycle system. The main advantage of these designs are the high outlet temperature in the primary circuit, while maintaining high thermal efficiency (approx. 60%). Again, the high outlet temperature and efficient supercritical fluid (comparable to corrosive sodium-cooled reactors) reduces the requirements on fuel, fuel matrix/cladding, and materials, and even allows for the use of more standard stainless steel metal alloys within the core. This has the potential of significantly reducing the fuel matrix/cladding development costs as compared to the reference design, and reducing the overall capital costs due to the small size of the turbomachinery (and other system components).

The safety system design will be affected by the choice of primary coolant, whether a direct or indirect power conversion cycle is used, and the core geometry (i.e. prism, block, plate, pebble, etc.). The trade-off between high conductivity and high temperature capabilities led to the choice of ceramics, including refractory ceramics. The reference fuel matrix for the Generation IV GFR is 5 SiC using a uranium-carbide dispersion fuel, based on a balance between conductivity and high temperature capability. The preferred method of the present invention usage of an integrated air cooling heat exchanger will provide for forced air or natural flow air cooling enabling the highest safety margin and redundant backup cooling.

While it is possible to design a GFR with complete passive safety (i.e., reliance solely on conductive and radiative heat transfer for decay heat removal), it has been shown that the low power density results in unacceptable fuel cycle costs for the GFR. It should be noted however, increasing power density results in higher decay heat rates, and the attendant temperature increase in the fuel and core. Use of active movers, or blowers/fans, is possible during accident conditions, which only requires 3% of nominal flow to remove the decay heat. Unfortunately, this requires reliance on active systems. In order to incorporate passive systems, innovative designs have been studied, and a mix of passive and active.

The cooling gas used can be many different types, including carbon dioxide or helium. It must be composed of elements with low neutron capture cross sections to prevent positive void coefficient and induced radioactivity. The use of gas also removes the possibility of phase transition—induced explosions, such as when the water in a water-cooled reactor (PWR or BWR) flashes to steam upon overheating or depressurization. The use of gas also allows for higher operating temperatures than are possible with other coolants, increasing thermal efficiency.

The fast style of reactors is intended for use in nuclear power plants to produce electricity, while at the same time producing (breeding) new nuclear fuel.

A supercritical CO2 cooled nuclear reactor containment vessel providing a thermal heat exchanger capability within the vessel, comprising one or more layers of heat exchanger chambers rather than ceramic fiber, ceramic bricks or tile such as would be conventional in an advanced gas-cooled reactor. This is provided so that the coolant temperatures achieved in a High-Temperature Reactor or a Fast Reactor can be tolerated with the vessel and provide fault tolerance and scram capability.

This invention relates to nuclear reactors, and in particular to the provision of thermal management on such inner surfaces, of a containment vessel in which is housed a supercritical CO2 cooled nuclear reactor core, as are exposed to the core coolant fluid while it is at high temperature. The invention is of particular application in relation to the internal thermal management of a stainless steel pressure vessel of a gas-cooled High Temperature Reactor or Fast Reactor, though it may also be of comparable in relation to a liquid-cooled (e.g. sodium-cooled) Fast Reactor.

The preferred method of the present invention utilizing a single metal construction without welds or seems using quadratic or squared HDLS construction. The method of the present invention unlike prior art reduces coefficient of thermal expansion to a minimum for longer life and highly reduced fatigue from mismatched materials and through welds and seam expansions.

The preferred method of the present invention utilizing the advantage over prior art with pressure and temperature from the enhanced supercritical ready pressure vessel, turbine system, heat exchanger of the present invention uses of quadratic or squared HDLS providing for no welds, joints or connections within the pressure vessel walls.

The preferred method of the present invention utilizing the advantage over prior art with integration of the direct metal deposition system used in combination of the 3d object scanning system can provide real time analysis during coating and plating for optimal thickness while removing the any faults of inadequate protection from inferior coating or plating thicknesses.

The preferred method of the present invention utilizing the advantage over prior art with integration of the thermal spray system used in combination of the 3d object scanning system can provide real time analysis and control using artificial intelligence response during coating and plating of a multiple of protection layers of various metallic and nonmetallic coating and plating materials for optimal targeted thickness while removing the any faults of inadequate protection from inferior coating or plating thicknesses.

The preferred method of the present invention utilizing the advantage over prior art with integration of the friction stir welding builds upon the quadratic or squared HDLS fabrication system while allowing joining of isolated builds to promote a larger combined component used in combination of the 3d object scanning system can provide real time analysis and control using artificial intelligence response during friction stir welding and follow-up direct metal deposition and/or thermal spraying of coating and plating for optimal thickness while removing the any faults of inadequate protection from inferior standalone processes.

The preferred method of the present invention provides enhanced thermal performance, increased temperature operational thresholds and optimized response to radioactivity with radiation containment within the system greatly exceeding prior art methods and applications.

In currently-known prior art designs of Advanced Gas-cooled Reactor having the reactor core housed in a concrete pressure vessel whose inner surfaces are covered by a metal liner, typically using a layer of thermal insulation provided on those parts of the liner which would otherwise be exposed to the coolant gas at high temperature is in the form of a layer or layers of either ceramic fibers or metal foil packs, and in either case this insulation has to be retained in place by retention means which is commonly a system of steel cover plates held in place on studs which project from the liner through the insulating layer or layers. In order to restrict the percolation of coolant gas into the thermal insulation through expansion gaps left between the cover plates is exposed to some extent to the high-temperature coolant gas.

Such an arrangement would be undesirable in a High Temperature Reactor or a Fast Reactor, especially in a case where helium is employed as the reactor coolant, typically higher temperatures achieved by the coolant causes corrosion and more so with prior art dissimilar and welded materials of the metal exposed to the high-temperature coolant develops issues concerning exposure of the insulation to high temperature coolant gas.

It has also been proposed in prior art to provide a horizontal inner surface of such a containment vessel, thermal insulation in the form of layers of ceramic bricks or tiles. According to that prior art proposal, the bricks or tiles are held into position by their own weight, and no retention means is provided or required to be thermally insulated from the interior of the vessel. This allows settling concerns and compaction issues with weight loss through operations.

The preferred method of the present invention provides for advantages over prior art utilizing enhanced pressure and temperature enables supercritical CO2 which has near 80% the density of water for the highest thermal transfer compared to prior art gas cooled reactors and gas cooled fast reactors.

The preferred method of the present invention provides for advantages over prior art from the above additionally provides for utilization of a supercritical CO2 turbine and energy system advantage with enhanced system efficiency with supercritical CO2 density versus prior art low density gas thermal transfer limitations.

The preferred method of the present invention provides for utilization of rugged, reliable, custom shaped and scaled yet compact printed design heat exchangers for both primary integrated heat exchanger and the auxiliary loop service. Integration of the heat exchangers inside the inside the pressure vessel provides for optimal efficiency.

The preferred method of the present invention allows for liner(s) with honeycomb design structures internal to the pressure vessel for support of the inner components to reduce vibrations yet offer support to the internal load and provide additional shielding.

The preferred method of the present invention provides for coating and plating of the individual parts internal and external while retaining the precise custom fit without voids with scaling of the fabrication for megawatt scale to gigawatt scale reactor potential depending on the design requirements.

The preferred method of the present invention provides for advantages over prior art from total component requirement reduction and simplification, reduced maintenance and potential failures through single material fabrication without welds and fused joints.

The preferred method of the present invention provides for advantages over prior art from enhanced operational safety margins and backup cooling contained and fabricated within the pressure vessel through a controlled high effectiveness thermal transfer heat exchanger thereby reducing the requirement for the size of active decay heat removal system, and the providing redundant solutions for an integrated active and passive decay heat removal mechanisms to facilitate both natural and forced convection.

It is an object of the present invention to reduce the efficiency penalty of conventional cooling gas systems for turbine blades and impellers by utilizing high pressure gases and/or supercritical fluids from the compressor stages and/or pumps.

It is a further object of the invention to eliminate the mechanical complexity of conventional cooling systems by eliminating tangential onboard injection, cover plates and seals.

It is a further object of the invention to utilize a high work single or multiple stage high-pressure turbine with gas path pressure lower than turbines conventionally used to enable use inline compressors of lower pressure sources for cooling gas for the turbine rotor with blades or impeller.

Further objects of the invention will be apparent from review of the disclosure, drawings and description of the invention below.

The preferred method of the present invention referred to as the altitude-compensating ARBACC, or Axisymmetric Rocket-Based Air-augmented Combined Cycle propulsion system rocket engine assembly is provided for a horizontal or vertically launched rocket vehicle. The hybrid rocket engine consists primarily of a single piece housing fabrication of the primary engine assembly and cooling jackets which also provides for an integral inlet, injector, and combustion area, flame-holder, and outlet, two or more combustion chambers each including an outlet end defining a throat exhaust area.

The preferred method of the present invention referred to as the Baldr family of rocket engines using bell nozzles utilize single piece construction The hybrid rocket engine consists primarily of a single piece housing fabrication of the primary engine assembly and cooling jackets. Utilizing the quadratic or squared selective sintering process that quintessentially reduces weight using honeycomb integrated designs while maintaining superior strength ductility, fracture resistance and thermal stress capability with a lower variability in materials properties and highly reduced coefficients of thermal expansion versus traditional fabrication and cast parts processes.

### SUMMARY

In general, various embodiments of the present invention provide for methods, applications and integrated system for cost effective and reliable component fabrication and manufacturing viability while providing for new potentials for creation of thermal and mechanical as well as other types of component fabrication. Prior art thermal and mechanical component design with flaws in fabrication and manufacturing therein have limited thermal and mechanical technology to be fully appreciated without introducing the above mentioned weaknesses and points of failure.

In reality, the ability to fabricate and manufacture cost effectively are closely bonded, design processes cannot be separated from fabrication nor can manufacturing be separated from the fabrication methods and applications to allow cost effective production. Simple fact is the reality of feasibility in engineering and designing is that a design must conform to be built cost effectively or must accept liability of lessor quality and reliability or its inability to fabricate due to cost or complexity from limitations in fabrication methods and applications.

The present invention allows scalable fabrication of commercial and utility scale parts and components without joints, connections or welds removing most potential failure points while allowing smooth and fine channel capability for conformed and unconformity in ducts and surfaces. The present inventions novel scalability and fabrication capability in itself sets the invention apart from prior art.

The consequences of using prior manufacturing of components that have differing or opposing metals, welded and joints are that systems are reported to undergo severe erosion/corrosion (E/C) damage. Additional prior art deficiencies stem from contact and use with erosive, corrosive and fouling gases and/or supercritical fluids and liquids which only amplifies the deterioration rate and/or performance and exemplifies the differences the novel advantages of the present invention.

Significant degradation of material thickness losses which worsen when different opposing material surfaces are introduced and have losses as high as1.0 to 1.5 mm/year can occur. In a number of component installations result in ruptures and other premature failures or unscheduled shutdowns often necessitating costly outages and repairs and often more frequent maintenance is required.

Additionally, the system includes methods, processes and applications for fabrication of a supercritical, transcritical and subcritical carbon dioxide (sCO2) energy system including its turbine, compressors, heat exchangers, thermal components and pumping systems with methods of fabrication and manufacturing. Various embodiments of the present invention may include carbon dioxide handling equipment, that may include, for example, a carbon dioxide source or carbon dioxide generator, a pressurizing apparatus or compressor, one or more pressure vessels, various interconnecting piping, valves, one or more vent pipes, or some combination of these items. Various embodiments of the present invention also include enclosures or enclosing walls or structure. Another embodiment will allow power, heating and cooling generation.

An embodiment presented in FIG. 21 shows a schematic and paths of direction and connection of the present inventions methods and applications of an energy conversion system, which preferably will include renewable energy generated from wind and solar but alternatively can use fossil fuels and nuclear thermal generation for input to the supercritical, transcritical and subcritical carbon dioxide energy conversion system. Thermal storage integration may be used to provide thermal energy to a supercritical, transcritical and subcritical carbon dioxide energy conversion system up to 24 hours a day 7 days a week with energy storage reserves used for peaker power generation.

Integrating renewable energy systems for input in conjunction with a combined cycle supercritical, transcritical and subcritical carbon dioxide energy conversion system allows for efficient use of supercritical, transcritical and subcritical carbon dioxide energy conversion system and increases the electric conversion efficiency of a combined cycle supercritical, transcritical and subcritical carbon dioxide energy conversion system to approximately 63-69% and above 80% when using recycled thermal waste heat for general heating and cooling applications.

A supercritical, transcritical and subcritical carbon dioxide energy conversion system can provide power generation, heating and cooling from a single system utilizing complete energy cycles of available energy. This greatly increases the overall efficiency of energy system, thereby reducing plant capital costs, lowers recurring maintenance costs and total costs of electricity production.

A supercritical, transcritical and subcritical carbon dioxide energy conversion system generally includes carbon dioxide storage and pump P2 and motor/engine/turbine powered to introduce carbon dioxide into the system at high pressure to establish and maintain adequate carbon dioxide charge and by replacement of carbon dioxide lost to leakage. High pressure piping via Ducts D1-D32, valves and other type of connectors connect the system components to circulate the gas and liquids amongst the various components and loops of the system. The turbine, generator/alternator and compressor is shown inside the dashed area can be interchanged with the various configurations shown for scaling the system up or down.

A primary heat exchanger HX1 is used for transfer of external generated thermal energy input to inject thermal energy into the carbon dioxide top cycle for input to the primary turbine T1 and generator/alternator 1 and main compressor MC, secondary turbine T2 and generator/alternator 2 and recompressor RC, gas film compressor BC (turbine bearings) and motor/engine/turbine, high temperature recuperator/heat exchanger HX2, low temperature recuperator/heat exchanger HX3, gas precooler/heat exchanger HX4, condenser, transcritical turbine 3 and generator/alternator 3, pump P1 and motor/engine/turbine, secondary compressor SC and motor/engine/turbine, heat exchanger HX5, heat exchanger HX6. Heat exchanger HX7, expansion valve and evaporator.

An embodiment presented in FIG. 2 shows a diagram of an integrated multistage multiple turbine system example that does have the gas film bearing system components but is only a reference as other cooling and lubrication methods may be used.

The present invention allows single component fabrication of impellers and rotors with blades without using joints, welds and other types of connections. This will allow high pressure gases and/or supercritical fluids and fluids to be used as lubrication within the component build while reducing the number of seals or the size of the seals while still allowing seals to substantially limit leaks. The present invention provides for channels both conformed and nonconformed for the purpose of creating mixing vortices which may include mixing systems such as vortex generators to create turbulence within the cooling channels.

This may be established within the fabrication of the rotor with blades or impellers, vanes and injectors of both radial and axial turbine components to assist in cooling effectiveness not achievable from prior art. The present invention provides the ability to create and fabricate complex geometries within channels and ducts of the component build that along with scalable methods for fabrication enable previous inaccessible and unavailable complex scalable designs to create optimal design specifications monetizing previous prior art advances into a single fabricated component.

The present invention with its ability to scale the component builds provides for cooling and lubrication channels and systems design build within a single component build that has no joints, welds, fusions or connections thereby offering the highest performance and efficient possible. The present invention will provide for higher turbine temperatures and pressures to allow for higher turbine efficiencies. The present invention will provide for higher thermal cooling efficiency while reducing thermal stresses to the components to a minimum. The present invention provides turbine manufacturing with greater efficiency and greater power potential through scaling.

The present invention provides for heat exchangers to fabricated to higher levels of pressure capability while greatly surpassing prior art. For example, prior art typical heat exchanger design provided for 80-90% effectiveness, the newest technique referred to as Printed Circuit Heat Exchangers (PCHE) typically provide 90-96% effectiveness whereas the present invention is capable of fabricating a Printed Design Heat Exchanger (PDHE) with effectiveness as high as 99% without prior art deficiencies that had joints, welds, fusions, material usage limitations due to manufacturing issues and sizing constraints.

The present invention provides for optimizing the component design for optimal contact surface area for maximizing thermal energy transfer, reduction of parasitic losses and reducing material requirements thereby also reducing the weight and space requirements while maintaining the optimal material characteristics from the chosen material used for the fabricated component.

The present invention provides for the targeted component to be easily designed and then fabricated with a number of materials for a customized solution for gases and/or supercritical fluids or liquids, clean or fouling and even corrosive on a beneficial and cost effective basis advantage of prior art.

The present invention provides for fabrication with capabilities of the highest thermal effectiveness, highest temperatures, highest pressures, lowest pressure drops, highest compactness, highest erosion resistance, highest corrosion resistance and longest life advantages over any prior art and is only limited by the material characteristics chosen for fabrication. The present invention provides for predetermined estimates for component replacement and repair by selective material choice and material thickness prior to fabrication. The present invention requires no special orders of materials as such provides for lower material costs, short lead times greatly reducing downtime and project delays hence greater cost reductions and lower cost of energy and cost of ownership.

This process can however by itself impose additional issues as the fabricated components are generated from powder, the surface roughness and the geometrical accuracy lies within the range of the powder grain size. The achievable part accuracy depends on which powder material is used, varying from about ±20-250 μm. Shrinkage during exposure can impose additional errors of accuracy.

Amalgamating a CNC process for cutting, smoothing, polishing or joining components after the HDLS process will allow finished product accuracy with extremely tight precision of 1-2 μm tolerances. Thereby benefiting from the speed of fabrication using quadratic or squared plurality of laser assemblies for sintering a component to CNC process refining the precision of the final characteristics of the fabricated component.

For instance, both radial inflow turbines and axial flow turbines are turbo machinery designs that are both affected by blade design build capability, support structure and cooling issues. Use of only CNC machine fabrication would require solid blades, welding or other types of attachment. Note however cooling channels thru the blades without joints, welds or other attachment would also not be possible with CNC only fabrication. Joints and welds promote faster material break down through corrosion and material weakness. Radial inflow turbines are limited in scaling ability due to blade overheating from lack of blade cooling capability afforded through standard CNC fabrication techniques.

Quadratic or squared HDLS for rotors with blade cooling channel builds could allow radial turbines to scale from 1 kw to 100's of megawatts and axial turbines along with the new radial blade designs would have considerably longer lifespans and higher temperature capabilities with lower maintenance issues and requirements. Slight quadratic or squared HDLS high density multiple layer heating and sintering overbuild of particular areas of component builds would allow precision CNC machining as a subject of refining component accuracy could be preplanned to match exact product characteristic requirements. This strategy would allow tolerances of quadratic or squared HDLS of 20-250 μm accuracy to be tightened to only 1-2 μm tolerance greatly enhancing accuracy and component performance.

These manufacturing capabilities would be an important step towards provisioning next generation manufacturing, this would include manufacturing capacity of high temp high pressure since piece construction with conforming and non-conforming channels and optimized features of power system components, especially opening up a new market as a manufacturer of next generation Steam and Super Critical CO2 turbine generation systems and components.

Heat exchangers are greatly affected by less than optimal surface contact area ratios, pressure drops from sub-optimal flow channels and by thermal transfer losses from sub-optimal excess material design from previous manufacturing method limitations equates to higher thermal losses, higher pressures also thereby require wider tolerances to enhance safety margins often requiring over building deeply affecting the typical build cost. New designs with highly optimized flow channels and thermal transfer material surface contact ratios could be fabricated in single piece construction, CNC machining of high pressure connection surfaces would promote use of higher temperatures and higher pressures with a wider degree of safety.

Quadratic or squared HDLS 1000 printing will allow designs for turbine blades with conforming and nonconforming cooling channels within a solid piece, turbine assemblies with conforming lubrication channels and oil sump collection areas within solid component builds. Highly optimized heater exchanger/recuperator designs with previously unavailable efficiency or not cost competitive or affordable from a manufacturing difficulty or simply a cost basis. The HDLS system is comprised by four primary internal control sections, the DMLS control system 1001 handles overall control and functioning of the system and is responsible for communication to external systems.

Lift points and gantry 1008 can be used to manually move items within the HDLS machine. The power supply system 1002 is responsible for providing fixed and variable power to the various components and is monitored and controlled via interface to the DMLS control system. Laser optics control 1006 and laser power control 1004 operate and cooling of the lasers, galvo mirrors and focusing optics for the HDLS system. The object scanners 1012 which type to be used can vary depending upon needs and materials.

Using lasers in a quad grid array 1014 will allow scaling build size while minimizing optical mirror directional errors by enforcing smaller laser build fields. Build rate can be as low as 10 μm per layer. For example, using 16-inch×16 inch or 18-inch×18 inch overlapping grid quadrants using quad lasers within each grid quadrant setup would allow fast build rates for larger component manufacturing. This additionally would allow volume building of smaller component within a single build session and single device.

For instance, each 3 feet by 3 feet build size could involve 4 lasers while a 16 feet by 16 feet could use 16 or 64 lasers. Utilizing a transparent thermal barrier 1016 will allow the lasers to fuse material while trapping excess thermal energy within the build chamber thereby using the entire build area as an integrated heat treatment or metal aging area. Alternatively, the transparent thermal barrier 1016 may be extended outward to also shield the 3D object scanners from the thermal energy within the build area.

Using a standard vacuum system 1024 and using cyclone separation 1026 along with grid based sieve/sifter for separation of contaminated materials and for return of usable materials for build reuse. The cooling system 1032 and heating system 1030 can also be used to transfer thermal energy to the material storage and moderate the main build area for constant thermal modulation. A nitrogen generator 1034 can be used with using nitrogen gas as the shield gas, alternatively other gases such as helium, argon may be utilized. A gas purification 1028 can be used to remove unwanted gases and fumes. A pressure door 1040 when used in the standalone HDLS System 1000.

Thermal vents 1036 near the fuse surface can be used for venting thermal energy and fumes away from the build surface.

The HDLS system 1000 may alternately have external control, power, material, thermal management and gas systems.

The HDLS system 1000 will typically use an integrated CNC Processing System with tools for polishing, smoothing, coating and such to promote robotic automation.

The cartridge system consists of a primary build cartridge 1018 and sump cartridge sump 1 cartridge 1020 and optionally sump 2 cartridge 1022. The sump cartridges can be used as supply cartridges or for excess storage. The cartridge system can be supported via a host of methods but preferably a track/rail and carriage system 1038. Alternately a stationary piston 1021 or scissor lift could be used for stationary HDLS system 1000 installation.

The CNC Processing System 1042 is comprised by a framework that utilizes a track or rail based crane, winch, or robotic arm transfer system, The CNC gantry 1046 or alternately a track or rail based system for moving the CNC tool assembly 1048. The CNC Processing System area may be in an enclosure 1050 by coverings or panels to capture gases and fumes and contain airborne materials for containment within the CNC work area accessed via an access door.

Internal CNC tool assembly 1095 utilizes a DMD assembly consisting of a laser 1302 and a material feed and gas supply 1304 to apply material and vacuum 1306 to remove powdered material.

External CNC tool assembly 1048 utilizes a DMD assembly consisting of a laser 1302 and a material feed and gas supply 1304 to apply material and vacuum 1306 to remove powdered material, alternately a gas containment hood 1312 may be used.

External CNC tool assembly 1048 utilizes a DMD assembly also comprising a 3D object scanner 1310.

Completed fabrications are handled with a manual or robotic product transport 1052

The CNC Processing System 1042 may be integrated with a tank or vessel fabrication system utilizing DMD or friction stir welding system 1056, Tank or vessel rotation support system 1058 to consisting of rollers and motorized rotation system to rotate the tank or vessel of complete rotations for DMD fusing or friction stir welding.

The primary build cartridge 1018, Material sump 1 cartridge 1020, material sump 2 cartridge 1022. The ducted platform 1070 supports the ducted build plate 1082 which is raised or lowered with the actuator scissor lift or piston 1074. Thermal transfer is effected from side thermal input 1072 or side thermal input 1078, thermal exchange from the vent tray 1076 through the telescopic duct 1084 to the top thermal duct 1086 which transfers thermal energy through ducted top plate 1080 which transfers thermal energy to the top build platform 1070 and the ducted top build plate 1082.

The quadratic or squared laser array 1090 consists of thermal management gas flows individual using layout pattern 1094 of single lasers 1089 which has a focus assembly 1098 for beam width control, mirror 1102 is used to change direction of the beam into the X axis galvo 1104 and Y axis galvo 1106 which is directed through the transparent thermal barrier 1016 to the targeted surface.

Gantry 1008 allows travel for the multi-axis CNC assembly 1095 that directs the location of the DMD and material removal attachment 1096

HDLS will fabricate metal honeycomb designs such as hexagonal 2000, reinforced hex 2002, square hex 2004, circular 2006, over-expanded 2008, flexible hex 2010, criss cross hex 2012, multiple flexible hex 2014

Friction stir welding in joint weld configurations such as Butt 2020, Butt Laminate 2022, Lap 2024, Lap Laminate 2026, Butt joint both sides 2028, T-Butt 2030, L-Outside 2032, Flange 2034, Multi-thickness 2036, T-Single weld 2038, T-Butt dual pass 2040, L-Inside 2042

The preferred method of the present invention it should be noted using a quadratic or squared system provides a system to use tighter integration using more lasers in a smaller footprint for enhanced sintering and density, alternately this would also benefit higher power lasers with beam splitters to remove heat buildup from concentrated areas of multiple laser with each having thermal build up and also requiring a more complicated cooling configuration with cooling lines carrying thermal energy away and coolant

Oil-free turbomachinery (TMs) require gas film bearings for enhanced rotor dynamic stability, mechanical efficiency, and improved reliability with reduced maintenance costs compared with oil-lubricated bearings. Implementation of gas film bearings into stationary and mobile TMs requires careful chosen design parameters for stability, thermal management with accurate measurements to verify model predictions. Gas foil bearings (GFBs) are customarily used in oil-free turbomachinery because of their distinct advantages including high tolerance to shaft misalignment and centrifugal/thermal growth, and large damping and load capacity compared with rigid surface gas bearings. Flexure pivot tilting pad bearings (FPTPBs) are widely used in high-performance turbomachinery since they offer little or no cross-coupled stiffness's with enhanced rotor dynamic stability. The present invention provides details offering high rotor dynamic performance, sealing capabilities and temperature characteristics of oil-free TMs.

A turbine, impeller and/or rotor, bearing with seals assembly for use in turbomachinery is provided. The turbine impeller and/or rotor has a connection area adapted to mounting to a shaft, and an airfoil area extending from the root area extending from the connection area. A cooling gas duct is provided and adapted to communicate with the gas plenum as a consequence of turbine shaft components interconnection while gas is communicated through ducts and/or channels in the blades that are connected to the rotor. Pressurized gas is provided to a cooling gas channel defined within a blade airfoil area of the impeller and/or rotor for the purpose of cooling the blades. Turbomachinery components includes high ratio heat exchangers optimized for enhanced thermal dynamic operations is also provided. A turbomachinery system also includes the linear advanced bearings and seals gallery assembly in connection with the shaft and in communication with gas or liquids for the purpose of support, sealing and cooling of the assembly.

The a linear advanced bearing and seal gallery assembly is configured to support and seal a rotating shaft of a turbo machine having a high pressure process gas or liquid, comprising a housing defining an orifice configured to receive the rotating shaft, a linear advanced bearing and seal gallery assembly, wherein the housing is mounted to a casing of the turbo machine; a first sealing stage comprising a seal and configured to reduce down the high pressure process gas or liquid to an acceptable lower pressure level; a labyrinth seal mounted longitudinally outward from the first sealing stage; and an optional labyrinth stage may be mounted longitudinally inward from the first labyrinth stage; a thrust bearing mounted longitudinally outward from the labyrinth seal: and a titling journal pad bearing array mounted longitudinally outward from the thrust bearing and a second sealing stage mounted longitudinally outward from the labyrinth seal, wherein the second sealing stage comprises a tandem seal having a primary seal and a secondary seal axially spaced with an intermediate labyrinth seal and an outer labyrinth longitudinally outward from the tandem seal.

A linear advanced bearing and seal gallery assembly for forming a bearing to support the shaft and seal between a rotating shaft and a casing of a turbo machine having a high-pressure process gas is herein disclosed. The linear advanced bearing and seal gallery assembly may include a housing defining an orifice configured to receive the rotating shaft and linear advanced bearing and seal gallery assembly, wherein the housing is mounted adjacent the casing; a high-pressure seal radially coupled proximate to an outer edge of the casing, wherein the high-pressure seal is configured to reduce the high pressure process gas to a first pressure lower than the high pressure; a high-pressure labyrinth seal mounted longitudinally outward from the high-pressure seal and configured to partially restrict the flow of the process gas along the rotating shaft and separate the process gas from the high-pressure seal; optionally inner labyrinth seal can be used of further lower process gas leakage, a single dry gas reduction seal mounted longitudinally outward from the high-pressure labyrinth seal and configured to reduce the process gas from the first lower pressure to a second pressure lower than the first pressure; a labyrinth seal mounted longitudinally outward from the single dry gas reduction seal; a tandem dry gas seal mounted longitudinally outward from the labyrinth seal, wherein the tandem dry gas seal comprises a primary dry gas seal and a secondary dry gas seal axially spaced with an intermediate labyrinth seal; and a separation seal mounted longitudinally outward from the tandem dry gas seal.

Also disclosed herein is another linear advanced bearing and seal gallery assembly configured to form a seal on a rotating shaft of a turbo machine having a high pressure process gas. The linear advanced bearing and seal gallery assembly may include a first sealing stage comprising a single dry gas seal extending circumferentially around the rotating shaft and configured to reduce the high pressure process gas to a lower pressure; a labyrinth seal mounted longitudinally outward from the first sealing stage and extending circumferentially around the rotating shaft; optionally an inner labyrinth can be used to further lower process gas leakage, and a second sealing stage mounted longitudinally outward from the labyrinth seal and extending circumferentially around the rotating shaft, wherein the second sealing stage comprises a tandem dry gas seal having a primary dry gas seal and a secondary dry gas seal axially spaced with an intermediate labyrinth seal.

Lastly, a method configured to form a seal on a rotating shaft of a turbo machine having a high pressure process gas is herein disclosed. The method may include additional stages to reduce the high pressure gas to a lower pressure using a single dry gas seal extending circumferentially around the rotating shaft; providing a labyrinth seal mounted longitudinally outward from the single dry gas seal and extending circumferentially around the rotating shaft; optionally an inner labyrinth seal can be used to further reduce process gas leakage, and reduce the lower pressure gas to about atmospheric pressure using a tandem dry gas seal mounted longitudinally outward from the labyrinth seal and extending circumferentially around the rotating shaft, wherein the tandem dry gas seal comprises a primary dry gas seal and a secondary dry gas seal axially spaced with an intermediate labyrinth seal.

Turbomachinery typically operates in one of two modes or both, the first mode is as a turbine to extract energy from a flow and the second mode is as a compressor for the flow. In turbine mode an input gas flow delivers compressed gas or liquids to the turbine input, thus boosting the torque output of the turbine shaft connected to the rotor and blades or impeller. A turbine wheel whether a rotor with blades or an impeller in the turbine housing is rotatable driven by an inflow gas or liquid supplied. The present invention uses a shaft is rotatable supported by linear advanced bearing and seal gallery assembly linear advanced bearing and seal gallery assembly housing connects the turbine wheel to a compressor rotor and blades or impeller in the compressor housing so that rotation of the turbine wheel causes rotation of the compressor rotor and blades or impeller. In compressor mode the compressor rotor and blades or impeller rotates, it increases the gas mass flow rate, gas flow density and gas pressure delivered to the output duct.

### Summary

The preferred methods and applications of the present invention provides for proprietary novel advantages over prior art in its ability to form passages and ducts within fabricated components. The method allows micro-channels and ducts with extremely small passages not normally quite in laminar flow region. The method of creating passages within components does not in any way constrain them to be straight or normal zig-zag configured channels or ducts, the method also does not constrain the channel or duct to be conformed as the channel is allowed to have unconformity such as vortex generators and other means of swirl creation for intermixing flow for superior thermal transfer characteristics greatly exceeding prior art including diffused bonding technologies.

The methods resultant frequent vortices of the flow disrupt the boundary layer, this method gives greatly enhanced thermal energy transfer for the same expenditure of pressure drop, this method effect especially occurs at the very low Reynolds number seen. The method allows the design to match requirements for optimization and adaptation for design to allowed pressure drop for the particular component. This method gives the designer the ability to customize material characteristics, thickness, channel and duct sizing to also include anticipated corrosion and erosion rates to enable the highest safety ratings. The methods of the present invention also reduce fouling due to the rapidly changing vortexes. The methods allow for channel and duct size to exceed expected blockage and adjust to remove hydraulic hammering effects.

The preferred methods of the present invention provide additional advantages over prior art such as components two to three times lighter and in most cases size to ten times smaller due to the inventions ability to use honeycomb style reinforcement, ability to use precise material thicknesses which also enhances efficiencies greater than previous art allowed of equivalent requirements and tolerances. This design feature has space and weight advantages, reducing connection counts with piping and valve requirements.

The preferred methods of the present invention provide for extreme pressures from the lack of joints, welds and fusions thereby not incurring penalties from unlike materials and their associated material weakness, thermal stress reduction, reduced corrosion and erosion properties. Using unlike materials can also attribute corrosion due to galvanic corrosion which occurs when an electrolytic fluid passes dissimilar materials such as ships require a sacrificial anode which unfortunately using exposed fused surfaces like those of prior art such as the PCHE process and others for example utilization of welding introduces by new faults and failures by default.

The preferred method of the present invention allows use of exotic metals such as titanium, tungsten or nickel and allows special allows such as aluminum with titanium and other customized metallurgy. This method would provide for a base material to be melted in an electric arc furnace and then blended to create a special custom alloy metallurgy that matches an individual need for hardness, corrosion resistance, psi tensile strength and temperature handling capability requirements to match the particular specific component requirements. Various hardening can also be done prebuild or post build with common treatments such as annealing, aging and other methods.

The preferred method of the present invention provides for: advantages over prior art of greatly enhanced pressure capability in excess of 2400 bar (35,000 psi) and enhanced ability to cope with extreme temperature exposure, those ranging from critical cryogenic temperatures to high temperatures of 1000° C. (1832° F.).

The preferred method of the present invention can provide components with high thermal effectiveness of 99% in each component. They can incorporate several process streams into a single unit or separate process steams into modular units to enable greater handling and shipping capability. Additional functions and functionality can be included in to component design, such as gas or chemical mixing and reaction, mass transfer and mixing, optimizing the process considerably. For example, the heat exchanger compactness allowing tight integration to a reactor for enhanced thermal capture and reduced loss while allowing greater maintenance access. Integrated recuperator such as the present invention for a lower thermal chain without adding an additional heat exchanger thereby lowering material requirements, increased efficiency and lower costs.

A turbine, impeller and/or rotor, bearing with seals assembly for use in turbomachinery is provided. The turbine impeller and/or rotor has a connection area adapted to mounting to a shaft, and an airfoil area extending from the root area extending from the connection area. A cooling gas duct is provided and adapted to communicate with the gas plenum as a consequence of turbine shaft components interconnection while gas is communicated through ducts and/or channels in the blades that are connected to the rotor. Pressurized gas is provided to a cooling gas channel defined within a blade airfoil area of the impeller and/or rotor for the purpose of cooling the blades. Pressurized gas flow is also provided to a cooling gas channel to provide cooling for nozzles and vanes. Turbomachinery components includes superior high surface area ratio heat exchangers optimized for enhanced thermal dynamic operations. A turbomachinery system also includes the linear advanced bearings and seals gallery assembly in connection with the shaft and in communication with gas or liquids for the purpose of support, sealing and cooling of the assembly.

The preferred method of the present invention will allow conforming and nonconforming channels and ducts within the fabrications to provide efficient thermal modulation of fabricated components, whether that be the turbine, rotor and blades or the impeller, turbine casing, the bearing and seal array assembly or the heat exchangers in the system all benefit from the ability of the present invention to moderate pressure loss while maximizing vortices for system efficiency.

An GFFPTP journal bearing includes an outer support ring and flexure or balanced pivot tilting pads disposed on an inner surface of the outer ring. The outer surface of the outer ring provides mounting for the outer bearing surface connection. The flexure or balanced pivot tilting pads, which provide the inner bearing surface, are formed separately from the outer support ring and press fit into slots formed in the surface of the outer support ring. Since they are formed separately, the manufacturing process used to form the outer support ring and tilting pads is not limited since the geometry of each component can be created with commonly used machine equipment, reducing manufacturing costs relative to some conventionally manufactured FPTP bearings.

In some aspects a journal bearing includes a cylindrical outer support ring and a flexure or balanced pivot tilting pad. The outer support ring includes a first end, a second end, a longitudinal axis that extends through the first end and the second end, a radially outward-facing bearing surface, and an inner surface opposed to the radially outward-facing bearing surface. The inner surface includes an axially extending pad mount. The flexure or balanced pivot tilting pad includes a bearing member that provides a radially inward facing bearing surface, an anchor portion, and a mount that connects the bearing member to the anchor portion. The anchor portion is inserted in the slot in such a way that the pad is secured to the outer support ring, and the bearing member is pilotable relative to the outer ring inner surface.

The journal bearing may include one or more of the following features: The anchor portion is press fit within the slot. The groove is blind relative to the outer ring first end and the outer ring second end. The anchor portion has a pentagonal profile, and the groove has a curved profile. The web is disposed closer to a trailing end of the bearing member than to a leading end of the bearing member relative to a direction of rotation of the shaft. The journal bearing may include a retaining ring disposed within the outer support ring, the retaining ring configured to retain the flexure or balanced pivot tilting pad within the outer ring. The retaining ring is press fit within the outer support ring.

The journal bearing includes a retaining pin to be inserted within the outer support surface of the bearing, the retaining ring configured to urge the anchor portion radially outward and into the groove. The journal bearing uses a connector to the supply gas to communicate gas to create the film between the shaft and the journal bearing. The journal bearing includes a first retaining ring disposed within the outer ring on a first axial side of the flexure or balanced pivot tilting pad and a second retaining ring disposed within the outer ring on a second axial side of the or balanced flexure tilting pad.

The invention provides a turbomachinery having a single stage or multiple stage high work high-pressure turbine with unique blade foil and vane cooling capability. The turbine blades include a cooling gas inlet duct communicating with a cooling gas plenum with pressure above the hot gas path pressure. A blade airfoil extends radially from the root with internal channels and includes cooling air channels communicating between the cooling air inlet duct, transfer ducts through the connecting components as the cooling gas path of the turbomachinery. The gas cooling system includes an inlet extending into the cooling gas plenum with an inlet aperture to communicate cooling gas from the plenum as a consequence of the pumping due to turbine rotation. The turbomachinery includes a high-pressure compression stage in flow communication with the cooling gas plenum. Advantageously, the turbomachinery includes a bearing gallery adjacent the cooling gas plenum, where the bearing and sealing gallery includes a cooling gas jacket in communication with the high pressure compression stage, and the cooling gas jacket communicates with the high pressure cooling gas plenum. A seal array is provided between the hot gas path and the cooling gas plenum.

The use of a gas inlet and ducts in conjunction with the high work single stage or multiple stage high pressure turbine is feasible for the following reasons. The high work single stage or multiple stage high pressure turbine has a gas path pressure that is higher than conventional turbines and for this reason high pressure cooling gas sources can be utilized. The cooling gas pressure must be at least somewhat marginally higher than the gas path pressure in order to ensure that cooling gas of sufficient quantity is conducted through the high pressure turbine blades to affect cooling. The invention, greatly simplifies turbine blade or impeller cooling systems by providing a high pressure cooling gas plenum and duct system connected with the high pressure turbine rotor and blades or impeller while still or rotating. Extending into the cooling gas plenum are the blade roots of the turbine blades or impeller together with gas ducts oriented to communicate cooling gas from the plenum as a consequence of the turbine rotation.

Therefore, the invention eliminates tangential onboard injectors, cover plates and associated seals that are conventionally necessary to increase the pressure of cooling air. Since the hot gas path pressure is lower for high work turbines, low pressure air can be drawn through the rotation of the inlet scoops by the rotating turbine within a cooling air plenum supplied by low pressure cooling air from the low pressure stage of the compressor.

It is possible to form the frame and interconnect assembly from to single plate of metal which is fabricated via direct metal laser sintering. Prior are used other fabrication methods such as pressed, formed and casted methods. There are regions of prior art where, there are regions in the sealing surfaces between one cell/frame assembly and the next where the metal parts are unsupported or cantilevered. As a result, the metal parts can creep at the high operating temperatures required for a solid-oxide fuel cell, causing failure in the seal joints and potentially a catastrophic collapse of the stack structure. Other fabrication methods often used require costly machining of the components used in the frame and interconnect assembly.

A SOFC fuel stack module via high temperature, high pressure sealing connections including an integral high effectiveness stack heat exchanger manifold containing all of the gas and fuel distribution necessary for supply and exhaust of fuel and cathode oxygen to and from the stack chimneys and carbon dioxide (CO2) thermal control pathways for removal of excess thermal energy from the SOFC stack. The stack is mounted and hermetically joined directly to the heat exchanger manifold that has couplings for inlet and outlet ports to provide for fuel and oxygen system distribution and thermal management system.

The heat exchanger manifold preferably is fabricated of Inconel 600 series stainless steel, and preferably formed in a one-piece direct metal laser sintering fabrication. Preferably, the heat exchanger manifold includes thermal balancing into adjacent fuel, cathode oxygen channels and CO2 cooling channels to enhance balancing of temperatures by heat exchange and removal of thermal energy thereof. Heat exchange may be further improved by configuring the heat exchanger manifold to have a plurality of interleaved anode, cathode gas supply and CO2 cooling channels.

A solid oxide fuel cell (SOFC) stack assembly is the primary power-producing component in an SOFC electric power plant such as an auxiliary power unit (APU) for a vehicle, a central power generating unit (CPU), a combined cooling, heat and power unit (CCHP), or other such system such as a combined cooling, freezing, heat and power (CCFHP). In a practical and in practice of the manufacturability of a SOFC power system, the stack assembly typically is manufactured as a primary component mounted into a power generation system for ease of assembly, service, and replacement.

The power generation system provides fuel to the anode side of the stack, and provides oxygen as an oxidant and CO2 coolant for excess heat removal from the SOFC fuel cell stack. Partially depleted fuel gas is recirculated from the stack for reuse. The SOFC fuel cell stack must be maintained at an operating temperature between 650° C. and 1000° C., and preferably between 750° C. and 800° C. to optimize the SOFC operation while moderating thermal stress on the fuel cell material integrity and provide the CO2 combined cycle energy system adequate working temperature outputs.

The fuel and cathode oxygen typically are fed to and removed or recycled from the stacked individual fuel cells by integral fuel, gas and CO2 distribution channels within the stack known in the art as “chimneys”. The chimneys are carefully designed to distribute evenly to the anode and cathode gas cavities of each fuel cell unit in the stack. The gases and/or supercritical fluids or liquids entering and exiting the stack must also be routed in such a way that they are properly distributed to the chimneys to assure even flow distribution across the surfaces of each cell within the anode and cathode gas cavities.

A stack must be easily and reliably mounted to, and removable from, a system manifold with a good seal assuring minimal leakage of oxygen and/or fuel and/or CO2. In addition, for proper sealing of the multiple layers in a stack, a compressive load must be maintained within the stack at all times.

In the prior art, these functions have been achieved by a specific arrangement wherein the stack is mounted to a base plate which in turn is mounted onto a system manifold. The base plate has openings in it that align with the chimneys as well as with openings in the system manifold. The distribution of gases and/or supercritical fluids to the chimneys is determined by the configuration and design of the system manifold. See, for example, U.S. Pat. No. 6,967,064 B2 and US Patent Application Publication No. US 2003/0235751 A1. The stack is sealed to the base plate by a high-temperature adhesive seal, and the base plate is sealed to the system manifold by a compressive high-temperature gasket.

In this prior art arrangement, the compressive loading mechanism must provide load not only for integrity of the stack layers but also through the stack to maintain a much higher compressive sealing load on the base plate gasket. There are multiple drawbacks to these prior art designs.

First, the SOFC plates, must closely match the coefficient of thermal expansion (CTE) of the fuel cell stack components, prior art tended to be extremely thick and quite large in their attempts to also maintain a uniform compressive load on the gasket.

Second, prior art system manifold typically used inexpensive stainless steels using complex connections between components such as glass to metal housekeeper seals to have sufficient structural rigidity in attempts to maintain a uniform compressive load on the gasket against the base plate, this however highly limited fuel cell operational life expectancy while attempting to provide sealing and rigidity at high SOFC operating temperatures.

Third, the stack compressive loading mechanism must provide more load than is required for stack seal integrity in order to provide sufficient load for the gasket, a deficiency of prior art was when the temperature rises the supporting bolts for compression also experiences thermal expansion thereby allowing leakage to occur and prior art typically used inexpensive metals with lower characteristics and is therefore heavier duty and dimensionally larger than would otherwise be necessary.

When a prior art SOFC power system is constructed to account for all these considerations, distribution of fuel and oxygen, thermal balancing result in suboptimal operation, leakage allowing the potential for fires, overheating and partial of complete system failure.

What is needed in the art is a design and assembly arrangement for an SOFC stack and manifold that prevents leakage between the stack and the manifold and reduces the compressive loading requirement on the stack. Preferably, an individual stack heat exchange manifold includes structures extending into adjacent fuel, cathode oxygen and CO2 cooling chambers to enhance thermal balancing of gas temperatures and for excess thermal energy removal. Heat exchange may be improved still further by configuring the heat exchange manifold to have a plurality of interleaved anode, cathode gas supply and CO2 cooling chamber cavities.

It is a principal object of the present invention to prevent leakage of fuel and/or cathode oxygen and/or CO2 from between an SOFC stack and a stack heat exchange manifold.

It is a further object of the invention to reduce the weight, size, cost, and complexity of an SOFC power unit.

It is a still further object of the invention to greatly improve the durability and reliability while simplifying manufacturability of an SOFC power unit.

It is a principal object of the present invention to provide an improved fuel cell assembly wherein the assembly is formed of inexpensive fuel cell modules and components.

It is a further object of the invention to provide such a fuel cell module primarily formed from metal and ceramic parts and a PEN cell element.

It is an object of the present invention to provide inner surfaces of a containment vessel of a CO2 cooled reactor with thermal management and internal backup thermal management which presents to high-temperature supercritical fluid within the pressure vessel isolation between channels while promoting substantial thermal distribution and management of thermal energy within the pressure vessel of the reactor.

According to the invention in its broadest aspect, there is provided a. nuclear reactor containment vessel having an internal surface faced with a multiple channel heat exchanger which provides for rigid mounting surfaces and rigid connections of studs and supports for detainment of thermal insulation which comprises a layer of ceramic or graphite bricks or tiles.

The invention will be more fully understood from the following description of various preferred embodiments of it, as applied to the gas-cooled High Temperature Reactor, with reference to the accompanying drawings, in which:

FIG. 22x is a vertical section through the lower end of a stainless steel pressure vessel of a High Temperature Reactor, showing regions of its inner surfaces which are provided thermal management heat exchanger with mounting arrangement for additional heat exchangers, material supports and/or insulation in accordance with the invention;

### BRIEF DESCRIPTION OF THE DRAWINGS

The present disclosure is best understood from the following detailed description when read with the accompanying Figures. It is emphasized that, in accordance with the standard practice in the industry, various features are not drawn to scale. In fact, the dimensions of the various features may be arbitrarily increased or reduced for clarity of discussion. In order that the invention may be readily understood, one embodiment of the invention is illustrated by way of example in the accompanying drawings. Further details of the invention and its advantages will be apparent from the detailed description included below.

FIG. 1 is an internal view of the present inventions quadratic or squared HDLS with 3D object scanners shown

FIG. 2 is an internal view of the present inventions quadratic or squared HDLS with 3D object scanners, thermal vents and transparent thermal barrier shown

FIG. 3 is an internal view of the present inventions quadratic or squared HDLS with 3D object scanners, thermal vents, transparent thermal barrier and cartridge carriage/rails/track shown

FIG. 4 is an external view of the present inventions quadratic or squared HDLS with support services moved external to the main machine

FIG. 5 is an external view of the present inventions quadratic or squared HDLS with example method of a potential door and seal

FIG. 6 is an external view of the present inventions quadratic or squared HDLS with open CNC Processing System

FIG. 7 is an external view of the present inventions quadratic or squared HDLS with enclosed. CNC Processing System

FIG. 8 is an external view of the present inventions quadratic or squared HDLS with open CNC Processing System and Manual/Robotic Transport.

FIG. 9 is an external view of the present inventions quadratic or squared HDLS with open CNC Processing System with Tank or Vessel Construction System and Manual/Robotic Transport.

FIG. 10 is an external top view of the present inventions quadratic or squared HDLS with enclosed CNC Processing Stations and. Manual/Robotic Transport, view of the present inventions quadratic or squared HDLS and enclosed work area capable of single and multiple arm with CNC system and tool system to contain and exhaust gases and fumes additionally contain materials within the CNC work area.

FIG. 11 is an internal view of the present inventions quadratic or squared HDLS cartridge

FIG. 12 is an internal view of the present inventions quadratic or squared HDLS cartridge with thermal transfer with heated bed and completing the HDLS 3D thermal management system

FIG. 13 is an internal view of the present inventions quadratic or squared HDLS cartridge with thermal venting and material capture

FIG. 14 is an exposed view of the present inventions quadratic or squared HDLS cartridge with thermal management ducting and material capture shown

FIG. 15 is a view of a HDLS Quad Laser Array, HDLS Quad Laser Array with w/DMD Insert and Repair System, HDLS Quad Laser Array with multiple DMD Insert and Repair System

FIG. 16 HDLS Quad Laser Array with thermal gas vents layout and individual laser setup with focus lens system and targeting X axis and Y axis galvo with thermal barrier shown

FIG. 17 is an external view of the present inventions quadratic or squared HDLS with internal and CNC mounted DMD injection and repair attachment

FIG. 18 is a view of the CNC Processing System friction stir welding attachment

FIG. 19 is a view of examples of honeycomb design techniques

FIG. 20 is a view of example of friction stir welding techniques

FIG. 21 is a schematic of a Supercritical, Transcritical and Subcritical Energy Conversion System according to one or more aspects of the present disclosure.

FIG. 22 is a schematic of a Supercritical, Transcritical and Subcritical Energy Conversion System according to one or more aspects of the present disclosure.

FIG. 23 is a view of the example of Dual CO2 Cooling as optional to Supercritical, Transcritical and Subcritical Energy Conversion System FIG. 24 is a view of the configuration of a LABS—Linear Advanced Bearing and Seal System: 1. Primary Shaft Sleeve 2. Intermediate Sleeve 3. Inner Sleeve 4. Adjustable Threaded Collar 5. Upper Lock Collar 6. Upper Lock Ring 7. Lower Lock Collar 8. Lower Lock Ring 9. Outer Labyrinth 10. Optional Inner Labyrinths 11. Intermediate Labyrinth 12. Inner Labyrinth 13. Outer Level Pad 14. Inner Level Pad 15. Outer Stationary Seal Bearing 16. Inner Thrust Bearing 17. Thrust Ring 18. Outer Thrust Bearing 19. Stationary Seal 20. Tilting Journal Pad 21. Spring 22. Inner Stationary Seal Bearing 23. Inner Journal Bracket 24. Outer Journal Bracket 25 Secondary Labyrinth

FIG.25 is a view of the configuration of a LABS—Linear Advanced Bearing and Seal System

FIG. 26 is a view of the configuration of a LABS—Linear Advanced Bearing and Seal System

FIG. 27 is a view of journal pads, journal pad surface and pivot placements, thrust bearing example and thrust bearing design example

FIG. 28 is a view of the examples of Multistage CO2/Steam Turbine—Alternate Cooling/Lubrication System Designs with internal cooling channels

FIG. 29 is a view of Multistage CO2/Steam Turbine and example of component placements

FIG. 30 is an example of heat exchanger flow patterns 1600

FIG. 31 is an example of a printed circuit heat exchanger, component build and channels 1602

FIG.32 is a view of heat exchanger comparison, General Shell, Tube and Plate Heat Exchangers 1604 with Typical 80-90% Effectiveness, Printed Circuit Heat Exchangers (PCHE) 1606 Typical 90-97% Effectiveness and DMLS fabricated state of the art and highly optimized Printed Design Heat Exchanger (PDHE) 1608 Optimized for 99% Effectiveness with Highest Efficiency, Highest Surface Area, Least Use of Materials

FIG. 33 is a view of an HDLS fabricated Printed Design Heat Exchanger (PDHE) with example of multiple input 16010a or output capability 1610b, 1610c, 1610d, 1610e

FIG. 34 is a view of an HDLS fabricated Printed Design Heat Exchanger (PDHE) with example usage for molten salt 1612 and CO2 channels 1613

FIG. 35 is a view of an HDLS fabricated Printed Design Heat Exchanger (PDHE) with example usage for CO2 input 1614aand CO2 output channels 1614b

FIG. 36 is the view of typical zigzag channels 1616 showing the sharp connections that create turbulence and pressure drops and HDLS fabricated rounded zigzag channels 1618 promoting smooth flow while demonstrating high surface area

FIG. 37 is a view of examples of HDLS fabricated monolithic PDHE heat exchanger with dual filter ports 1620 and comparison to the many parts and components required for the labor intensive and multi-process construction and fabrication of a PCHE heat exchanger 1622

FIG. 38 is a view of examples of HDLS fabricated monolithic PDHE heat exchanger with single filter port

FIG. 39 is a view of the Modular Solid Oxide Fuel Cell

FIG. 40 is a view of the Modular Solid Oxide Fuel Cell with Flow Supply Duct to Cell from Supply Channel Tunneled Inside the Plate under the Seal for Optimized Channel Sealing Between Plates with male and female connections, compression connections and fuel/oxygen sub-channel examples

FIG. 41 is a view of the Modular Solid Oxide Fuel Cell with channel layout, seals, connections, channels and cell area

FIG. 42 is a view of the Modular Solid. Oxide Fuel Cell with seals, connections, channels and cell area

FIG. 43 is a view of the HDLS fused monolithic component structure dual isolated cooling heat exchanger Advanced Gas Modular Fast Reactor-Generation V—Single Stage utilizing internal and external heat exchanger sleeves from HDLS fused monolithic component builds

FIG. 44 is a view of the HDLS fused monolithic component structure dual isolated cooling heat exchanger Advanced Gas Modular Fast Reactor-Generation V—Dual Stage utilizing internal and external heat exchanger sleeves from HDLS fused monolithic component builds

FIG. 45 is a view of the Toroidal ARBACC

FIG. 46 is a view of the Toroidal ARBACC w/Turbopump and output manifold

FIG. 47 is a view of the HDLS fabricated monolithic Aerospike Engine with attached HDLS fabricated. Thrust Cells, HDLS fabricated monolithic Thrust cell with pintle injector

FIG. 48 is a view of the ARBACC Rocket Engine with Gas Generator Cycle

FIG. 49 is a view of the HDLS fabricated monolithic Rocket Engine with Gas Generator Cycle single and multi-engine configuration examples

FIG. 50 is a view of the space vehicle with Toroidal ARBACC mounted

FIG. 51 is a view of the space vehicle with Toroidal ARBACC mounted

FIG. 52 is a view of the space vehicle with Toroidal ARBACC mounted

FIG. 53 is a view of the space vehicle with Toroidal ARBACC mounted

FIG. 54 is a view of the space vehicle with Toroidal ARBACC mounted

FIG. 55 is a view of the Linear ARBACC configuration

FIG. 56 is a view of the Linear ARBACC w/Turbopump and manifold configuration

FIG. 57 is a view of the space vehicle with Linear ARBACC configuration

FIG. 58 is a view of the space vehicle with Linear and Toroidal ARBACC configuration

FIG. 59 is a view of the space vehicle with Linear ARBACC configuration

FIG. 60 is a view of the space vehicle with Linear ARBACC configuration

It is to be understood that the following disclosure describes several exemplary embodiments for implementing different features, structures, or functions of the invention. Exemplary embodiments of components, arrangements, and configurations are described. below to simplify the present disclosure, however, these exemplary embodiments are provided merely as examples and are not intended to limit the scope of the invention. Additionally, the present disclosure may repeat reference numerals and/or letters in the various exemplary embodiments and across the Figures provided herein. This repetition is for the purpose of simplicity and clarity and does not in itself dictate a relationship between the various exemplary embodiments and/or configurations discussed in the various Figures.

Moreover, the formation of a first feature over or on a second feature in the description that follows may include embodiments in which the first and second features are formed in direct contact, and may also include embodiments in which additional features may be formed interposing the first and second features, such that the first and second features may not be in direct contact. Finally, the exemplary embodiments presented below may be combined in any combination of ways, i.e., any element from one exemplary embodiment may be used in any other exemplary embodiment, without departing from the scope of the disclosure.

Additionally, certain terms are used throughout the following description and claims to refer to particular components. As one skilled in the art will appreciate, various entities may refer to the same component by different names, and as such, the naming convention for the elements described herein is not intended to limit the scope of the invention, unless otherwise specifically defined herein. Further, the naming convention used herein is not intended to distinguish between components that differ in name but not function. Further, in the following discussion and in the claims, the terms “including” and “comprising” are used in an open-ended fashion, and thus should be interpreted to mean “including, but not limited to.” All numerical values in this disclosure may be exact or approximate values unless otherwise specifically stated. Accordingly, various embodiments of the disclosure may deviate from the numbers, values, and ranges disclosed herein without departing from the intended scope.

Additionally, the system includes methods, processes and applications for fabrication of a supercritical, transcritical and subcritical carbon dioxide energy system including its turbine, compressors, heat exchangers, thermal components and pumping systems with methods of fabrication and manufacturing. Various embodiments of the present invention may include carbon dioxide handling equipment, that may include, for example, a carbon dioxide source or carbon dioxide generator, a pressurizing apparatus or compressor, one or more pressure vessels, various interconnecting piping, valves, one or more vent pipes, or some combination of these items. Various embodiments of the present invention also include enclosures or enclosing walls or structure. Another embodiment will allow power, heating and cooling generation.

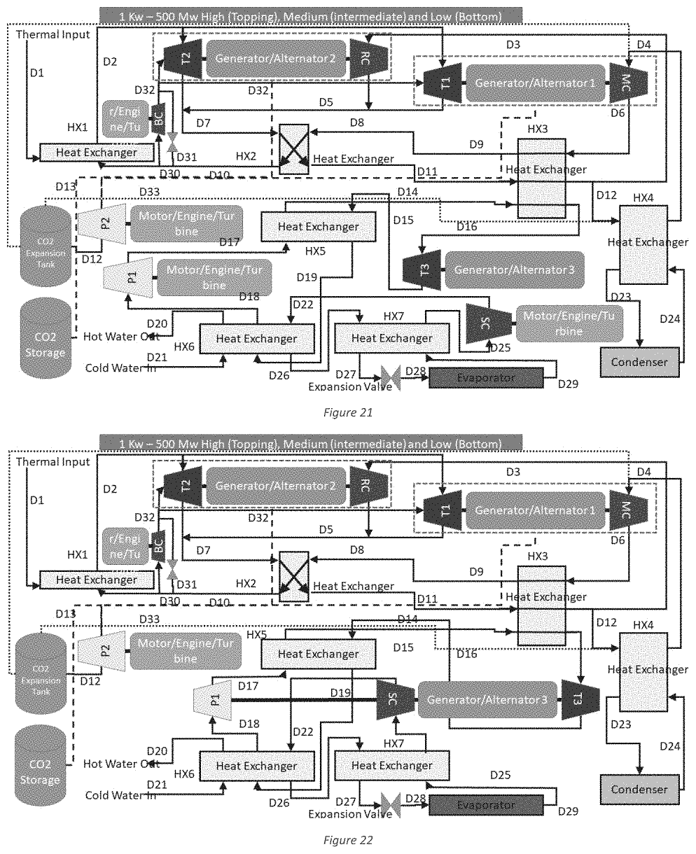

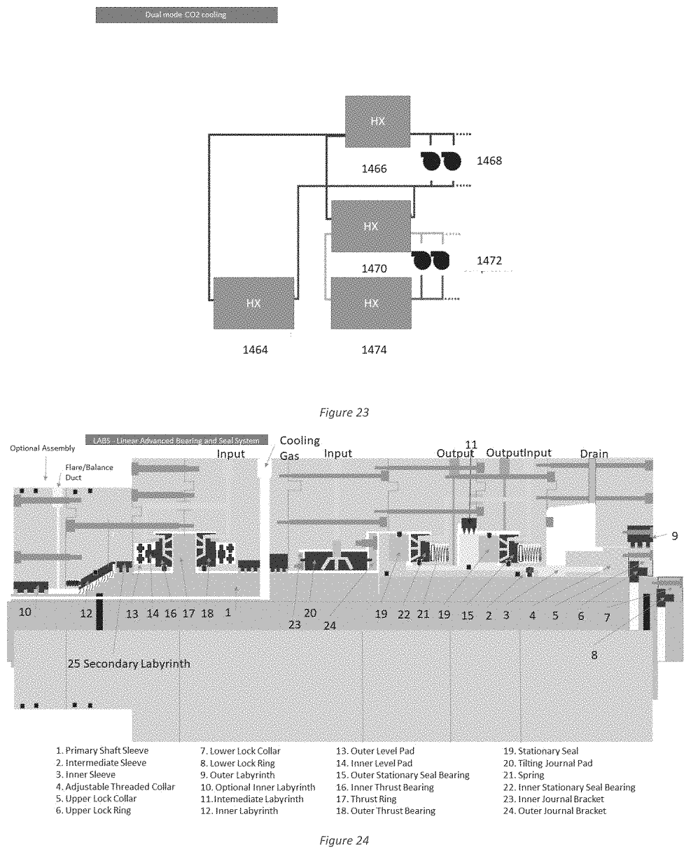

An embodiment presented in FIG. 21 shows a schematic and paths of direction and connection of the present inventions methods and applications of an energy conversion system, which preferably will include renewable energy generated from wind and solar but alternatively can use fossil fuels and nuclear fission or fusion thermal generation for input to the supercritical, transcritical and subcritical carbon dioxide energy conversion system. Thermal storage integration may be used to provide thermal energy to a supercritical, transcritical and subcritical carbon dioxide energy conversion system up to 24 hours a day 7 days a week with energy storage reserves used for peaker power generation.

Integrating renewable energy systems for input in conjunction with a combined cycle supercritical, transcritical and subcritical carbon dioxide energy conversion system allows for efficient use of supercritical, transcritical and subcritical carbon dioxide energy conversion system and increases the electric conversion efficiency of a combined cycle supercritical, transcritical and subcritical carbon dioxide energy conversion system to approximately 63-69% and above 80% when using recycled thermal waste heat for general heating and cooling applications. A supercritical, transcritical and subcritical carbon dioxide energy conversion system can provide power generation, heating and cooling from a single system utilizing complete energy cycles of available energy. This greatly increases the overall efficiency of energy system, thereby reducing plant capital costs, lowers recurring maintenance costs and total costs of electricity production.

A supercritical, transcritical and subcritical carbon dioxide energy conversion system generally includes carbon dioxide storage and pump P2 and motor/engine/turbine powered to introduce carbon dioxide into the system at high pressure to establish and maintain adequate carbon dioxide charge and by replacement of carbon dioxide lost to leakage. High pressure piping via Ducts D1-D32, valves and other type of connectors connect the system components to circulate the gas and liquids amongst the various components and loops of the system. The turbine, generator/alternator and compressor is shown inside the dashed area can be interchanged with the various configurations shown for scaling the system up or down.

A primary heat exchanger HX1 is used for transfer of external generated thermal energy input to inject thermal energy into the carbon dioxide top cycle for input to the primary turbine T1 and generator/alternator 1 and main compressor MC, secondary turbine T2 and generator/alternator 2 and recompressor RC, gas film compressor BC (turbine bearings) and motor/engine/turbine, high temperature recuperator/heat exchanger HX2, low temperature recuperator/heat exchanger HX3, gas precooler/heat exchanger HX4, condenser, transcritical turbine 3 and generator/alternator 3, pump P1 and motor/engine/turbine, secondary compressor SC and motor/engine/turbine, heat exchanger HX5, heat exchanger HX6. Heat exchanger HX7, expansion valve and evaporator.

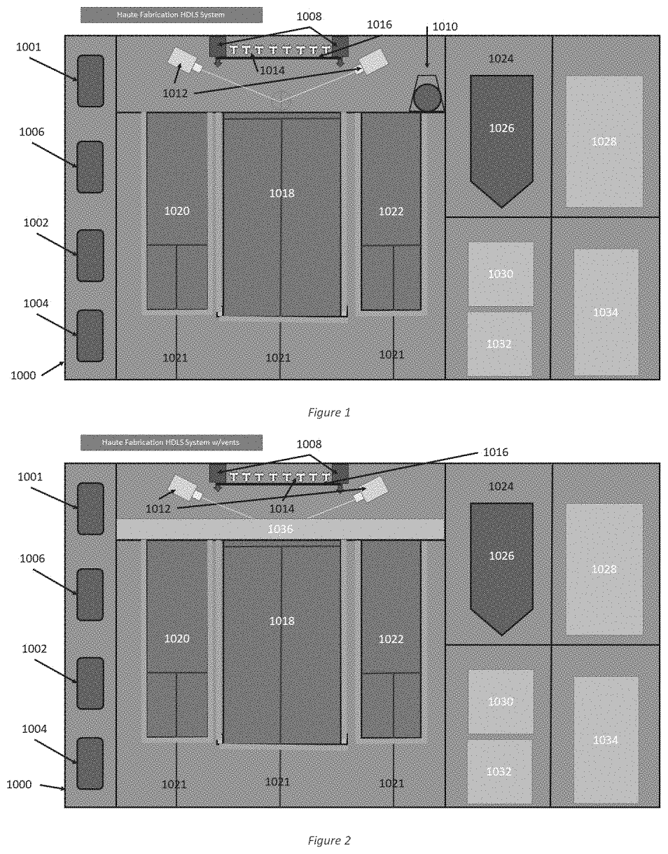

An embodiment presented in FIG. 2 shows a schematic of energy conversion system that with conversion of the secondary system using turbine T3 shaft as the input source for the transcritical and subcritical compressor SC and pump P1. This allows the middle and bottom cooling cycle to greatly improve system efficiency by optimizing utilization from a greater percentage of the thermal energy input.

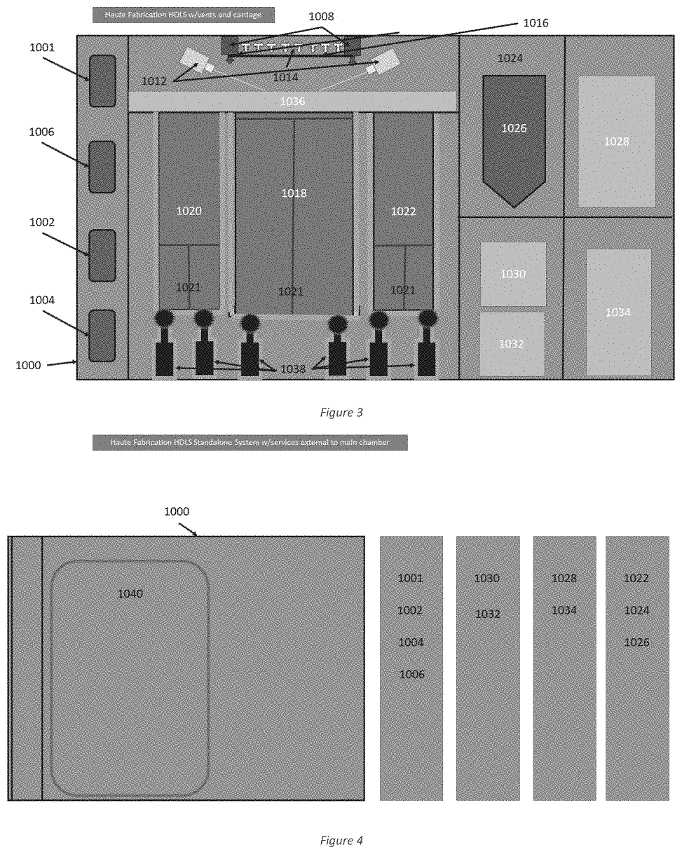

An embodiment presented in FIG. 3 shows a diagram of a multistage bearing and seal array but is only a reference as other bearing, lubrication and sealing methods that may be used.

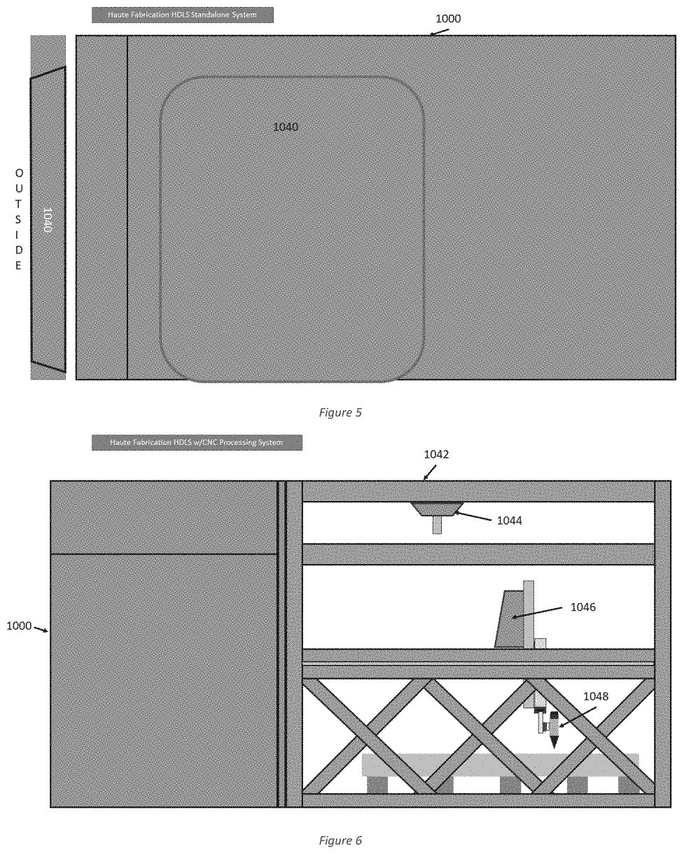

An embodiment presented in FIG. 4 shows a diagram of a multistage bearing and seal array but is only a reference as other bearing, lubrication and sealing methods that may be used.

An embodiment presented in FIG. 5 shows a diagram of a multistage bearing and seal array but is only a reference as other bearing, lubrication and sealing methods that may be used.

An embodiment presented in FIG. 6 shows a diagram of a multistage bearing and seal array but is only a reference as other bearing, lubrication and sealing methods that may be used.

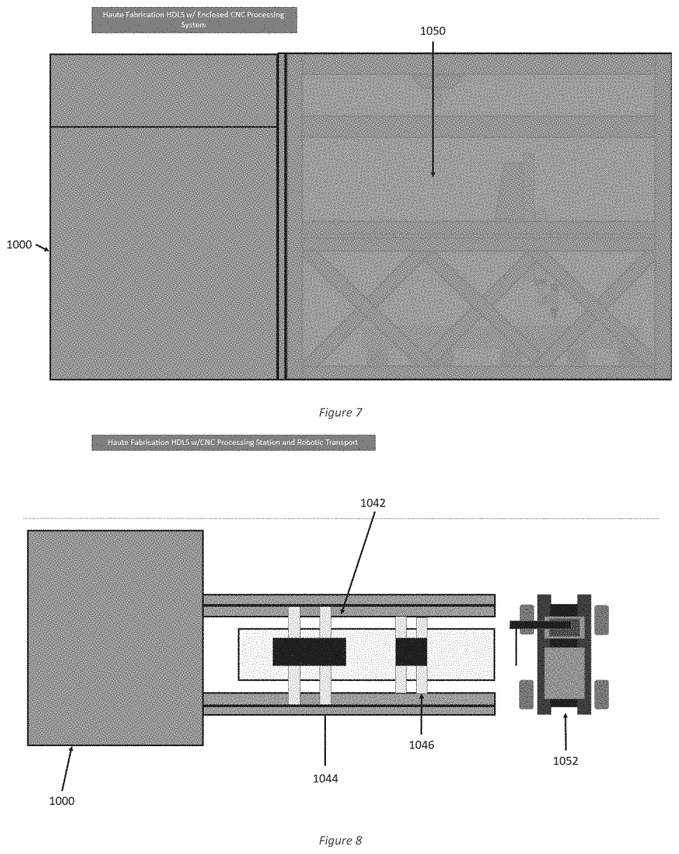

An embodiment presented in FIG. 7 shows a diagram of a gas film titling pad bearing and a gas film thrust bearing but is only a reference of a method that may be used.

An embodiment presented in FIG. 8 shows a diagram of a single or multistage cooling channel and duct system and components as a reference to the communication of cooling gas between components and the rotor and blade or impeller cooling methods that may be used.

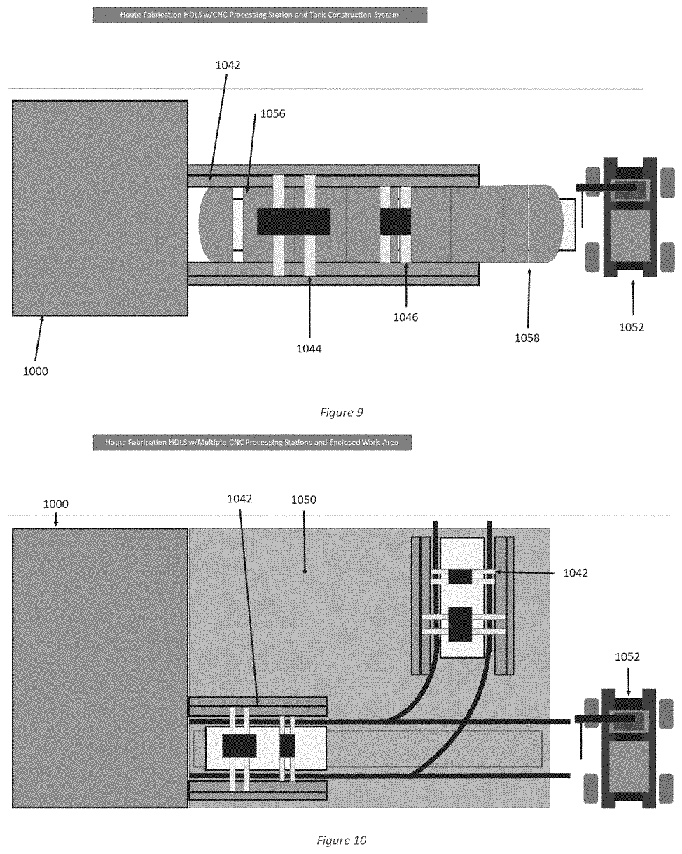

An embodiment presented in FIG. 9 shows a diagram example for a single or multistage turbine and compressor with bearing and seal array arrangements but is only a reference as other rotor and blade or impeller, bearing, lubrication and sealing methods that may be used.

An embodiment presented in FIG. 10 shows a diagram of a prior art and the present inventions improvements with massive surface area ratio enhancement.

An embodiment presented in FIG. 11 shows a diagram of a heat exchanger using a singular input and multiple thermal transfer loops utilizing an optimized surface area ratio.

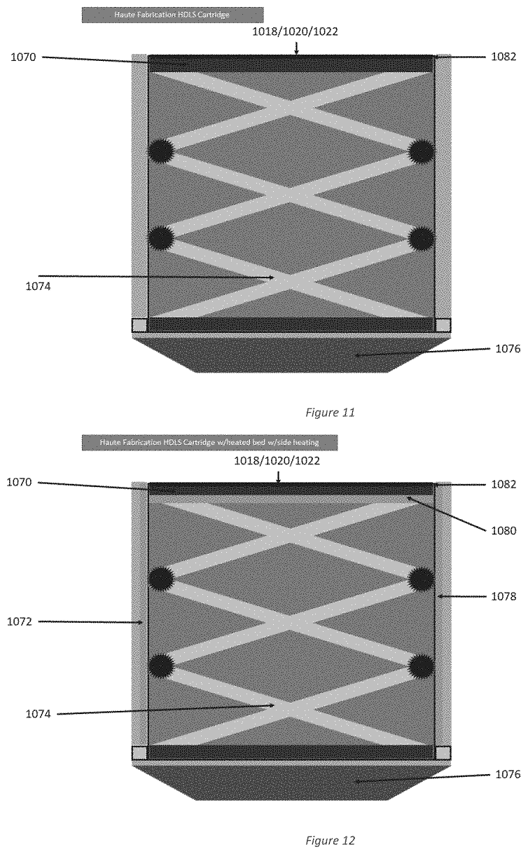

An embodiment presented in FIG. 12 shows a diagram of a heat exchanger using a molten salt input design and a steam or CO2 transfer loop utilizing an optimized surface area ratio.

An embodiment presented in FIG. 13 shows a diagram of a heat exchanger using a steam or CO2 input design and a steam or CO2 transfer loop utilizing an optimized surface area ratio.

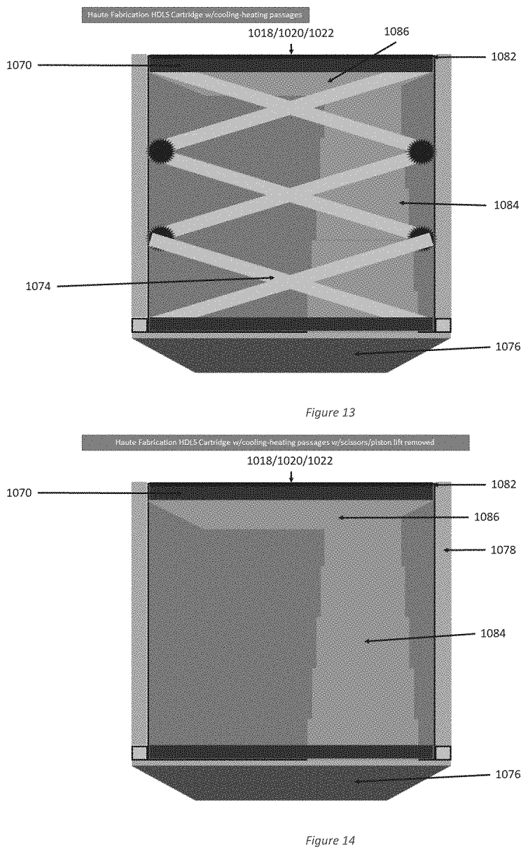

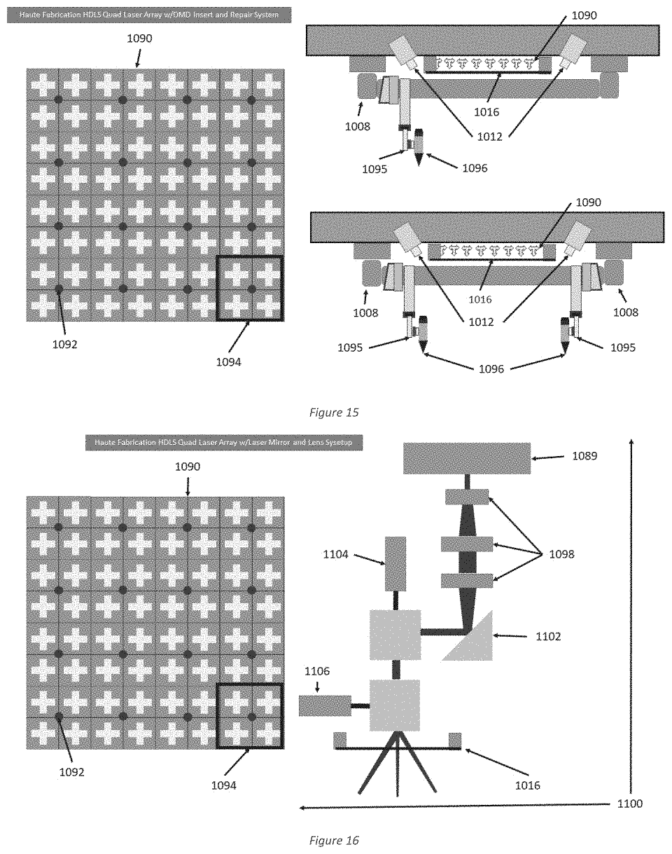

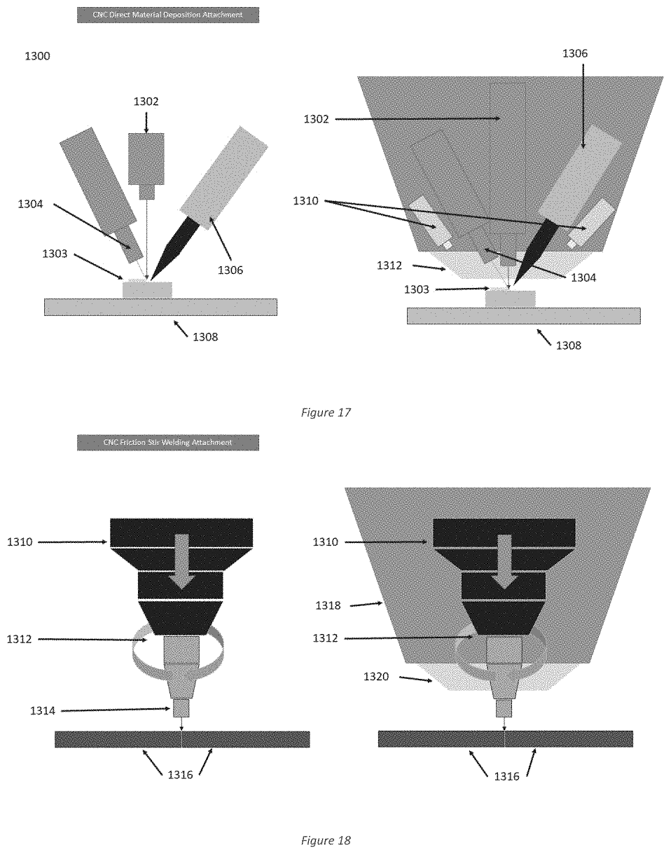

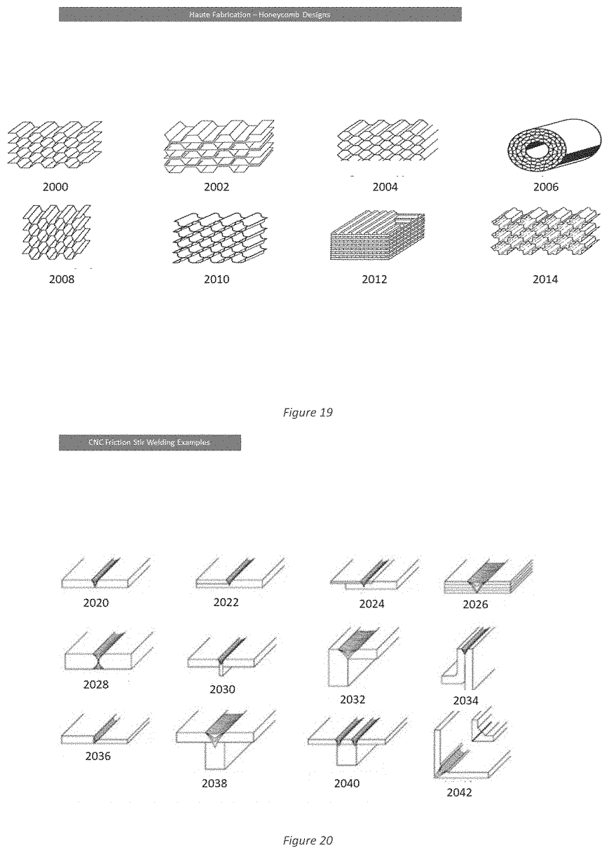

An embodiment presented in FIG. 14 shows a diagram of an electronic arc furnace for melting materials to allow normal or special alloy matrixes.

An embodiment presented in FIG. 15 shows a diagram of a water based atomization process to process materials melted in the electronic arc furnace for atomized materials for use in the quadratic or squared high density laser sintering (HDLS) process as input materials to allow normal or special alloy matrixes usage.

The present invention allows single component fabrication of impellers and rotors with blades without using joints, welds and other types of connections. This will allow high pressure gases and/or supercritical fluids and fluids to be used as lubrication within the component build while reducing the number of seals or the size of the seals while still allowing seals to substantially limit leaks. The present invention provides for channels both conformed and nonconformed for the purpose of mixing which may include mixing systems such as vortex generators to create turbulence within the cooling channels, this may be established within the fabrication of the blades, vanes and injectors of both radial and axial turbine components to assist in cooling effectiveness not achievable from prior art. The present invention provides the ability for complex geometries within channels and ducts of the component build that along with scalable methods for fabrication enable previous inaccessible and unavailable complex scalable designs to create optimal design specifications monetizing previous prior art advances into a single fabricated component.

The present invention with its ability to scale the component builds provides for cooling and lubrication channels and systems design build within a single component build that has no joints, welds or connections thereby offering the highest performance and efficient possible. The present invention will provide for higher turbine temperatures allow for higher turbine efficiencies. The present invention will provide for higher thermal cooling efficiency while reducing thermal stresses to the components to a minimum. The present invention provides turbine manufacturing with greater efficiency and greater power potential through scaling.

The present invention provides for heat exchangers to fabricated to higher levels of pressure capability while greatly surpassing prior art. For example, prior art typical heat exchanger design provided for 80-90% effectiveness, the newest technique referred to as Printed Circuit Heat Exchangers (PCHE) typically provide 90-96% effectiveness whereas the present invention is capable of fabricating a Printed Design Heat Exchanger (PDHE) with effectiveness as high as 99% without prior art deficiencies that had joints, welds, fusions, material usage limitations due to manufacturing issues and sizing constraints.

The present invention provides for optimizing the component design for optimal contact surface area for maximizing thermal energy transfer, reduction of parasitic losses and reducing material requirements thereby also reducing the weight and space requirements while maintaining the optimal material characteristics from the chosen material used for the fabricated component.

The present invention provides for the targeted component to be easily designed and then fabricated with a number of materials for a customized solution for gases and/or supercritical fluids or liquids, clean or fouling and even corrosive on a beneficial and cost effective basis advantage of prior art.

The present invention provides for fabrication with capabilities of the highest thermal effectiveness, highest temperatures, highest pressures, lowest pressure drops, highest compactness, highest erosion resistance, highest corrosion resistance and longest life advantages over any prior art and is only limited by the material characteristics chosen for fabrication.

The present invention provides for predetermined estimates for component replacement and repair by selective material choice and material thickness prior to fabrication. The present invention requires no special orders of materials as such provides for lower material costs, short lead times greatly reducing downtime and project delays hence greater cost reductions and lower cost of energy and cost of ownership.

The present invention provides for inclusion of an electric arc furnace integration into the system processes to provide the ability to create special alloy metallurgy that matches exactly the specific design needs for strength, corrosion resistance, psi tensile strength and temperature requirements within the upper safe limits of special alloy materials for the purpose usage in component builds.

The present invention provides for a novel advantage especially concerning aerospace, heavy equipment and mining equipment and other mobile based industries with weight to energy issues, weight is an ability the present invention largest advantage in the mobile sector that the prior art isn't and/or can't change in designs for weight saving concerns using honeycomb and other supported void types of volume yet light weight designs that that the present invention can incorporate and fabricate. This allows the present invention to use fabrications with the least amount of weight like a honeycomb void design would allow while retaining very high tensile strength.

Referring now to the drawings in detail, wherein like numbers are used to indicate like elements throughout, there is illustrated in FIG. 1 is a supercritical, transcritical, subcritical CO2 combined cycle energy system and with supporting hardware. This arrangement allows use of the topping cycle for high temperature thermal energy use for power generation, reuse of the reduced temperature thermal energy for a middle cycle for power generation and a bottom cycle using low temperature thermal energy for cooling generation and processing the recycled thermal energy for water heating thereby utilizing energy to upwards of 90%+ efficiency.

The Linear Advanced Bearing and Seal (LABS) array system forms a replaceable cartridge for easy maintenance in the field. After removal the cartridge with its tight tolerances can be sent in for repair for inspection to determine failure and provide data for product enhancements. This process will also allow proper servicing in a sealed environment to prevent contamination and further damage.

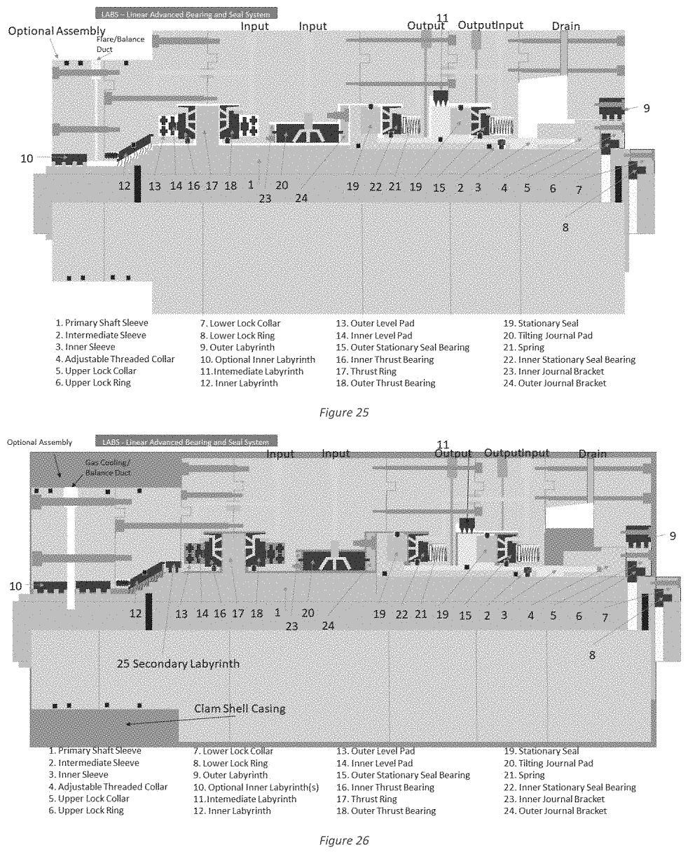

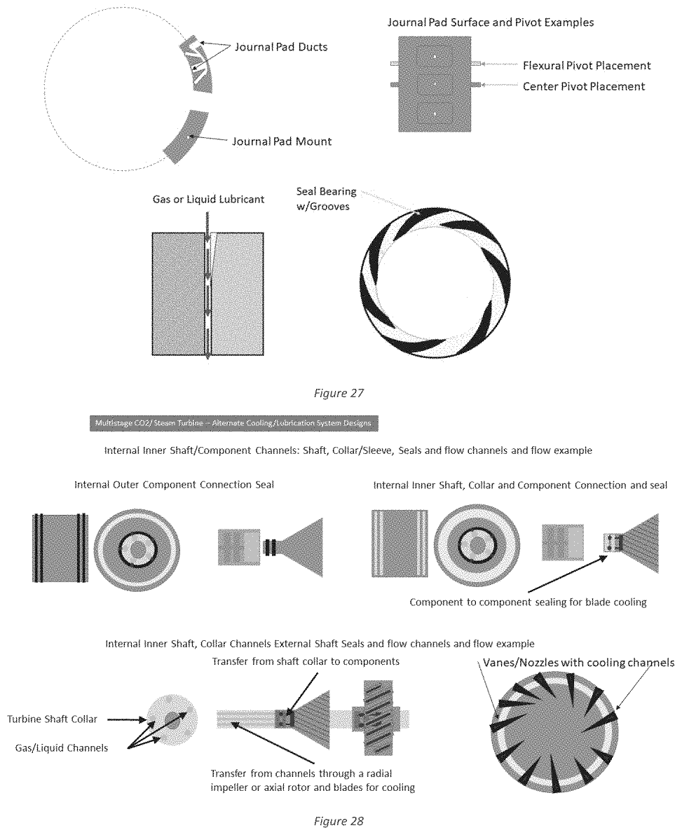

The Linear Advanced Bearing and Seal (LABS) array assembly provides a cartridge based system as illustrated in FIG. 24-FIG. 26 that quantifies the quintessential nature of the bearing and seal assembly. This assembly also includes the integration of the cooling gas input channel within the assembly to further reduce sealing requirements simply due to its integration within LABS assembly.

The Linear Advanced Bearing and Seal (LABS) array assembly of the present invention as illustrated in FIG. 26 demonstrates the assembly can be contained in a clam shell enclosure for added sealing capabilities and higher pressures with additional protection provided for the assembly. As illustrated in FIG. 24-FIG. 26 bearing and seal assembly according to one of more aspects of the present invention through this disclosure is only an example and different configuration and placement of the bearings and seals is possible.

As illustrated in FIG. 24-FIG. 26 bearing and seal assemblies according to one or more aspects of the present disclosure may be used in conjunction with a turbomachinery with the assembly enclosed and/or connected to a casing and having a balance pressure side, low-pressure gas side a high-pressure gas side. In an exemplary embodiment, the turbomachinery may consist of a high-pressure turbo-compressor. The turbomachinery may also include a rotor shaft configured to extend through the turbomachinery and exit one or both sides of the casing into a housing that may consist of a single or multiple rotor and blades and/or impeller(s). The rotor shaft may use a be journal bearing at each end by employing suitable bearings. In alternative embodiments, the casing and the housing may include the same overall structure, or otherwise the casing and housing may each be enclosed by a separate overall casing structure.

As illustrated in FIG. 24-FIG. 26, one embodiment a LABS assembly as discussed herein may be utilized effectively on a single sided turbo machine (e.g., machines of the overhang type).

Relative to the housing, the rotor shaft may be supported via bearings to provide the shaft free rotation and sealed via a series of seals to reduce process gas leakage from the inner area of the turbo machine. In particular, the turbomachinery requires a LABS assembly configured to supported the rotor shaft via bearings to provide the shaft free rotation while reducing unwanted movement and to prevent process gas or liquids from escaping from the turbomachinery inner or outer casing and system housing, thereby entering the atmosphere.

In an exemplary embodiment, the LABS assembly on the gas exit side may include a high-pressure seal, a high-pressure labyrinth seal, a single seal, a labyrinth seal, a tandem seal including an intermediate labyrinth seal, and a separation labyrinth seal. Each bearing and seal may extend circumferentially around the rotating shaft and be sequentially mounted longitudinally outward relative to the housing. The bearing and seal assembly may be similar to the bearing and seal assembly on the opposite side of the turbomachinery.

Referring to FIG. 24-FIG. 26, illustrated is an exemplary embodiments of the bearing and sealing assembly. As illustrated, the high-pressure seal may be situated on the high-pressure process gas or liquids of the turbo machine, and radially coupled to an outer edge of the interior of the turbo machine casing. The high-pressure seal typically is utilized reduce the pressure of any process gas or liquids escaping the turbomachinery casing to a lower inner-stage pressure. This may be done to create a delta pressure that serves to balance axial theist forces generated inside the turbo machine. In one embodiment, a portion of this reduced-pressure process gas may be collected via a duct and re-injected at process gas or liquid side to be re-pressurized by the turbomachinery or external input. The high-pressure labyrinth seal, located coaxially adjacent to the high-pressure seal, may be configured to separate any escaping process gas from the high-pressure seal.

Traditionally, a labyrinth-type seal has been employed coaxially adjacent the high-pressure labyrinth seal and the potential for a secondary labyrinth seal array can be configured to further reduce pressure of any process gas escaping the high-pressure labyrinth seal to a level that a tandem seal can physically accept. However, in high-pressure, low-flow applications, using the traditional labyrinth-type blow-down seal may cause up to 10-15% efficiency losses in power and total process flow of the turbomachinery. According to the present disclosure, to decrease these efficiency losses, the pressure reduction process may instead be handled by a single pressure reduction seal. It has been shown that using a single pressure reduction seal may reduce total efficiency loss from 10-15% to about 2-5%, and even less than about 1% in some applications.

Therefore, an exemplary embodiment of the present disclosure may include the combination of a single pressure reduction seal and a tandem seal; thus taking advantage of the current tandem experience while benefiting from the bearing pressurizations yet still efficiently reducing pressure efficiency losses. This combination is not necessarily configured but can be seen as a triple or quadruple seal system.

During typical operation of a dry gas face seal, a portion of the high-pressure process gas is cleaned and introduced to the gas seal to help maintain a high-pressure sealing effect, and also to prevent potential contamination of the seals. Prior to cleaning, this process gas may contain foreign matter such as dirt, iron filings, and other solid particles which can contaminate the seals. Therefore, cleaned seal gas, including filtered process gas or an inert gas from an external source, may be injected at each gas seal at a predetermined pressure higher than the pressures in the preceding inner-areas of the housing in order to block process gas leakage. In operation, the cleaned gas may be pressurized by a small reciprocating compressor, or may utilize pressurized gas from an alternative turbo machine application.

Likewise, externally pressured gas may be injected at the tandem in a similar fashion. In particular, cleaned seal gas may be injected via a duct between the labyrinth seal and the primary gas seal at a pressure in excess of the pressure incident in reduced pressure at the primary vent duct. In an exemplary embodiment, the majority of the seal gas injected via a duct may flow across the labyrinth seal and into a seal duct via reduced pressure at the primary vent duct. However, a small portion of the seal gas may flow across the primary seal as leakage loss, which may either be collected or discharged to flare via the tandem primary vent duct.

The foregoing has outlined features of several embodiments so that those skilled in the art may better understand the detailed description that follows. Those skilled in the art should appreciate that they may readily use the present disclosure as a basis for designing or modifying other processes and structures for carrying out the same purposes and/or achieving the same advantages of the embodiments introduced herein. Those skilled in the art should also realize that such equivalent constructions do not depart from the spirit and scope of the present disclosure, and that they may make various changes, substitutions and alterations herein without departing from the spirit and scope of the present disclosure.

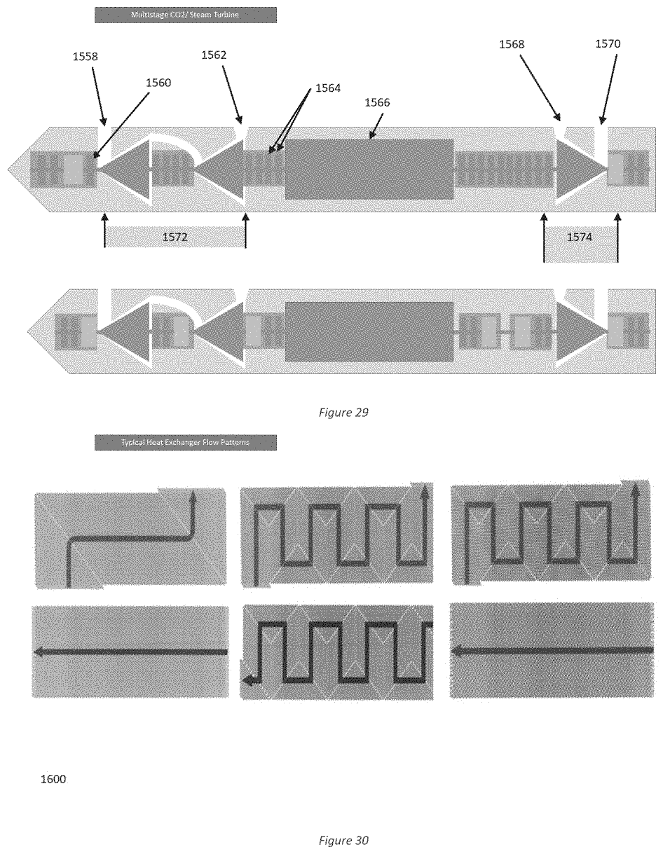

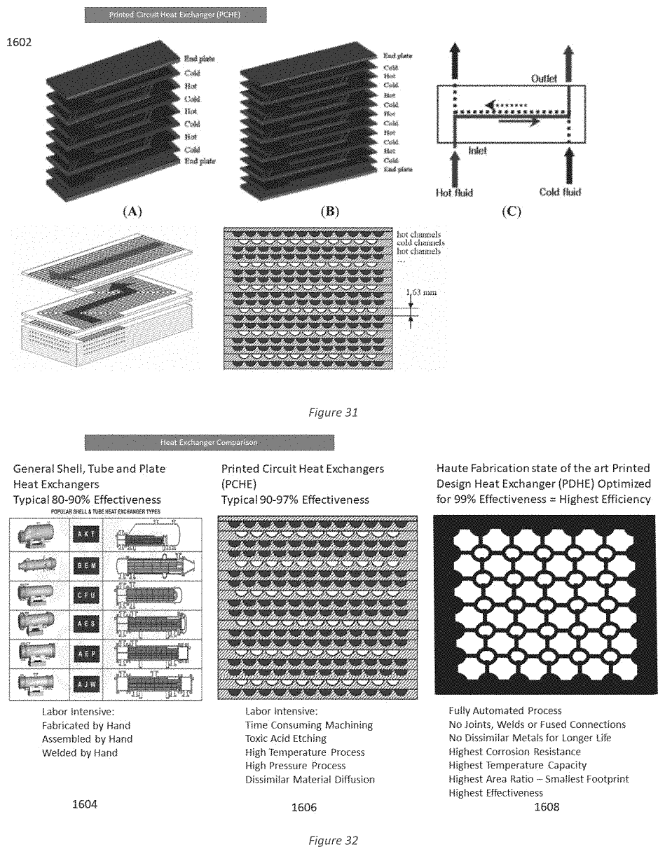

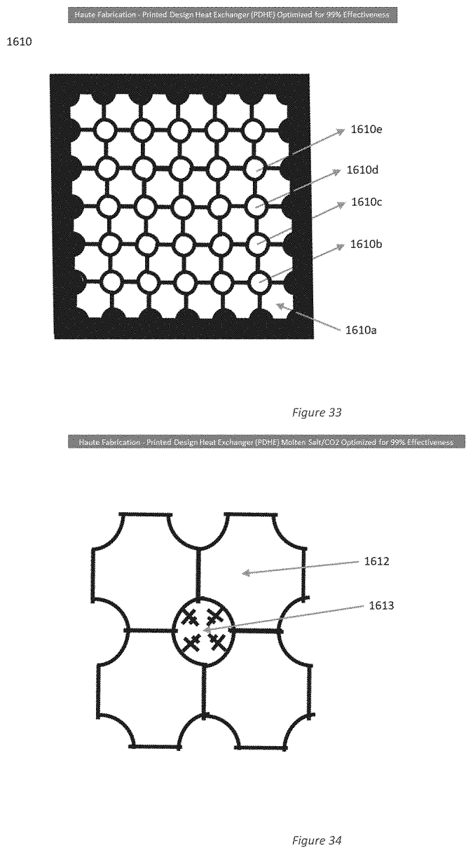

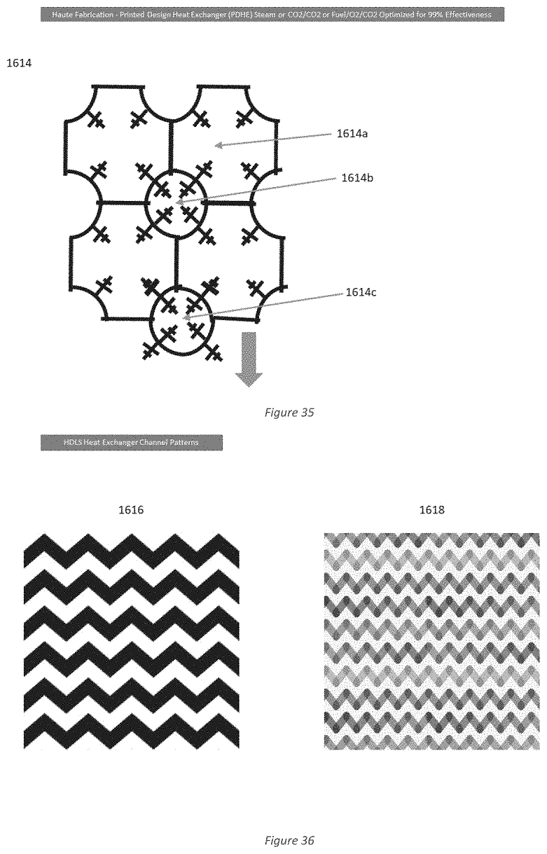

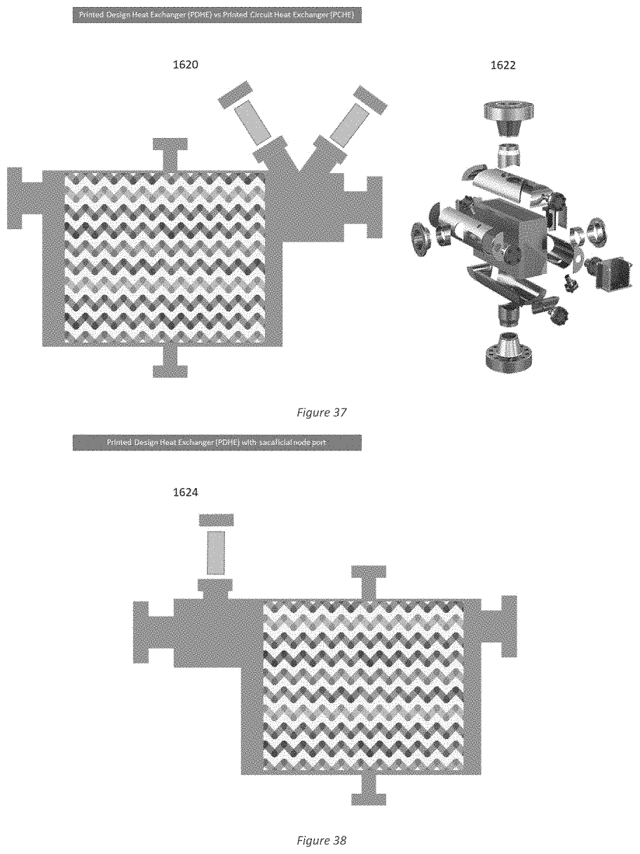

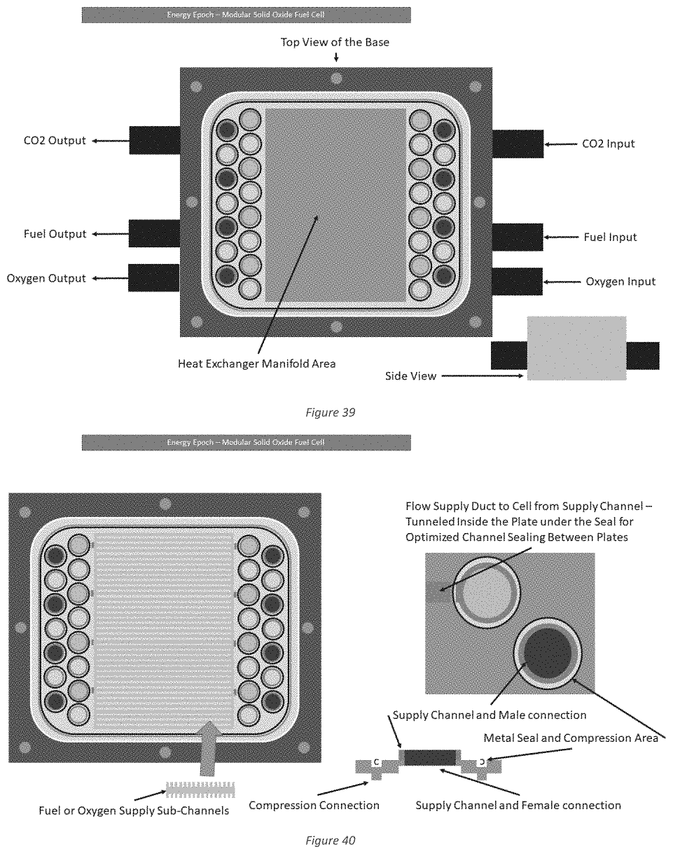

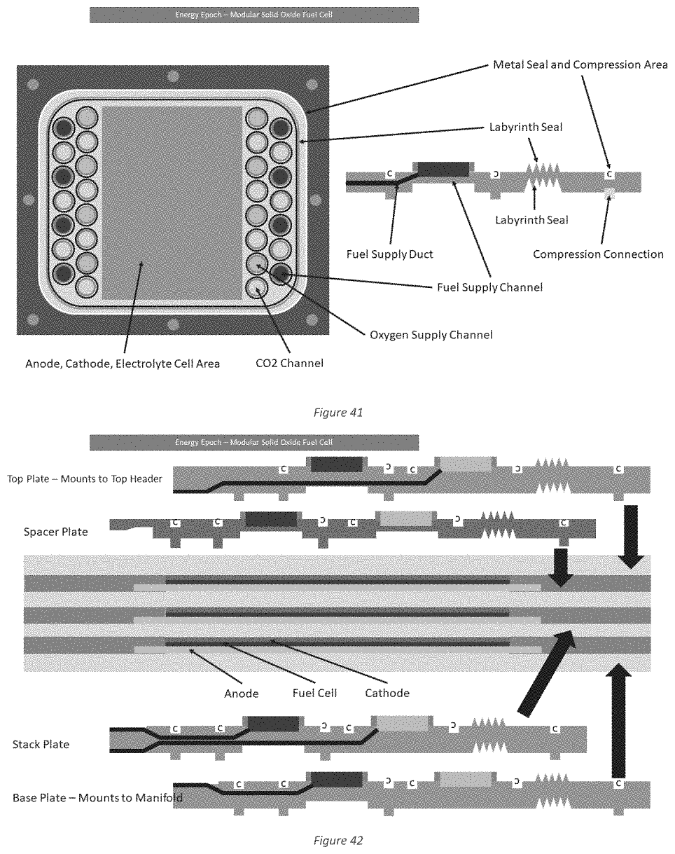

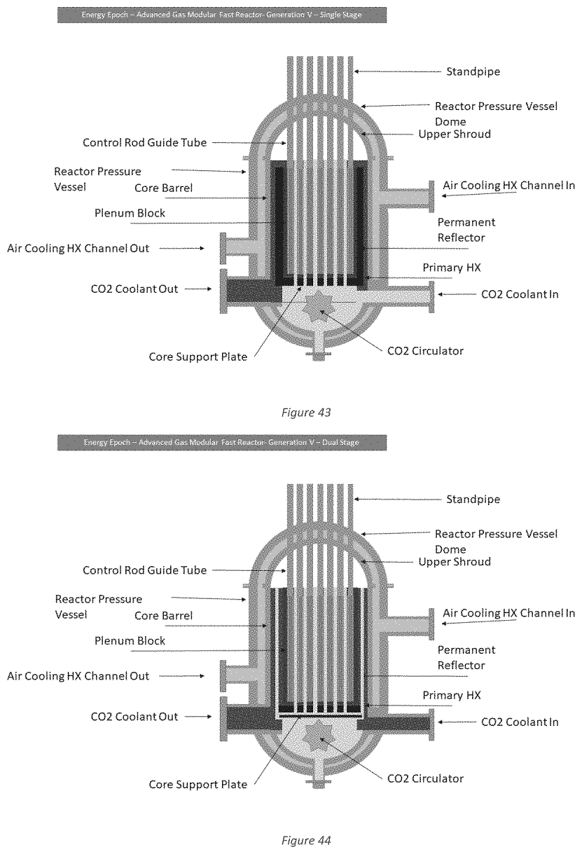

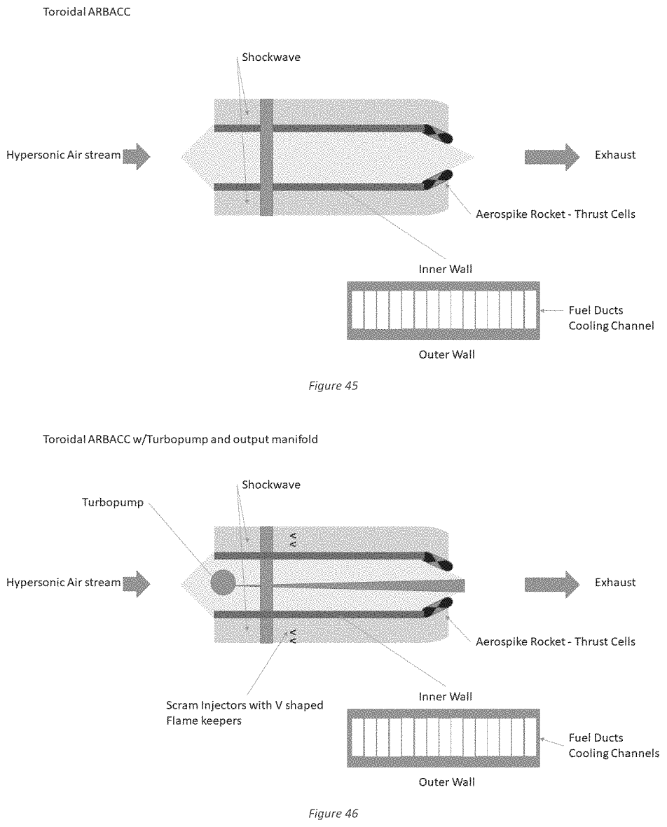

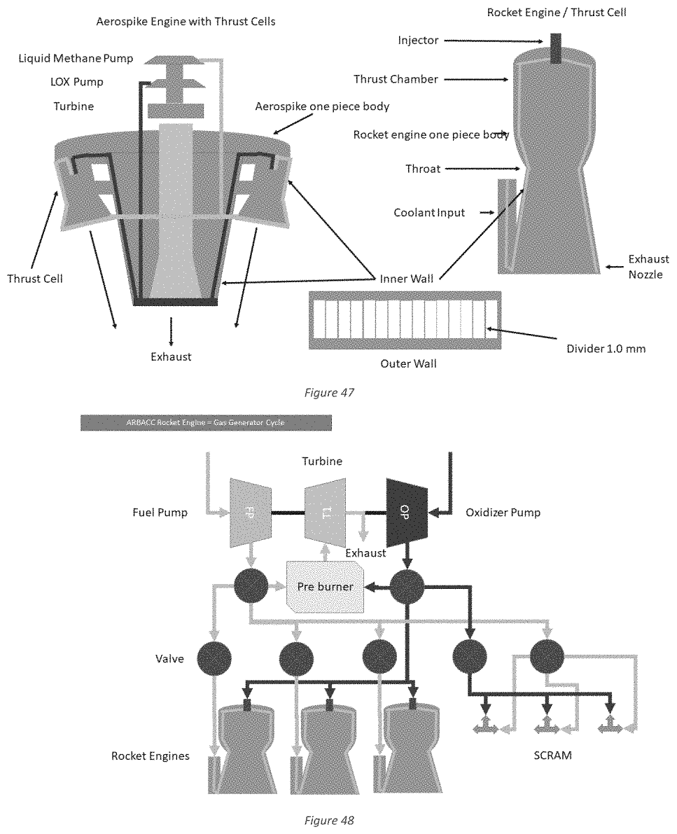

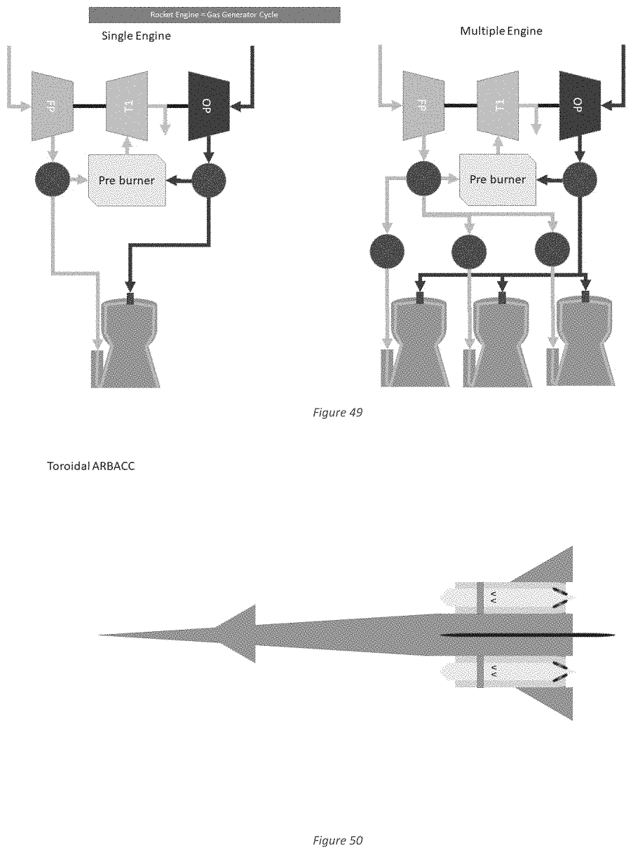

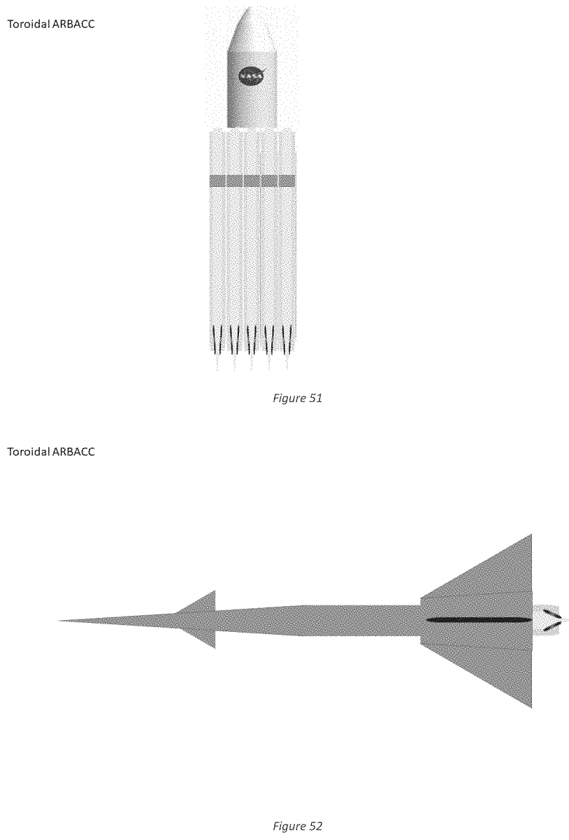

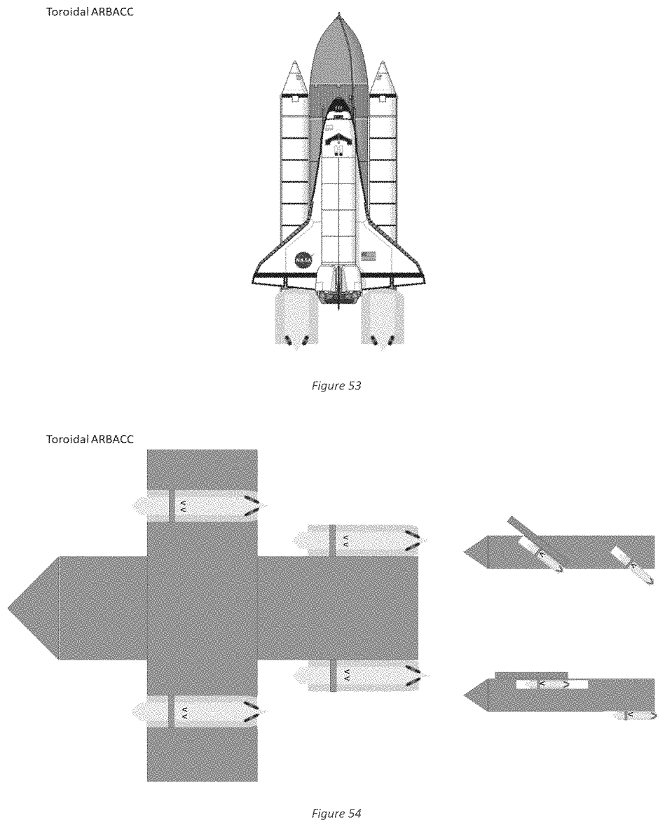

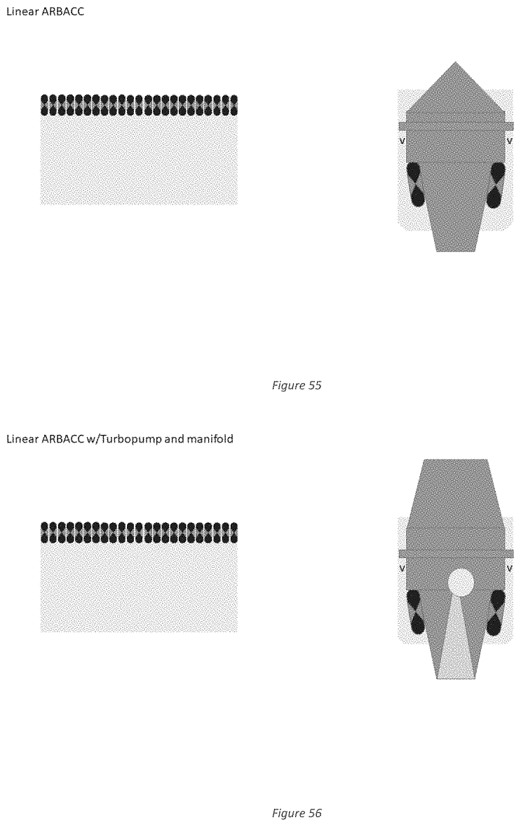

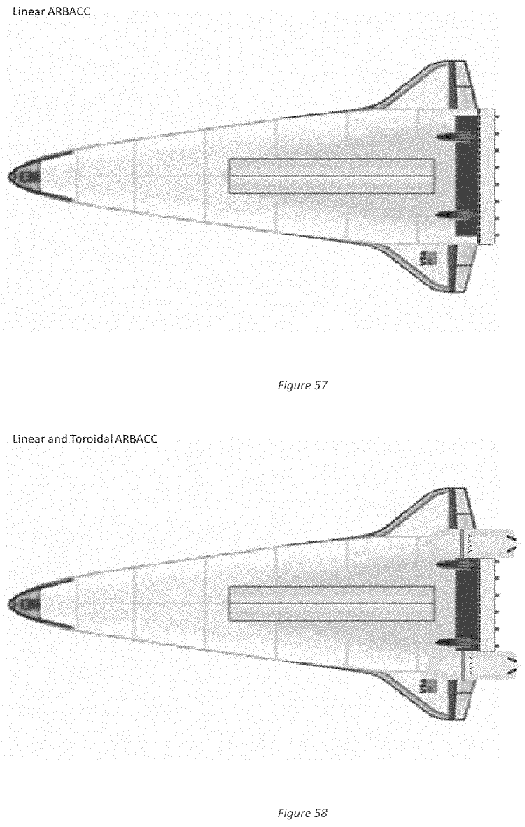

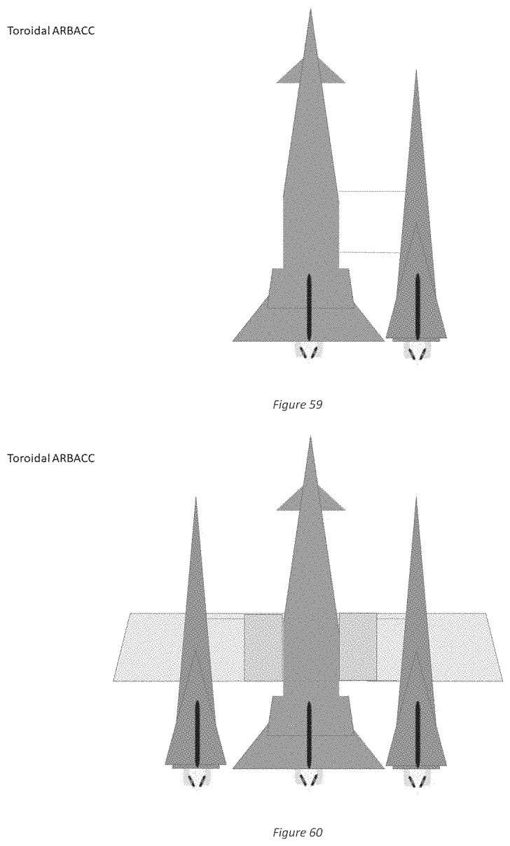

The Linear Advanced Bearing and Seal (LABS) array assembly of the present invention through utilization of the cooling gas channel input. FIG. 29 illustrates an axial half cross-section example through the relevant components of “prior art” conventional turbomachinery. A separate flow metering aperture with an accurately sized opening can be used to control the flow and pressure that are delivered to the lubricating gas and cooling gas plenum, as desired given the necessary design parameters.

The inner chambers of the bearing and seal gallery is supplied with lubricating gas and/or fluids via supply ducts and gas and/or liquids are removed via a drain scavenge duct. An outer most chamber of the gallery is ventilated with low pressure compressed cooling gas and sealed with seals. Compressed cooling gas is delivered to the outer chamber of the bearing and seal gallery is provided through a low pressure gas supply duct (not shown) communicating between the low pressure stage compressor and/or regulator (not shown) and the bearing and seal gallery chamber.

Referring to FIG. 29, a plurality of turbine blades is mounted to a rotor or an impeller in single stage high work high pressure turbine of the turbomachinery. The gas or liquid has a pressure (typically seen during operation of the engine) downstream of the turbine which is lower in conventional turbomachinery because of the effect of the high work high pressure turbine on the gas or liquid there through the turbomachinery.

Referring to FIG. 29, a plurality of turbine blades is mounted to a multiple of rotors or impellers in multistage stage high work high pressure turbine of the turbomachinery. The gas or liquid has a pressure (typically seen during operation of the engine) downstream of the turbine which is lower in conventional turbomachinery because of the effect of the high work high pressure turbine on the gas or liquid there through the turbomachinery.

Referring to FIG. 29, alternatively in a turbomachinery compressor a plurality of turbine blades is mounted to a rotor or an impeller in single stage high work high pressure compressor of the turbomachinery. The gas or liquid has a pressure (typically seen during operation of the engine) downstream of the compressor which is higher in conventional turbomachinery because of the effect of the high work high pressure turbine on the gas or liquid there through the turbomachinery.

Referring to FIG. 29, alternatively in a turbomachinery compressor a plurality of turbine blades is mounted to a multiple of rotors or impellers in a multiple single stage high work high pressure compressor of the turbomachinery. The gas or liquid has a pressure (typically seen during operation of the turbomachinery) downstream of the compressor which is higher in conventional turbomachinery because of the effect of the high work high pressure turbine on the gas or liquid there through the turbomachinery.

The turbine has a rotation about the turbomachinery axis is shown in FIG. 28 in a circular motion about the periphery of a blade. Each component including the rotor of impeller has its blades quadratic or squared HDLS printed with the chosen material as a single component free of welds, fusions or mechanical connections. The blade or air foil whether axial turbine with a rotor and blades or radial with an impeller communicates cooling gas flow through its ducts that each blade or airfoil include a cooling duct communicating at one end with the cooling duct transfer channels cooling plenum within connecting components that also connect to the shaft for rotation and at another end with the blade interior, as described below. Relatively cool gas is provided via the compressor and supplied to cooling gas plenum through conventional duct means. Compressed cooling gas may also be delivered to the gas cooling chambers of the bearing and seal gallery through a pressure gas supply duct from the LABS bearing and gear assembly which also provides lubrication to the bearings and cooling to the gallery, as described in more detail below.

The rotor or impeller that includes blade air foils that extend radially from the root which connects to the shaft and include cooling gas channels communicating between the cooling gas inlet duct and the cooling gas channel of the turbomachinery engine as shown in FIG. 8 and exiting through intermediate (lower radius) ducts of the components along the shaft. Each cooling gas duct through the rotor and impeller extending into the airfoil and includes connection to the gas cooling ducts between components having cooling gas communicated from the gas cooling duct input.

A high work single or multiple stage turbomachinery experiences a relatively large pressure drop across the turbine because of the amount of work extracted from the flow. The resulting pressure of the gas path downstream of the turbine is therefore markedly reduced compared to the turbomachinery input pressure. Due to the implied high pressure characteristic of a high work single or multiple stage high pressure turbomachinery creates a pressure drop on the output of duct of the turbomachinery. This allows the cooling gas plenum, channels and ducts to provide sufficient intake flow of cooling gas flow to cool the turbine blades or airfoils and vanes or nozzles without requiring the mechanical complexity of the prior art.

As shown in FIG. 26, cooling gas enters through a duct in the LABS bearing and seals gallery is then exhausted into the cooling gas plenum, channels and ducts through components in FIG. 28. A separate flow metering aperture and/or temperature sensor with an accurately sized opening can be used to control the flow, pressure and temperature that are delivered to and through the cooling gas plenum, as desired given the necessary design parameters. Optimization of the ducting shape, aperture size, vortex generators and orientation depends on the turbine radius, speed of rotation and the parameters of the cooling gas plenum, as well will be apparent by one skilled in the art in regards of disclosure for the present invention.

With regards to past prior art, many attempts have been employed to enhance rocket engines, mostly this was through the delivery of energy and choice of energy for rocket engines. The energy potential of the propellant and oxidizers have been gradually increased to reduce their weight and the operating pressures have been increased to enhance total thrust.

A liquid fuel rocket engine construction includes the usual main combustion chamber having a nozzle discharge. One or more gas generator is used to generate shaft energy input to the turbine section of the turbopump and to discharge exhausted combustion gases and/or supercritical fluids external to primary turbopump exhaust. The primary turbopump typically drives at least one separate fuel component pumps and one separate oxidizer component pumps.

A liquid fuel rocket engine construction includes a typical main combustion chamber having a nozzle discharge.

The preferred method of the present invention provides for a fabrication and construction method and application of rocket engines and, in particular, to new and useful liquid fuel rocket engines having at least one first stage and provides the ability for additional stages of a space launch system.

The preferred method of the present invention provides for injection of the regenerative cooling agent consisting of fuel or oxidizer according to the invention which provides for the highest ratio of surface area to flow volume of the injection cooling agent in addition to the highest ratio of contact area for optimization of regenerative cooling efficiency. Due to the uniform distribution of the regenerative cooling agent, a rapid and thus advantageous cooling and combustion thereby thrust is achieved. Thus, it is then possible to obtain either a reduction of the length or weight or the potential of both for the combustion chamber weight and cooling and better combustion with extended burn time capabilities and engine reusability.

The preferred method of the present invention using quadratic or squared fabrication system provides for optimized regenerative cooling within in the context of rocket engine design. The preferred method provides for a method and process of fabrication to allow maximum performance, maximum chamber pressure and optimal cooling.

The preferred method of the present invention provides for optimization through which the regenerative cooling agent is communicated through channels which are formed via the inner and outer jacket or skins of the engine.

The preferred method of the present invention utilizes the quadratic or squared fabrication system through with the inner jacket having optimal thickness for thermal energy transfer via conduction and the thickness for sides of each duct optimally built for the required strength and tensile strength and an outer jacket all optimized with a safety margin for minimal pressure drop, maximized pressure and temperature and optimized weight reduction. An example of the duct and channels within a wall section is shown.

The preferred method of the present invention fabrication of the complete rocket engine and pintle injector component along with the combustion chamber, exhaust nozzle bell and regenerative cooling channels within a single component build with no seams, joints or connections while able to scale to hundreds of thousands foot pounds of thrust compared to the limited build, non-optimal chamber pressure, thrust limitation due to cooling constraints imposed by prior art fabrication methods.

The preferred method of the present invention greatly exceeds the ability of prior art methods and beyond the capabilities and potential of prior art fabrication thereof by enabling the present invention novel fabrication methods for novel applications with higher pressure, temperature, cooling capacity and scaling than was previously available from prior art.

The preferred method of the present invention provides for some or all the fuel and/or oxidizer is communicated through ducts, channels, or in a jacket around the combustion chamber and/or exhaust nozzle to cool the engine. This is effective because the fuel and/or oxidizer are effective coolants. The heated fuel and/or oxidizer is then communicated into a special gas generator to power the turbopump or directly injected into the main combustion chamber

In accordance with the method of the invention, a liquid fuel rocket engine is operated with at least one pre-combustion chamber for burning fuel components arranged to discharge the combustion gases and/or supercritical fluids through an auxiliary turbine. The turbine is connected to drive the fuel component pumps, and it is arranged to discharge the gases and/or supercritical fluids directly into the main combustion chamber. The fuel components are directed into the pre-combustion chamber and the pre-combustion chamber is operated with an excess of either oxidizer or fuel component so that there will be a completed burning of the fuel combustion products after they are discharged through the turbine external from the assembly through an exhaust duct.

A further object of the invention is to provide a liquid-fuel rocket engine which is simple in design, rugged in construction and economical to manufacture and reusable.

This invention relates in general to the construction of combustion chambers and in particular, to a new and useful method and construction of a combustion chamber and exhaust nozzle particularly of a rocket engine which includes a collecting or distributing channel for interconnecting a plurality of channels or ducts such as for cooling with additional fuel or oxidizer distribution purposes.

Combustion chambers and exhaust thrust nozzles for rocket engines which are propelled by liquid propellants are typically subject to extremely high thermal stresses in addition to very high compressive stresses. In order to control the great amounts of thermal energy which is generated by the combustion chambers and the thrust nozzles are frequently made of a special alloy material since such materials have thermal conductivity yet are capable of handling high thermal stresses which is facilitated by removal of the thermal energy by the regenerative cooling system provided.

A further object of the invention is to provide a combustion chamber construction with an annular collecting or feeding duct which is simple in design, rugged in construction, and economical to manufacture.

A premise on which the present invention includes a rocket engine method called “Air-augmented aerospike” or “ducted aerospike”, which utilizes additional mass air flow via an inlet that collects external mass flow and passes the flow through ducts, whereby the use of atmospheric air reduces oxidizer requirements which then combines with the propellant gases and/or supercritical fluids to increase the specific impulse of the propellant. While ducted rockets have been investigated they previously posed difficulties and complex to design efficiently. The present invention, an Air-augmented aerospike rocket engine amalgamated with a scramjet engine, improves the delivered energy density of rocket engines, with less complexity of prior art.

A standard scramjet (supersonic combusting ramjet) is a valiant of a ramjet air breathing jet engine that requires high vehicle speed in which injection and then combustion takes place in supersonic airflow. Typically, when operational the airflow in a scramjet is supersonic throughout the entire engine. This allows the scramjet to operate efficiently at extremely high speeds which can go up to Mach 25.

Scramjet engines are a unique type of jet engine, and rely on the combustion of fuel and atmospheric air as an oxidizer to produce thrust. Similar to conventional jet engines, scramjet-powered aircraft carry the fuel on board, and obtain the oxidizer by the induction of atmospheric oxygen (as compared to conventional rockets, which carry both fuel and an oxidizing agent). This requirement limits scramjets to suborbital atmospheric propulsion, where the oxygen content of the air is sufficient to maintain combustion.

The scramjet is composed of four basic components: a converging inlet, where incoming air is compressed; an injector, a combustor, where gaseous or atomized liquid fuel is burned with atmospheric oxygen to produce heat; flame-holder, and a diverging nozzle, where the heated air is accelerated to produce thrust. An injector with preference for a pintle injector is designed for use with a scramjet engine and provides high combustion efficiency and pressure recovery for length-to-diameter (L/D) ratios tunable over a wide range of operating conditions.

The present invention method comprises use of a flame holder that typically involves an injector which will provide excellent performance over a wide range of conditions of L/D ratios. A flame holder is a component of a jet engine designed to help maintain continual combustion.

Generally, all commercial continuous-combustion jet engines require a flame holder. A flame holder creates a low-speed eddy in the engine to prevent a flameout scenario. The design of the flame holder is an issue of balance between a stable eddy and drag, this becomes more critical as flow speeds increase.

Typical effective designs are the “H” and “V” flame holders. One method is the H-gutter flame holder, which is shaped like a letter H with a curve facing and opposing the flow of air. The most effective and most widely used method however, is the V-gutter flame-holder, which is shaped like a “V” with the point in the direction facing the flow of air. Many reviews have shown that adding a small amount of base bleed from the “V” in the “V” shaped-gutter helps reduce drag without reducing effectiveness.

An injector is provided and flame-holders are provided to enhance and maintain combustion efficiency. Different type of flame-holders may be selected to achieve particular targeted results. For example, toroidal ring flame-holders provide a nearly symmetrical spreading of the fuel-air mixture, toroidal ring of injector ports and flame-holders will increase secondary flows in regions of the combustor dome between ports, and perpendicular toroidal ring flame-holders will increase secondary flows outboard of the ports as well as in the center of the engine.

Additional features may include the use of electronic igniters and/or pilot shrouds for lowering both the lean limits, fuel detonations and pressure oscillations and the use of flow dividers for raising the rich operating limits. It is therefore a general object of the present invention to provide an injector dump combustor which will have good performance over a wide range of conditions of L/D ratios.

The method of the present invention comprises an air-augmented aerospike rocket engine that is mounted in the center of a long duct. As the rocket engine vehicle moves through the atmosphere the air enters the inlet of the ducts, where it is compressed via a ram effect. It transverses down the throat of the duct it is further compressed, it is at this stage, usage of the scramjet injectors enables scramjet functionality with its higher Specific Impulse (Isp), this supersonic flow can then mixed with the fuel-rich exhaust from the aerospike rocket engine. These advantages provide supersonic flow for the establishment of high speed thermal expanded flow to encourage of pressure fields to originate containment in creating enhanced virtual bell nozzle effect to effectuate altitude-compensating for a net thrust benefit.

Another advantage is diverting part of the mass flow through the aerospike plug base to enable a pressure bleed which will reduce drag on the engine and its attached vehicle. In this fashion a smaller rocket engine in conjunction with the scramjet component to accelerate a much larger working mass flow leading to significantly higher thrust within the atmosphere. When leaving the atmosphere, primary propulsion would be transferred and maintained solely from the rocket engine thrust.

The method of the present invention comprises an air-augmented aerospike rocket engine incorporating scramjet technology providing use of the similar high-energy propellant and cooling schemes and techniques to maintain sustained operation and uses. The inclusion of the scramjet engine will allow a vehicle voyage through the atmosphere to benefit from the atmospheric air flow to reach Mach 25 while conserving propellant, meanwhile transferring primary propulsion to the rocket engine for accelerating to Mach 25 and above with the air-augmented aerospike rocket engine with enough speed necessary for leaving earth orbit.

The method of the present invention may be comprised with the inclusion of a ballute. This device is an amalgamation of a balloon and parachute and its function is a parachute-like braking device optimized for use at high altitudes and supersonic velocities. A ballute typically is an inflated structure intended to ensure flow separation which stabilizes the intended target as it decelerates through different flow regimes slowing from supersonic to subsonic speeds.

Space transportation architecture covers a wide range of launch concepts all proposed. as options for a space launch vehicle. The commercial market demands that any option and meet an additional set of challenging requirements be met to fulfill current and future commercial space lift needs.

One of the most demanding of the system design requirements for a launch system that is capable of performing space missions is to limit the development time and cost for the complete system. Typically, there is a long duration of stages between initial investment, design, development, prototyping and finally the operational system with associated revenues for a return on investment.

In addition to targeting low development costs, any system that is to be developed must also be extremely reliable and enable safety of manned human flight missions. Development would include an extremely reliable design that precludes, within practicality, catastrophic system failures. Examples of design features that help to prevent such catastrophic failures include: full engine shutdown from liftoff, full vehicle abort capability throughout the entire mission, robust design and standard operating margins, and integrated vehicle health monitor and control system. The integrated vehicle health monitor and control system within an ideal concept should also include a constant evolving control system that is relatively tolerant of many critical failures or malfunctions of key flight systems.

The invention will be better understood, and further objects, novel features, and advantages thereof will become more apparent from the following description of the preferred embodiments, taken in conjunction with the accompanying drawings.

An object of the invention is to provide a space launch vehicle maneuvering thrusters would be placed on each side of the vehicle and would be used by the reaction control system having an efficient fuel usage for payload to orbit.

Another object of the invention is to provide a space launch vehicle having an air augmented aerospike rocket engine coupled to a space craft for efficient delivery of a payload into orbit.

Yet another object of the invention is to provide a space launch vehicle having an external tank coupled to a space craft for efficient delivery of a payload into orbit.

Still another object of the invention is to provide a launch vehicle having an external tank and air augmented aerospike rocket engines coupled to a space craft for efficient delivery of a payload into orbit and to provide flight reentry of an orbiter.

A further object of the invention is to provide a launch vehicle having an external tank and multiple air augmented aerospike rocket engines coupled to a space craft for efficient delivery of a payload into orbit.

The present invention has three primary classes of space launch vehicles characterized by one or more rocket stages having air augmented aerospike rocket engines for propulsion, a space craft with flight control and/or stabilization surfaces, and characterized by an attached propellant booster stage for the efficient delivery of a payload into space. The rocket stage(s) can be in the preferred forms an orbiter, standard rocket, a booster, multiple boosters or any combinations thereof. The orbiter and/or standard rocket that preferably includes a payload bay and/or payload module. The propellant feeding stage in the preferred forms can be an external tank (ET) or a core stage the latter of which preferably includes air augmented aerospike rocket engines and a payload bay. The use of these components provides a variety of launch systems having a wide variety of capabilities.

These and other advantages will become more apparent from the following detailed description of the preferred embodiment.

In accordance with the invention, an altitude-compensating, Rocket-Based Air-augmented Combined Cycle propulsion system rocket engine assembly is provided for horizontal and vertically launched vehicles which offers substantial advantages over prior art engine assemblies such as standard aerospike and bell nozzles. Space craft performance is improved 12-20% over prior art engines using conventional engine and nozzle arrangement results in a light weight, high performance space launch system.

In accordance with a first aspect of the invention, there is provided a rocket engine housing duct including at an inlet, injector, combustion area, flame-holder, outlet, an injector, least two combustion chambers each including an outlet end defining a throat exhaust area; means for supplying a propellant to said at least two combustion chambers including throttling injector means, associated with each of said at least two combustion chambers and located upstream of said throat area, for receiving said propellant and for injecting said propellant into the associated combustion chamber; and control means for selectively controlling the throttling injector means for each of said at least two combustion chambers so that said at least two chambers enabling thrust vectoring capable propulsion.

Preferably, the rocket engine assembly further comprises expansion means located downstream of said throat exhaust area for providing expansion of combustion gases and/or supercritical fluids produced by said at least two combustion chambers so as to increase the net propulsion. In one preferred embodiment, the expansion means comprises an expansion nozzle. In an alternative preferred embodiment, the expansion means comprises an aerospike body. In one preferred implementation, the expansion means comprises a fixed position exhaust nozzle but, as described below, a movable nozzle can also be employed.

In one preferred embodiment, the at least two chambers are disposed in side-by-side relation. In an advantageous implementation, multiple combustion chambers arranged in a cluster in side-by-side relation.

The injector means preferably comprises a coaxial pintle injector disposed coaxial with the associated combustion chamber. Advantageously, the injector means comprises at least one movable element for providing flow regulation of the propellant.

According to a second aspect of the invention, there is provided a rocket engine assembly for a space launched vehicle with maneuvering thrusters would be placed on each side of the vehicle and would be used by the reaction control system, comprising a rocket engine housing duct with an inlet, injector, combustion area, flame-holder, outlet, including at least two combustion chamber disposed in side-by-side relation and each including an outlet; means defining a throat exhaust area at the outlet of each the at least two combustion chambers; propellant supply means for separately supplying an oxidizer and fuel to said combustion chambers; throttling injector means, associated with each of said combustion chambers located downstream of said throat exhaust area, for receiving said oxidizer and fuel and for injecting said oxidizer and fuel into the associated combustion chamber; and control means for selectively controlling said throttling injector means of each of said combustion chambers to enabling thrust vectoring capable propulsion.

According to a third aspect of the invention, there is provided a rocket engine assembly for a space launched vehicle with a maneuvering thrusters would be placed on each side of the vehicle and would be used by the reaction control system, comprising a rocket engine housing duct with an inlet, injector, combustion area, flame-holder, outlet, including at least two combustion chamber disposed in side-by-side relation and each including an outlet; means defining a throat exhaust area at the outlet of each the at least two combustion chambers; propellant supply means for separately supplying an oxidizer and fuel to said combustion chambers; throttling injector means, associated with each of said combustion chambers located downstream of said throat exhaust area, for receiving said oxidizer and fuel and for injecting said oxidizer and fuel into the associated combustion chamber; and control means for selectively controlling said throttling injector means of each of said combustion chambers to enabling thrust vectoring capable propulsion.

As indicated above, the assembly preferably comprises expansion means located downstream of said throat exhaust area for providing expansion of combustion gases and/or supercritical fluids produced by said at least two combustion chambers. As also was described previously, expansion means comprises an expansion nozzle or an aerospike body, and can comprise a fixed position exhaust nozzle.

In accordance with yet another aspect of the invention, there is provided a rocket engine assembly for a space launched rocket vehicle, comprising a rocket engine housing duct with an inlet, injector, combustion area, flame-holder, outlet, including at least two combustion chambers each including an outlet end defining a throat exhaust area; propellant supply means for supplying a oxidizer and fuel to said at least two combustion chambers, said propellant supply means including injector means, associated with each of said at least two combustion chambers and located upstream of said throat exhaust area, for receiving said propellant and for injecting said propellant into the associated combustion chamber; regulator means for regulating the flow rate of said oxidizer and fuel to each of said at least two combustion chambers; control means for selectively controlling said regulator means for each of said at least two combustion chambers so that said at least two chambers enabling thrust vectoring capable propulsion; and expansion means, such as an expansion body or an aerospike body, located downstream of said throat exhaust area for providing expansion of combustion gases and/or supercritical fluids produced by said at least two combustion chambers so as to increase said net propulsion.

In one preferred implementation, regulator means comprises a control valve located in a propellant supply pipe upstream of said injector means. In another preferred implementation, regulator means comprises a control valve located in a oxidizer supply pipe upstream of said injector means. In another preferred implementation, the regulator means comprises a movable element of said injector means which is controlled by said control means.

Further features and advantages of the present invention will be set forth in, or apparent from, the detailed description of preferred embodiments thereof which follows.

An embodiment of the invention is described with reference to the figures using reference designations as shown in the figures. Referring to FIG. 1, a first preferred embodiment a single rocket engine without a launch vehicle. The preferred embodiment comprises a rocket engine housing duct with an inlet, injector, combustion area, flame-holder, outlet, including at least two combustion chambers each including an outlet end defining a throat exhaust area; propellant supply means for supplying a oxidizer and fuel to said at least two combustion chambers, said propellant supply means including injector means, associated with each of said at least two combustion chambers and located upstream of said throat exhaust area, for receiving said propellant and for injecting said propellant into the associated combustion chamber; regulator means for regulating the flow rate of said oxidizer and fuel to each of said at least two combustion chambers; control means for selectively controlling said regulator means for each of said at least two combustion chambers so that said at least two chambers enabling thrust vectoring capable propulsion; and expansion means, such as an expansion body or an aerospike body, located downstream of said throat exhaust area for providing expansion of combustion gases and/or supercritical fluids produced by said at least two combustion chambers so as to increase said net propulsion. For each application, it is anticipated that minor modifications will be required to tailor the rocket engine to specific applications.

An embodiment of the invention is described with reference to the figures using reference designations as shown in the figures. Referring to FIG. 2, a first preferred embodiment also known as “Prometheus” Mark 1 consists of a launch vehicle, includes a two engine orbiter having Axisymmetric Rocket-Based Air-augmented Combined Cycle propulsion system rocket engines (ARBACC). The orbiter has internal stored propellant. The twin engine orbiter includes a canard, left orbiter flight control surface and a right orbiter flight control surface, an orbiter shell, orbiter body flaps including orbiter left orbiter body flaps and right orbiter body flaps. For each application, it is anticipated that minor modifications will be required to tailor the launch vehicle to specific applications.

An embodiment of the invention is described with reference to the figures using reference designations as shown in the figures. Referring to FIG. 3, a first preferred embodiment also known as “Cronus” Mark 1 consists of a launch vehicle, includes a center body with an Axisymmetric Rocket-Based Air-augmented Combined Cycle propulsion system rocket engine (ARBACC). The orbiter has internal propellant tanks. The liquid rocket boosters have internal propellant tanks.

The twin engine orbiter includes a left orbiter flight control surface and a right orbiter flight control surface, an orbiter shell, orbiter body flaps including orbiter left orbiter body flaps a and right orbiter body flaps. For each application, it is anticipated that minor modifications will be required to tailor the launch vehicle to specific applications.

An embodiment of the invention is described with reference to the figures using reference designations as shown in the figures. Referring to FIG. 4, a first preferred embodiment also known as “Proteus” Mark 1 consists of a Fly-back Air-augmented Liquid Booster (FALB), includes an Axisymmetric Rocket-Based Air-augmented Combined Cycle propulsion system rocket engine (ARBACC). The FALB has internal stored propellant. Maneuvering thrusters would be placed on each side of the vehicle and would be used by the reaction control system. The FLAB is an Unmanned Aerial Vehicle (UAV), which is a craft with no pilot on hoard. An FLAB can be remote controlled aircraft by a pilot at a ground control station or can fly autonomously based on pre-programmed flight plans with a dynamic automation system. The FALB includes a canard, left flight control surface and a right flight control surface, an orbiter shell, body flaps including left body flaps and right body flaps. For each application, it is anticipated that minor modifications will be required to tailor the launch vehicle to specific applications.

An embodiment of the invention is described with reference to the figures using reference designations as shown in the figures. Referring to FIG. 5, a first preferred embodiment also known as “Helios” Mark 1 consists of a shuttle like launch system which includes an Axisymmetric Rocket-Based Air-augmented Combined Cycle propulsion system rocket engine (ARBACC). This embodiment has internal and external stored propellant. Maneuvering thrusters would be placed on each side of the vehicle and would be used by the reaction control system. This embodiment would include the use of FLAB and/or Solid Rocket Boosters (SBR) and/or Liquid Rocket Boosters (LBR) and an External Tank (ET). This embodiment consists of a left flight control surface and a right flight control surface, an orbiter shell, body flaps including left body flaps and right body flaps. For each application, it is anticipated that minor modifications will be required to tailor the launch vehicle to specific applications.

An embodiment of the invention is described with reference to the figures using reference designations as shown in the figures. Referring to FIG. 6, a first preferred embodiment also known as “Aurora” Mark 1 consists of a launch vehicle, includes a quad engine orbiter having Axisymmetric Rocket-Based Air-augmented Combined Cycle propulsion system rocket engines (ARBACC). The orbiter has internal stored propellant. The quad engine orbiter includes a primary wing and lift body, left orbiter flight control surface and a right orbiter flight control surface, an orbiter shell, orbiter body flaps including orbiter left orbiter body flaps and right orbiter body flaps. For each application, it is anticipated that minor modifications will be required to tailor the launch vehicle to specific applications.

An embodiment of the invention is described with reference to the figures using reference designations as shown in the figures. Referring to FIG. 7, a first preferred embodiment a single rocket engine without a launch vehicle. The preferred embodiment comprises a rocket engine housing duct with an inlet, injector, combustion area, flame-holder, outlet, including at least two combustion chambers each including an outlet end defining a throat exhaust area; propellant supply means for supplying a oxidizer and fuel to said at least two combustion chambers, said propellant supply means including injector means, associated with each of said at least two combustion chambers and located upstream of said throat exhaust area, for receiving said propellant and for injecting said propellant into the associated combustion chamber; regulator means for regulating the flow rate of said oxidizer and fuel to each of said at least two combustion chambers; control means for selectively controlling said regulator means for each of said at least two combustion chambers so that said at least two chambers enabling thrust vectoring capable propulsion; and expansion means, such as an expansion body or an aerospike body, located downstream of said throat exhaust area for providing expansion of combustion gases and/or supercritical fluids produced by said at least two combustion chambers so as to increase said net propulsion. For each application, it is anticipated that minor modifications will be required to tailor the rocket engine to specific applications.

An embodiment of the invention is described with reference to the figures using reference designations as shown in the figures. Referring to FIG. 8, a first preferred embodiment also known as “Perseus” Mark 1 consists of a launch vehicle, includes a two engine orbiter having Axisymmetric Rocket-Based Air-augmented Combined Cycle propulsion system rocket engines (ARBACC). The orbiter has internal stored propellant. The twin engine orbiter includes a canard, left orbiter flight control surface and a right orbiter flight control surface, an orbiter shell, orbiter body flaps including orbiter left orbiter body flaps and right orbiter body flaps. For each application, it is anticipated that minor modifications will be required to tailor the launch vehicle to specific applications.

An embodiment of the invention is described with reference to the figures using reference designations as shown in the figures. Referring to FIG. 9, a first preferred embodiment also known as “Perseus” Mark 2 consists of a launch vehicle, includes a two engine orbiter having Axisymmetric Rocket-Based Air-augmented Combined Cycle propulsion system rocket engines (ARBACC). The orbiter has internal stored propellant. The twin engine orbiter includes a canard, left orbiter flight control surface and a right orbiter flight control surface, an orbiter shell, orbiter body flaps including orbiter left orbiter body flaps and right orbiter body flaps. For each application, it is anticipated that minor modifications will be required to tailor the launch vehicle to specific applications.

An embodiment of the invention is described with reference to the figures using reference designations as shown in the figures. Referring to FIG. 10 and FIG. 11, a first preferred embodiment also known as “Hermes” Mark 1 also known as the “StarCruiser” concept consists of a two-stage, vertical or horizontal takeoff, horizontal landing configuration with a large unmanned booster and a manned stage designed for up to 150 passengers and 5 crew members. The fully reusable system is accelerated by a multiple engine orbiter having Axisymmetric Rocket-Based Air-augmented Combined. Cycle propulsion system rocket engines (ARBACC). The orbiter has internal stored propellant. The ARBACC engine orbiter includes a canard, left orbiter flight control surface and a right orbiter flight control surface, an orbiter shell, orbiter body flaps including orbiter left orbiter body flaps and right orbiter body flaps.

After primary rocket engine cut-off the passenger stage will enter a high-speed powered/gliding flight phase and shall be capable of traveling long intercontinental distances within an extremely short time. Altitudes of approximately 200 kilometers and Mach numbers beyond 24 are projected, depending on the mission and the associated flight path flown. For each application, it is anticipated that minor modifications will be required to tailor the launch vehicle to specific applications.

Although specific shapes and geometries have been illustrated in the drawings, it is also to be understood that the throat exhaust cross sections can be of various different shapes and sizes, and can be arranged in various different geometric locations with respect to each other. However, in each case, the throat exhaust section should be positioned so as to communicate combustion chamber gases and/or supercritical fluids to a single downstream expansion nozzle or body so as to create hypersonic expansion and increased thrust as described above.

Although the invention has been described above in connection with preferred embodiments thereof, it will be understood by those skilled in the art that variations and modifications can be effected in these preferred embodiments without departing from the scope and spirit of the invention.

The various features of novelty which characterize the invention are pointed out with particularity in the claims annexed to and forming a part of this specification. For a better understanding of the invention, its operating advantages and specific objects attained by its use, reference should be had to the accompanying drawings and descriptive matter in which there is illustrated and described a preferred embodiment of the invention.

Although the above description relates to a specific preferred embodiment as presently contemplated by the inventor, it will be understood that the invention in its broad aspect includes mechanical and functional equivalents of the elements described herein.

Although various representative embodiments of this invention have been described above with a certain degree of particularity, those skilled in the art could make numerous alterations to the disclosed embodiments without departing from the spirit or scope of the inventive subject matter set forth in the specification and claims. Joinder references (e.g. attached, adhered, joined) are to be construed broadly and may include intermediate members between a connection of elements and relative movement between elements. As such, joinder references do not necessarily infer that two elements are directly connected and in fixed relation to each other. Moreover, network connection references are to be construed broadly and may include intermediate members or devices between network connections of elements. As such, network connection references do not necessarily infer that two elements are in direct communication with each other. In some instances, in methodologies directly or indirectly set forth herein, various steps and operations are described in one possible order of operation, but those skilled in the art will recognize that steps and operations may be rearranged, replaced or eliminated without necessarily departing from the spirit and scope of the present invention. It is intended that all matter contained in the above description or shown in the accompanying drawings shall be interpreted as illustrative only and not limiting. Changes in detail or structure may be made without departing from the spirit of the invention as defined in the appended claims.

Although the present invention has been described with reference to the embodiments outlined above, various alternatives, modifications, variations, improvements and/or substantial equivalents, whether known or that are or may be presently foreseen, may become apparent to those having at least ordinary skill in the art. Listing the steps of a method in a certain order does not constitute any limitation on the order of the steps of the method. Accordingly, the embodiments of the invention set forth above are intended to be illustrative, not limiting. Persons skilled in the art will recognize that changes may be made in form and detail without departing from the spirit and scope of the invention. Therefore, the invention is intended to embrace all known or earlier developed alternatives, modifications, variations, improvements and/or substantial equivalents.

1. An automated fabrication system with methods for producing thermal and mechanical fabrications, the system and methods comprising:

2. An enclosed automated apparatus for producing a component from a powder, comprises at least one of a:
a) Means for consecutively dispensing a plurality of layers of powder within a boundary to a target surface; and
b) An energy source; and
c) Means for beam management utilizing mirrors on X axis, Y axis and focusing lens system for Z axis beam diameter control; and
d) Means of a transparent thermal barrier between beams and build area
e) A computer control system with artificial intelligence using machine learning for monitoring, analysis of 3d object and 2d sliced layers to include controlling the system; and f) Scanning system consisting of at least one method of 3D object electromagnetic radiation scanning used with 3d object data and 2d sliced layer analysis with fabricated layer; and g) A method for directing the energy source at locations of each dispensed layer of powder at the target surface corresponding to cross-sections of the component to be produced therein and fusing the powder thereof; and
h) Means for a counter rotating barrel dispensing powder near said target surface comprises at least one of a:
i. A thermally controlled counter rotating barrel;
ii. Means for moving said counter rotating barrel across said target surface in contact with said powder; and
iii. Means for rotating said counter rotating barrel to a direction of said movement of said counter rotating barrel across said target surface;
iv. wherein said movement and said counter-rotation of said barrel distribute a layer of powder over said target surface.
i) Thermal control means via gas exchange for moderating the temperature difference between unfused powder in a top layer of powder at the target surface and the material holding sump(s) and laser fused monolithic component in the one of the plurality of layers of powder immediately beneath the topmost layer
j) Means for cartridge based build area and transfer method thereof and comprises at least one of a:
i. Build platform assembly;
ii. An actuator; said actuator comprised by a lift mechanism;
iii. An enclosure; said enclose comprising metal supports, metal casing, metal sheets;
iv. Thermal communication channeling medium;
v. Carriage for transfer means;
k) Means for sealing and pressurizing fabrication system;

3. An enclosed automated apparatus for producing a component from a powder and wire, comprises at least one of a:
a) Means for consecutively dispensing a plurality of layers of powder and wire within a boundary to a target surface; and
b) An energy source; and
c) Means for beam management utilizing mirrors on X axis, Y axis and focusing lens system for Z axis beam diameter control; and
d) Means for transparent thermal barrier between beams and build area
e) A computer control system with artificial intelligence using machine learning for monitoring, analysis and controlling the system; and
f) Scanning system consisting of at least one method of 3D object electromagnetic radiation scanning used with 3d object data and 2d sliced layer analysis with fabricated layer; and scanning system consisting of at least one type of 3D object scanner, thermal or optical or light based sensor, x-ray, sonic scanning; and
g) A method for directing the energy source at locations of each dispensed layer of powder at the target surface corresponding to cross-sections of the part to be produced therein and fusing the powder thereof; and
h) A method for directing the energy source and wire at locations of each targeted layer at the target surface corresponding to cross-sections of the part to be produced therein and fusing the powder at the target location; and
l) Means for a counter rotating barrel dispensing powder near said target surface comprises at least one of a:
i. A thermally controlled counter rotating barrel;
ii. Means for moving said counter rotating barrel across said target surface in contact with said powder; and
iii. Means for rotating said counter rotating barrel to a direction of said movement of said counter rotating barrel across said target surface;
iv. wherein said movement and said counter-rotation of said barrel distribute a layer of powder over said target surface.
i) A method for directing removal of powder material at locations of each targeted layer at the target surface corresponding to cross-sections of the part to be produced therein; and j) Thermal control means via gas exchange for moderating the temperature difference between unfused powder in a top layer of powder at the target surface and the material holding sump(s) and laser fused monolithic component in the one of the plurality of layers of powder immediately beneath the topmost layer; and
m) Means for portable cartridge based build area with transfer method thereof and comprises at least one of a:
i. Build platform assembly
ii. An actuator; said actuator comprised by a lift mechanism;
iii. An enclosure; said enclose comprising metal supports, metal casing, metal sheets;
iv. Thermal communication channeling medium
v. Carriage for transfer means
n) Means for sealing and pressurizing fabrication system

4. An enclosed automated apparatus for producing a component from a powder, comprises at least one of a:
o) Means for consecutively dispensing a plurality of layers of powder within a boundary to a target surface; and
p) An energy source; and
q) Means for beam management utilizing mirrors on X axis, Y axis and focusing lens system for Z axis beam diameter control; and
r) Means of a transparent thermal barrier between beams and build area
s) A computer control system with artificial intelligence using machine learning for monitoring, analysis and controlling the system; and
t) Scanning system consisting of at least one method of 3D object electromagnetic radiation scanning used with 3d object data and 2d sliced layer analysis with fabricated layer; and u) A method for directing the energy source at locations of each dispensed layer of powder at the target surface corresponding to cross-sections of the component to be produced therein and fusing the powder thereof; and
v) Means for a scraper to dispense powder near said target surface comprises at least one of a:
i. A scraper;
ii. Means for moving said scraper across said target surface in contact with said powder; and wherein said movement of said scraper distribute a layer of powder over said target surface.
w) Thermal control means via gas exchange for moderating the temperature difference between unfused powder in a top layer of powder at the target surface and the material holding sump(s) and laser fused monolithic component in the one of the plurality of layers of powder immediately beneath the topmost layer
x) Means for cartridge based build area and transfer method thereof and comprises at least one of a:
i. Build platform assembly;
ii. An actuator; said actuator comprised by a lift mechanism;
iii. An enclosure; said enclose comprising metal supports, metal casing, metal sheets;
iv. Thermal communication channeling medium;
v. Carriage for transfer means;
y) Means for sealing and pressurizing fabrication system;

5. The apparatus of claim 2, wherein said thermal control means further comprises:
heater, cooling, heat exchanger to transfer thermal energy for thermal control of a gas; and means for directing the thermal controlled gas at the target surface and exhaust means for exhausting directed thermally controlled gas from the vicinity of the target surface.

6. The apparatus of claim 2, wherein said energy source comprises a quad laser array;
and wherein said controller comprises:
a computer; and lens and mirrors controlled by said computer to direct the width of the beams and aim and focus of the beams from the quad array of lasers.

7. The apparatus of claim 6, wherein said controller further comprises:
interface hardware, coupled to said computer, to enable and disable the quad laser array as its targeted energy beam is moved across the targeted surface.

8. The apparatus of claim 7, wherein the computer is programmed with the defined boundaries of each cross-section of the part.

9. The apparatus of claim 7, wherein the computer comprises means for determining the defined boundaries of each layer of the part from the overall dimensions of the part.

10. The apparatus of claim 6, wherein said controller further comprises:
interface hardware, coupled to said computer, to enable and disable the direct material depositing as its target is moved across the targeted surface.

11. The apparatus of claim 10, wherein the computer is programmed with the defined boundaries of each cross-section of the part whereas computer comprises means for determining the defined boundaries of each layer of the part from the overall dimensions of the part.

12. The apparatus according to claim 2, wherein the automated Computer Numerical Control (CNC) is the automation of machine tools by means of computers executing pre-programmed sequences of machine control commands whereas performing CNC finalization process comprises means for cutting, smoothing, polishing, spraying, coating or joining components;
An automated CNC machine tool control system for a CNC machine tool of the type comprising a controllable, movable tool for processing a fabrication component, means for receiving control instructions describing processing functions to be performed on the fabrication component, a processing unit and memory means, comprises at least one of a:
a) means for receiving and storing in the memory means fabrication component shaping instructions from 3 dimensional computer aided design data;
b) means for transmitting command signals to a movable tool to thereby cause the movable tool to move; and
c) means for generating control signals, said generating means including an object oriented software program comprising a plurality of objects, each said object including a plurality of instructions and associated data, said generating means including message means for transmitting information between said objects, at least one of said objects including a model of the processes to be performed on a fabrication component by the movable tool, said generating means coupled to said message means, said generating means generating control signals responsive to messages from said processing objects, said generating means communicating said control signals to said transmitting means.

13. Fabrication means utilizing the apparatus according to claim 11, wherein layers are fused to form a monolithic heat exchanger comprised by:
a) Fusing layers of at least one type of materials consisting of powder or wire; and b) A manifold extending between axially opposed ends and having first inlet means and first outlet means for respectively permitting the ingress and egress of a first heat exchange fluid; and c) A pair of end members fused to the axially-opposed ends of the manifold to define an internal chamber therein having an intermediate region disposed between two opposite non intermediate end regions of the chamber, the end members having second inlet means and second outlet means for respectively permitting the ingress and egress of a second heat exchange fluid; and
d) A plurality of uniformed rounded zig-zag channels extending from an end member to an adjacent end member for the first heat exchange fluid; and
e) A plurality of uniformed rounded zig-zag channels extending from an end member to an adjacent end member for the second heat exchange fluid

14. The apparatus of claim 11, wherein means for fabrication of a supercritical, transcritical and subcritical carbon dioxide turbine system, wherein said supercritical, transcritical and subcritical carbon dioxide turbine system comprises a plurality of turbines, compressors, evaporators, absorbers, heat exchangers and condensers.

15. The apparatus of claim 11, wherein provides means for fabrication of a monolithic axial turbine rotor with internal cooling channels, wherein said axial flow turbine comprising:
a. rotor blades fabricated via powder bed with internal cooling channels further comprised by smoothing and polishing fabrication comprised by method of claim 12; and
b. rotor hub fabricated via at least one method:
i. powder bed
ii. cnc machined
iii. casting

16. The apparatus of claim 11, wherein provides means for fabrication of a monolithic radial flow turbine impeller with internal cooling channels, wherein finalization of said radial flow turbine impeller fabrication is comprised by smoothing and polishing fabrication comprised by method of claim 12.

17. Fabrication means utilizing the apparatus according to claim 14, wherein layers are fused to form monolithic component builds of a supercritical, transcritical, subcritical turbine system comprises at least one of a:
a. Carbon dioxide storage, pump and valve: and
b. A high temperature recuperator; and
c. A medium temperature recuperator; and
d. A low temperature recuperator; and
e. A Heat Exchanger; and
f. A precooler; and
g. A condenser; and
h. An evaporator; and
i. An impeller and/or propeller with internal cooling channels; and
j . A modular sealing and bearing cartridge; and
k. A compressor
1. A turbine

18. The turbine system of claim 17, wherein the supercritical, transcritical, subcritical carbon dioxide turbine operates at a temperature of at least approximately 250 degrees Fahrenheit.

19. The turbine system of claim 17, wherein the supercritical, transcritical, subcritical carbon dioxide turbine comprises a supercritical carbon dioxide Brayton power conversion cycle utilizing heat exchangers.

20. A modular sealing and bearing turbine cartridge comprises:
a) At least one Primary Shaft Sleeve
b) At least one Intermediate Sleeve
c) At least one Inner Sleeve
d) At least one Adjustable Threaded Collar
e) At least one Upper Lock Collar
f) At least one Upper Lock Ring
g) At least one Lower Lock Collar
h) At least one Lower Lock Ring
i) At least one Outer Labyrinth
j) At least one Optional Inner Labyrinth(s)
k) At least one Intermediate Labyrinth
l) At least one Outer Leveling Pad
m) At least one Inner Leveling Pad
n) At least one Outer Stationary Seal Bearing
o) At least one Inner Thrust Bearing
p) At least one Thrust Ring
q) At least one Outer Thrust Bearing
r) At least one Stationary Seal
s) At least one Tilting Journal Pad
t) At least one Spring
u) At least one Inner Stationary Seal Bearing
v) At least one Inner Journal Bracket
w) At least one Outer Journal Bracket
x) At least one monolithic channeled housing

21. The process of claim 14 wherein said supercritical, transcritical and subcritical carbon dioxide turbine system further comprising:
a. External thermal input connects to primary heat exchanger HX1 that converts and transfers external generated thermal energy input to inject thermal energy into the carbon dioxide Brayton top cycle
b. Ducting from HX1 connects to the primary turbine T1 connected to generator/alternator 1 connected to main compressor MC and ducting to provide input to secondary turbine T2 and generator/alternator 2 connected to recompressor RC
c. Gas film compressor BC provides pressure boost to gas ducted to gas supported bearings (turbine bearings) connected to at least one: motor, engine, turbine
d. Ducting from turbine T1 and turbine T2 connects thermal input to high temperature recuperator/heat exchanger HX2 then ducted to low temperature recuperator/heat exchanger HX3
e. Ducting from HX3 connects thermal input to gas pre-cooler/heat exchanger HX4 then ducted connects thermal input to condenser,
f. Ducting from HX3 then connects thermal input to transcritical turbine 3 connected to generator/alternator 3
g. Pump P1 is connected to at least one: transcritical turbine 3, at least one individual standalone motor, engine, turbine
h. Secondary compressor SC is connected to at least one: transcritical turbine 3, at least one individual standalone motor, engine, turbine
i. Duct to connect between transcritical turbine 3 and heat exchanger HX5 connected to heat exchanger HX6 that is connected to Heat exchanger HX7 connected to an expansion valve and then connected to an evaporator.
j. Pump P2 is connected to cot expansion tank and accepts input from CO2 Storage k. CO2 expansion tank refills the CO2 cycles via ducting to upper Brayton and lower Brayton cycles.

22. A method of generating electricity, heating and cooling with a supercritical, transcritical, subcritical carbon dioxide turbine, the method comprising:
Transfer of thermal energy heating a heat transfer fluid to a temperature of at least about 250 degrees Fahrenheit from the thermal energy source;
transporting energy from the heat transfer fluid to heat a Brayton cycle working fluid of the supercritical, transcritical, subcritical carbon dioxide turbine system;
passing the heated Brayton cycle working fluid through the supercritical Brayton cycle; and thermal energy communication of the Brayton cycle working fluid from the supercritical carbon dioxide turbine with a high temperature recuperator to the transcritical Brayton cycle: and thermal energy communication of the Brayton cycle working fluid from the medium temperature recuperator to the subcritical Brayton cycle;

23. The method of claim 21, wherein carbon dioxide thermal transfer fluid transports the thermal energy for the Brayton cycle working fluid of the supercritical, transcritical, subcritical carbon dioxide turbine system comprises using a heat exchanger.

24. The method of claim 21, wherein the supercritical carbon dioxide turbine system comprises a supercritical, transcritical, subcritical carbon dioxide Brayton power conversion cycle.
a) A Brayton cycle working fluid for providing energy to the supercritical, transcritical and subcritical carbon dioxide turbines; and
b) a high temperature recuperator that receives the Brayton working fluid from the supercritical carbon dioxide turbine and thermal energy communicates it; and
c) A medium temperature recuperator that receives the Brayton working fluid from the high temperature recuperator and thermal energy communicates it; and
d) a low temperature recuperator that receives the Brayton working fluid from the high temperature recuperator and thermal energy communicates it;
e) A precooler;

25. Fabrication means utilizing the apparatus according to claim 11, wherein layers are fused in a single build of monolithic components to form high temperature fuel cell system comprised by:
A cooling channel, an anode channel, an anode inlet and an anode outlet, a first anode channel portion proximal to the anode inlet, a second anode channel portion proximal to the anode outlet, and a gas separation means operable to enrich a hydrogen gas component of an anode exhaust gas exiting the anode outlet to produce a first product gas enriched in the said hydrogen gas component such that at least a portion of the first product gas enriched in the hydrogen gas component can be provided as a portion of a fuel mixture supplied to the anode inlet

26. The high temperature fuel cell system according to claim 25 wherein the high temperature fuel cell comprises HDLS fused monolithic plates and monolithic ends to form components of a solid oxide fuel cell.

27. The high temperature fuel cell system according to claim 25, wherein the anode and cathode channels are arranged such that allows uniform placement cooling channels to moderate excessive heat and reduction of thermal hot spots within the fuel cell.

28. The high temperature fuel cell system according to claim 27, wherein the anode and cathode channels are arranged such that the fuel gas mixture in the anode channel is capable of flowing in a direction countercurrent to a flow of the oxygen-enriched gas in the cathode channel.

29. The high temperature fuel cell system according to claim 25, wherein the first anode channel portion comprises an anode material mixture thereof, and the second anode channel portion comprises a selected anode material.

30. The high temperature fuel system according to claim 25, wherein the high temperature fuel cell engages an internal thermal management system to moderate thermal energy from within the fuel cell assembly

31. A thermal energy management system for solid oxide fuel cells comprising:
a monolithic heat exchanger comprising a coolant inlet port, a coolant outlet port, and a plurality of cell channels for passing a flow of coolant there through;
said monolithic heat exchanger being connected to an SOFC stack; and
a seal material disposed between said SOFC stack and said heat exchanger to control thermal connection and coolant between said SOFC stack and said heat exchanger;
wherein in operation, a flow of inlet coolant having a selected temperature is passed through said heat exchanger cell channels and thermal energy flowing into and out of said SOFC stack is managed primarily by a thermal transfer fluid connection between said SOFC stack and said heat exchanger.

32. The thermal energy management system of claim 31, wherein said heat exchanger preheats or cools one or a combination of input fuel stream and oxidizing gas stream feeding said SOFC stack.

33. The thermal energy management system of claim 31, further comprising:
communication provided between said SOFC stack and said heat exchanger and configured to control thermal coupling between said SOFC stack and said heat exchanger.

34. The thermal energy management system of claim 31, further comprising:
a sealing material between said SOFC stack and said heat exchanger to control thermal connection between said SOFC stack and said heat exchanger; and
connection between said SOFC stack and said heat exchanger and configured to control thermal connection between said SOFC stack and said heat exchanger.

35. A method for managing the thermal energy flowing into and out of an SOFC system comprising:
connecting a heat exchanger to an SOFC stack, said monolithic heat exchanger comprising a coolant inlet side for introducing a flow of coolant, a plurality of cells for passing a flow of coolant there through, and a coolant outlet side for discharging said flow of coolant;
seal material between said SOFC stack and said heat exchanger and configuring said seal material to control thermal connection between said SOFC stack and said heat exchanger; and transfer of said coolant having a selected temperature through said heat exchanger cell channels so as to manage thermal energy flowing into and out of said SOFC stack primarily by coolant connection between said SOFC stack and said heat exchanger.

36. The method of claim 35, further comprising:
preheating or cooling one or a combination of input fuel stream and oxidizing gas stream feeding said SOFC stack with said heat exchanger.

37. A thermal energy management system for solid oxide fuel cells comprising:
an HDLS fused monolithic heat exchanger comprising a coolant inlet side, a coolant outlet side, and a plurality of cells for passing a flow of coolant there through;
said heat exchanger being coupled to an SOFC stack; and
a material disposed between said SOFC stack and said monolithic heat exchanger to control thermal coupling between said SOFC stack and said heat exchanger;
wherein in operation, a flow of inlet air having a selected temperature is passed through said heat exchanger cells and thermal energy flowing into and out of said SOFC stack is managed primarily by radiation coupling between said SOFC stack and said heat exchanger.

38. The thermal energy management system of claim 37, further comprising:
an air gap disposed between said SOFC stack and said monolithic heat exchanger and configured to control thermal coupling between said SOFC stack and said monolithic heat exchanger.

39. The thermal energy management system of claim 37, wherein said material is selected from the group consisting of a high emissivity material, a metal wall, metal media, or particles or a combination thereof.

40. The thermal energy management system of claim 37, wherein said monolithic heat exchanger is a HDLS fused monolithic heat exchanger.

41. A method for managing the thermal energy flowing into and out of an SOFC system comprising:
A. Connection of a HDLS fused monolithic heat exchanger to an SOFC stack, said heat exchanger comprising a coolant inlet side for introducing a flow of coolant, a plurality of cells for passing a flow of coolant there through, and a coolant outlet side for discharging said flow of coolant;
B. disposing a material between said SOFC stack and said heat exchanger and configuring said material to control thermal coupling between said SOFC stack and said heat exchanger; and
C. passing said coolant having a selected temperature through said heat exchanger cell channels so as to manage thermal energy flowing into and out of said SOFC stack primarily by coolant connection between said SOFC stack and said heat exchanger.

42. Fabrication means utilizing the apparatus according to claim 11, wherein layers are fused to form a monolithic advanced gas cooled fast nuclear reactor comprised by:
a. A monolithic pressure reactor vessel adapted to contain nuclear fuel therein, said monolithic vessel being adapted for operation with said advanced gas cooled fast nuclear reactor whereby it will become radioactively contaminated in the course of its operative life; and
b. A shield structure including:
1. a hdls fused monolithic reactor chamber for housing the reactor vessel during its operative life; and
2. a hdls fused monolithic extraction chamber above the reactor chamber in communicating relationship with the reactor chamber and capable of receiving the reactor control rods during transfer, maintenance and at the expiration of its operative life for at least a time sufficient to permit the thermal generation to decay to acceptable levels; and
3. hdls fused monolithic pressure vessel with a plurality of isolated heat exchanger cores c. A platform supporting the hdls fused monolithic reactor vessel within the monolithic reactor chamber, said platform being capable of permitting upward movement of said reactor control rods into the monolithic extraction chamber; and
d. means for supporting said platform;
e. means for engaging support from said platform; and
f. means for engaging the reactor core rods from the hdls monolithic reactor chamber to the monolithic extraction chamber at the expiration of said operative life.

43. An advanced gas cooled fast nuclear reactor according to claim 42 wherein:
a. said platform supporting the monolithic pressure reactor vessel within the monolithic reactor chamber is adapted for upward movement of the control rods into the extraction chamber at the expiration of said operative life, maintenance or shipping; and
b. said means for engaging the monolithic reactor core rods from the monolithic reactor chamber to the extraction chamber includes a mechanical system operatively connected to said platform whereby at the expiration of the operative life of the reactor vessel, maintenance or shipping the mechanical system may be activated to cause upward movement of said platform and said exhausted monolithic reactor control rods into the extraction chamber.

44. at least one movable support column positioned within the monolithic extraction chamber for supporting the platform during the operative life, maintenance and shipping of the reactor vessel in a position defining the top of reactor chamber;

45. at least one spring positioned such that upon activation thereby allowing the reactor control rods to elevate into the monolithic extraction chamber.

46. An advanced gas cooled fast nuclear reactor according to claim 42 wherein said monolithic extraction chamber includes:

47. An advanced gas cooled fast nuclear reactor according to claim 46 wherein said mechanical system comprises:

48. An monolithic advanced gas cooled fast nuclear reactor according to claim 47 including: a. movable support means positioned within the monolithic extraction chamber for supporting the platform during the operative life, maintenance and shipping of the reactor vessel in a position defining the top of the reactor chamber; and b. an access way leading into the upper portion of the extraction chamber to permit access into the extraction chamber for the purpose of removing said support means in preparation for replacement of said exhausted reactor vessel core material.

49. A monolithic advanced gas cooled fast nuclear reactor according to claim 48 including: a. an access way leading into the upper portion of the monolithic extraction chamber through which locking mechanism may be engaged to allow removal and replacement of the monolithic advanced gas cooled fast nuclear reactor.

50. An advanced gas cooled fast nuclear reactor according to claim 49 wherein a. said monolithic reactor chamber is located above ground level, and B. said monolithic extraction chamber is located above the reactor chamber level.

51. Fabrication utilizing the apparatus according to claim 11, wherein layers are fused to form a monolithic build liquid rocket engine components consisting of a thrust chamber, throat, exhaust and pintle injector comprised by:
For a space vehicle a single build monolithic constructed rocket engine body with no welds or bolted connections for providing propulsion force, said rocket engine having an pintle injector for feeding oxygen and hydrogen into a thrust producer means consisting of a single thrust chamber, a turbopump supplied source of liquid methane connected via coolant channels within the rocket body and a turbopump source of liquid oxygen connected to said injector and being located relative to said thrust chamber so that the center of the rocket engine body forms a mounting and sealing system for said pintle injector.

52. A rocket engine as in claim 51 wherein said connecting means includes pintle injector providing flow and pressure control and shutoff of fuel and oxidizer for said rocket engine.

53. A rocket engine as in claim 52 wherein a turbopump means includes a turbine driven by methane and oxygen exhaust after being in indirect heat exchange relationship with a prebumer, a first pump for oxygen and a second pump for hydrogen, and said turbopump impellers powering said first pump and said second pump.

54. A liquid fuel rocket engine having a turbopump for boosting the pressure of fuel component and for boosting the pressure of oxidizer component, two pressure driving means for pressurizing said fuel and said oxidizer, a combustor wherein said pressurized fuel and oxidizer are fed through a pintle injector into the combustion chamber to produce a mixed fuel and oxidizer combustion gas to be discharged outwardly, a combustor chamber cooling jacket mounted operatively around the circumference of said combustion chamber means, a throat area connected to a high expansion nozzle extending from said combustor, and an expansion nozzle cooling jacket disposed operatively around the circumference of said high expansion nozzle means, respectively;

55. The liquid fuel rocket engine of claim 51, wherein said engine is further characterized in that a direct fuel based cooling channel is disposed between said turbopump means and said rocket engine body.

56. The liquid fuel rocket engine of claim 51, wherein said engine is further characterized in that a direct oxidizer cooling channel is disposed between said turbopump means and said pintle injector.

57. Fabrication utilizing the apparatus according to claim 11, wherein layers are fused to form an Axisymmetric Rocket-Based Air-augmented Combined Cycle propulsion system rocket engine comprised by:
A monolithic rocket engine with scram engine thrust producing engine that has either rocket engine operation, air breathing operation with assistance of the rocket engine or continuous air breathing comprising of: an outer frame to connect the following components, symmetrical annular air intake compression ramps attached to the outer edges of the aerospike ramps center, an axial flow air diffuser area, flame area and compressor area, annular aerospike thrust cells connected to the annular thrust wall which provides the exhaust expansion ramp for the engine, air breathing combustors located at the beginning of the air compression ramp, a liquid fuel turbopump, liquid oxygen turbopump turbine, several linear actuators to change the air compression ramp geometry for thrust vectoring, and a control system to control basic engine functions, such as throttles for both air and fuel, air intake ramp shape, output ramp shape, fuel and oxidizer supply valves and an ignition system.

58. A turbopump turbine described in claim 57, which either drives liquid fuel pump or a liquid oxygen pump for the rocket that is controlled by a fuel and oxidizer valves, but does not drive both pump and air compressor simultaneously.

59. An air supply from claim 57 consisting of several movable annular cone mechanically connected in which compress the incoming air by a ram effect and can be moved by the attached linear actuators to change the air compression ramp geometry.

60. An annular arrangement of thrust cell which form an annular rocket thrust in claim 57 that serves as an exhaust expansion ramp for both said air breathing scram jets and said liquid rocket thrust cells while having the ability to thrust vector the rocket thrust without changing the air breathing exhaust ramp geometry.
